(19) United States
(12) Patent Application Publication
(10) Pub. No.: US 2024/0267987 A1
(43) Pub. Date: Aug. 8, 2024

(54) Cell DTX/DRX Activation/Deactivation

(71) Applicant: Alireza Babaei, Fairfax, VA (US)

(72) Inventor: Alireza Babaei, Fairfax, VA (US)

(21) Appl. No.: 18/581,233

(22) Filed: Feb. 19, 2024

Related U.S. Application Data
(60) Provisional application No. 63/443,629, filed on Feb. 6, 2023.

(51) Int. Cl. H04W 76/28; H04W 72/23

(52) U.S. Cl. CPC H04W 76/28; H04W 72/23

(57) ABSTRACT

A wireless device may receive configuration parameters, of a first cell, comprising first configuration parameters of a cell DTX DRX configuration for the first cell. The wireless device may receive a DCL A first value of a field of the DCI may indicate activation of the first cell DTX DRX configuration for the first cell and a second value of field of the DCI may indicate deactivation of the first cell DTX DRX configuration for the first cell. The wireless device may activate or deactivate the first cell DTX DRX configuration in response to receiving the DCI and based on the value of the field.

### CROSS-REFERENCE TO RELATED APPLICATIONS

This application claims the benefit of U.S. Provisional Application No. 63/443,629, filed Feb. 6, 2023, which is hereby incorporated by reference in its entirety.

### BRIEF DESCRIPTION OF THE DRAWINGS

FIG. 1A and FIG. 1B show examples of mobile communications systems in accordance with several of various embodiments of the present disclosure.

FIG. 2A and FIG. 2B show examples of user plane and control plane protocol layers in accordance with several of various embodiments of the present disclosure.

FIG. 3 shows example functions and services offered by protocol layers in a user plane protocol stack in accordance with several of various embodiments of the present disclosure.

FIG. 4 shows example flow of packets through the protocol layers in accordance with several of various embodiments of the present disclosure.

FIG. 5A shows example mapping of channels between layers of the protocol stack and different physical signals in downlink in accordance with several of various embodiments of the present disclosure.

FIG. 5B shows example mapping of channels between layers of the protocol stack and different physical signals in uplink in accordance with several of various embodiments of the present disclosure.

FIG. 6 shows example physical layer processes for signal transmission in accordance with several of various embodiments of the present disclosure.

FIG. 7 shows examples of RRC states and RRC state transitions in accordance with several of various embodiments of the present disclosure.

FIG. 8 shows an example time domain transmission structure in NR by grouping OFDM symbols into slots, subframes and frames in accordance with several of various embodiments of the present disclosure.

FIG. 9 shows an example of time-frequency resource grid in accordance with several of various embodiments of the present disclosure.

FIG. 10 shows example adaptation and switching of bandwidth parts in accordance with several of various embodiments of the present disclosure.

FIG. 11A shows example arrangements of carriers in carrier aggregation in accordance with several of various embodiments of the present disclosure.

FIG. 11B shows examples of uplink control channel groups in accordance with several of various embodiments of the present disclosure.

FIG. 12A, FIG. 12B and FIG. 12C show example random access processes in accordance with several of various embodiments of the present disclosure.

FIG. 13A shows example time and frequency structure of SSBs and their associations with beams in accordance with several of various embodiments of the present disclosure.

FIG. 13B shows example time and frequency structure of CSI-RSs and their association with beams in accordance with several of various embodiments of the present disclosure.

FIG. 14A, FIG. 14B and FIG. 14C show example beam management processes in accordance with several of various embodiments of the present disclosure.

FIG. 15 shows example components of a wireless device and a base station that are in communication via an air interface in accordance with several of various embodiments of the present disclosure.

FIG. 16 shows an example process in accordance with several of various embodiments of the present disclosure.

FIG. 17 shows an example process in accordance with several of various embodiments of the present disclosure.

FIG. 18 shows an example L1 command/L2 command in accordance with several of various embodiments of the present disclosure.

FIG. 19 shows an example process in accordance with several of various embodiments of the present disclosure.

FIG. 20 shows an example L1 command/L2 command in accordance with several of various embodiments of the present disclosure.

FIG. 21 shows an example L1 command/L2 command in accordance with several of various embodiments of the present disclosure.

FIG. 22 shows an example L1 command/L2 command in accordance with several of various embodiments of the present disclosure.

FIG. 23 shows an example process in accordance with several of various embodiments of the present disclosure.

FIG. 24 shows an example process in accordance with several of various embodiments of the present disclosure.

FIG. 25 shows an example process in accordance with several of various embodiments of the present disclosure.

FIG. 26 shows an example process in accordance with several of various embodiments of the present disclosure.

FIG. 27 shows an example process in accordance with several of various embodiments of the present disclosure.

FIG. 28 shows an example process in accordance with several of various embodiments of the present disclosure.

FIG. 29 shows an example process in accordance with several of various embodiments of the present disclosure.

FIG. 30 shows an example process in accordance with several of various embodiments of the present disclosure.

FIG. 31 shows an example process in accordance with several of various embodiments of the present disclosure.

FIG. 32 shows an example L1 command/L2 command in accordance with several of various embodiments of the present disclosure.

FIG. 33 shows an example timing advance group (TAG) in accordance with several of various embodiments of the present disclosure.

FIG. 34 shows an example TAG in accordance with several of various embodiments of the present disclosure.

FIG. 35 shows an example process in accordance with several of various embodiments of the present disclosure.

FIG. 36 shows an example process in accordance with several of various embodiments of the present disclosure.

FIG. 37 shows an example process in accordance with several of various embodiments of the present disclosure.

FIG. 38 shows an example process in accordance with several of various embodiments of the present disclosure.

FIG. 39 shows an example flow diagram in accordance with several of various embodiments of the present disclosure.

FIG. 40 shows an example flow diagram in accordance with several of various embodiments of the present disclosure.

### DETAILED DESCRIPTION

The exemplary embodiments of the disclosed technology enhance the processes in a wireless device and/or one or more base stations for cell discontinuous transmission (DTX) discontinuous reception (DRX). The exemplary disclosed embodiments may be implemented in the technical field of wireless communication systems. More particularly, the embodiments of the disclosed technology enhance physical and MAC layer processes for operations of one or more cells according to one or more DTX/DRX patterns.

The devices and/or nodes of the mobile communications system disclosed herein may be implemented based on various technologies and/or various releases/versions/amendments of a technology. The various technologies include various releases of long-term evolution (LTE) technologies, various releases of 5G new radio (NR) technologies, various wireless local area networks technologies and/or a combination thereof and/or alike. For example, a base station may support a given technology and may communicate with wireless devices with different characteristics. The wireless devices may have different categories that define their capabilities in terms of supporting various features. The wireless device with the same category may have different capabilities. The wireless devices may support various technologies such as various releases of LTE technologies, various releases of 5G NR technologies and/or a combination thereof and/or alike. At least some of the wireless devices in the mobile communications system of the present disclosure may be stationary or almost stationary. In this disclosure, the terms “mobile communications system” and “wireless communications system” may be used interchangeably.

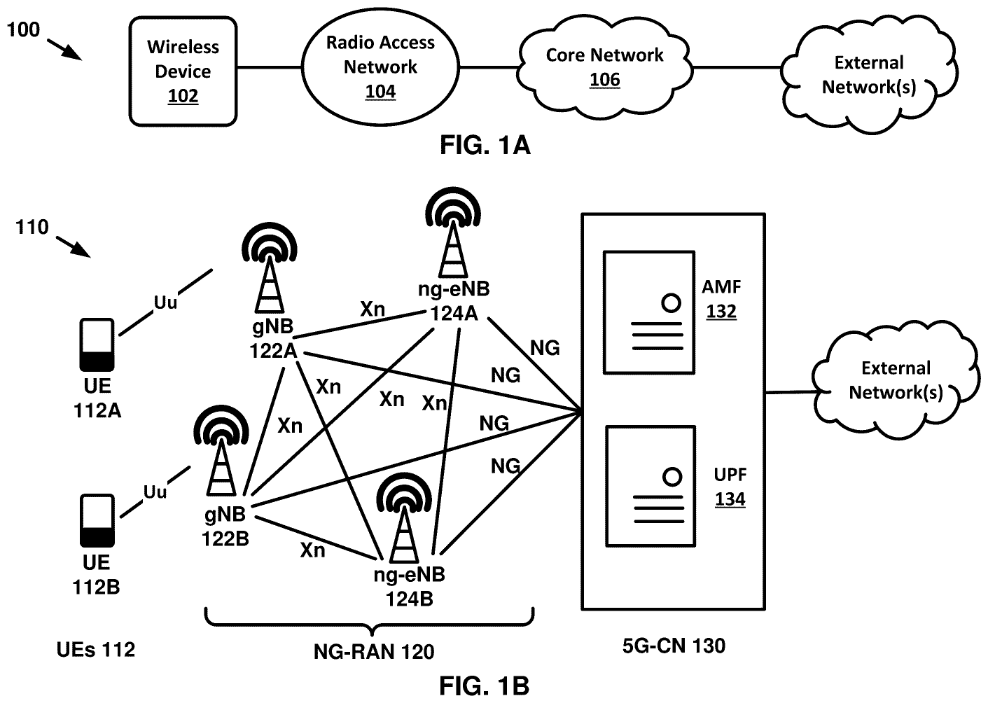

FIG. 1A shows an example of a mobile communications system 100 in accordance with several of various embodiments of the present disclosure. The mobile communications system 100 may be, for example, run by a mobile network operator (MNO) or a mobile virtual network operator (MVNO). The mobile communications system 100 may be a public land mobile network (PLMN) run by a network operator providing a variety of service including voice, data, short messaging service (SMS), multimedia messaging service (MMS), emergency calls, etc. The mobile communications system 100 includes a core network (CN) 106, a radio access network (RAN) 104 and at least one wireless device 102.

The CN 106 connects the RAN 104 to one or more external networks (e.g., one or more data networks such as the Internet) and is responsible for functions such as authentication, charging and end-to-end connection establishment. Several radio access technologies (RATs) may be served by the same CN 106.

The RAN 104 may implement a RAT and may operate between the at least one wireless device 102 and the CN 106. The RAN 104 may handle radio related functionalities such as scheduling, radio resource control, modulation and coding, multi-antenna transmissions and retransmission protocols. The wireless device and the RAN may share a portion of the radio spectrum by separating transmissions from the wireless device to the RAN and the transmissions from the RAN to the wireless device. The direction of the transmissions from the wireless device to the RAN is known as the uplink and the direction of the transmissions from the RAN to the wireless device is known as the downlink. The separation of uplink and downlink transmissions may be achieved by employing a duplexing technique. Example duplexing techniques include frequency division duplexing (FDD), time division duplexing (TDD) or a combination of FDD and TDD.

In this disclosure, the term wireless device may refer to a device that communicates with a network entity or another device using wireless communication techniques. The wireless device may be a mobile device or a non-mobile (e.g., fixed) device. Examples of the wireless device include cellular phone, smart phone, tablet, laptop computer, wearable device (e.g., smart watch, smart shoe, fitness trackers, smart clothing, etc.), wireless sensor, wireless meter, extended reality (XR) devices including augmented reality (AR) and virtual reality (VR) devices, Internet of Things (IoT) device, vehicle to vehicle communications device, road-side units (RSU), automobile, relay node or any combination thereof. In some examples, the wireless device (e.g., a smart phone, tablet, etc.) may have an interface (e.g., a graphical user interface (GUI)) for configuration by an end user. In some examples, the wireless device (e.g., a wireless sensor device, etc.) may not have an interface for configuration by an end user. The wireless device may be referred to as a user equipment (UE), a mobile station (MS), a subscriber unit, a handset, an access terminal, a user terminal, a wireless transmit and receive unit (WTRU) and/or other terminology.

The at least one wireless device may communicate with at least one base station in the RAN 104. In this disclosure, the term base station may encompass terminologies associated with various RATs. For example, a base station may be referred to as a Node B in a 3G cellular system such as Universal Mobile Telecommunication Systems (UMTS), an evolved Node B (eNB) in a 4G cellular system such as evolved universal terrestrial radio access (E-UTRA), a next generation eNB (ng-eNB), a Next Generation Node B (gNB) in NR and/or a 5G system, an access point (AP) in Wi-Fi and/or other wireless local area networks. A base station may be referred to as a remote radio head (RRH), a baseband unit (BBU) in connection with one or more RRHs, a repeater or relay for coverage extension and/or any combination thereof. In some examples, all protocol layers of a base station may be implemented in one unit. In some examples, some of the protocol layers (e.g., upper layers) of the base station may be implemented in a first unit (e.g., a central unit (CU)) and some other protocol layer (e.g., lower layers) may be implemented in one or more second units (e.g., distributed units (DUs)).

A base station in the RAN 104 includes one or more antennas to communicate with the at least one wireless device. The base station may communicate with the at least one wireless device using radio frequency (RF) transmissions and receptions via RF transceivers. The base station antennas may control one or more cells (or sectors). The size and/or radio coverage area of a cell may depend on the range that transmissions by a wireless device can be successfully received by the base station when the wireless device transmits using the RF frequency of the cell. The base station may be associated with cells of various sizes. At a given location, the wireless device may be in coverage area of a first cell of the base station and may not be in coverage area of a second cell of the base station depending on the sizes of the first cell and the second cell.

A base station in the RAN 104 may have various implementations. For example, a base station may be implemented by connecting a BBU (or a BBU pool) coupled to one or more RRHs and/or one or more relay nodes to extend the cell coverage. The BBU pool may be located at a centralized site like a cloud or data center. The BBU pool may be connected to a plurality of RRHs that control a plurality of cells. The combination of BBU with the one or more RRHs may be referred to as a centralized or cloud RAN (C-RAN) architecture. In some implementations, the BBU functions may be implemented on virtual machines (VMs) on servers at a centralized location. This architecture may be referred to as virtual RAN (vRAN). All, most or a portion of the protocol layer functions (e.g., all or portions of physical layer, medium access control (MAC) layer and/or higher layers) may be implemented at the BBU pool and the processed data may be transmitted to the RRHs for further processing and/or RF transmission. The links between the BBU pool and the RRHs may be referred to as fronthaul.

In some deployment scenarios, the RAN 104 may include macrocell base stations with high transmission power levels and large coverage areas. In other deployment scenarios, the RAN 104 may include base stations that employ different transmission power levels and/or have cells with different coverage areas. For example, some base station may be macrocell base stations with high transmission powers and/or large coverage areas and other base station may be small cell base stations with comparatively smaller transmission powers and/or coverage areas. In some deployment scenarios, a small cell base station may have coverage that is within or has overlap with coverage area of a macrocell base station. A wireless device may communicate with the macrocell base station while within the coverage area of the macrocell base station. For additional capacity, the wireless device may communicate with both the macrocell base station and the small cell base station while in the overlapped coverage area of the macrocell base station and the small cell base station. Depending on their coverage areas, a small cell base station may be referred to as a microcell base station, a picocell base station, a femtocell base station or a home base station.

Different standard development organizations (SDOs) have specified, or may specify in future, mobile communications systems that have similar characteristics as the mobile communications system 100 of FIG. 1A. For example, the Third-Generation Partnership Project (3GPP) is a group of SDOs that provides specifications that define 3GPP technologies for mobile communications systems that are akin to the mobile communications system 100. The 3GPP has developed specifications for third generation (3G) mobile networks, fourth generation (4G) mobile networks and fifth generation (5G) mobile networks. The 3G, 4G and 5G networks are also known as Universal Mobile Telecommunications System (UMTS), Long Term Evolution (LTE) and 5G system (5GS), respectively. In this disclosure, embodiments are described with respect to the RAN implemented in a 3GPP 5G mobile network that is also referred to as next generation RAN (NG-RAN). The embodiments may also be implemented in other mobile communications systems such as 3G or 4G mobile networks or mobile networks that may be standardized in future such as sixth generation (6G) mobile networks or mobile networks that are implemented by standards bodies other than 3GPP. The NG-RAN may be based on a new RAT known as new radio (NR) and/or other radio access technologies such as LTE and/or non-3GPP RATs.

FIG. 1B shows an example of a mobile communications system 110 in accordance with several of various embodiments of the present disclosure. The mobile communications system 110 of FIG. 1B is an example of a 5G mobile network and includes a 5G CN (5G-CN) 130, an NG-RAN 120 and UEs (collectively 112 and individually UE 112A and UE 112B). The 5G-CN 130, the NG-RAN 120 and the UEs 112 of FIG. 1B operate substantially alike the CN 106, the RAN 104 and the at least one wireless device 102, respectively, as described for FIG. 1A.

The 5G-CN 130 of FIG. 1B connects the NG-RAN 120 to one or more external networks (e.g., one or more data networks such as the Internet) and is responsible for functions such as authentication, charging and end-to-end connection establishment. The 5G-CN has new enhancements compared to previous generations of CNs (e.g., evolved packet core (EPC) in the 4G networks) including service-based architecture, support for network slicing and control plane/user plane split. The service-based architecture of the 5G-CN provides a modular framework based on service and functionalities provided by the core network wherein a set of network functions are connected via service-based interfaces. The network slicing enables multiplexing of independent logical networks (e.g., network slices) on the same physical network infrastructure. For example, a network slice may be for mobile broadband applications with full mobility support and a different network slice may be for non-mobile latency-critical applications such as industry automation. The control plane/user plane split enables independent scaling of the control plane and the user plane. For example, the control plane capacity may be increased without affecting the user plane of the network.

The 5G-CN 130 of FIG. 1B includes an access and mobility management function (AMF) 132 and a user plane function (UPF) 134. The AMF 132 may support termination of non-access stratum (NAS) signaling, NAS signaling security such as ciphering and integrity protection, inter-3GPP access network mobility, registration management, connection management, mobility management, access authentication and authorization and security context management. The NAS is a functional layer between a UE and the CN and the access stratum (AS) is a functional layer between the UE and the RAN. The UPF 134 may serve as an interconnect point between the NG-RAN and an external data network. The UPF may support packet routing and forwarding, packet inspection and Quality of Service (QoS) handling and packet filtering. The UPF may further act as a Protocol Data Unit (PDU) session anchor point for mobility within and between RATs.

The 5G-CN 130 may include additional network functions (not shown in FIG. 1B) such as one or more Session Management Functions (SMFs), a Policy Control Function (PCF), a Network Exposure Function (NEF), a Unified Data Management (UDM), an Application Function (AF), and/or an Authentication Server Function (AUSF). These network functions along with the AMF 132 and UPF 134 enable a service-based architecture for the 5G-CN.

The NG-RAN 120 may operate between the UEs 112 and the 5G-CN 130 and may implement one or more RATs. The NG-RAN 120 may include one or more gNBs (e.g., gNB 122A or gNB 122B or collectively gNBs 122) and/or one or more ng-eNBs (e.g., ng-eNB 124A or ng-eNB 124B or collectively ng-eNBs 124). The general terminology for gNBs 122 and/or an ng-eNBs 124 is a base station and may be used interchangeably in this disclosure. The gNBs 122 and the ng-eNBs 124 may include one or more antennas to communicate with the UEs 112. The one or more antennas of the gNBs 122 or ng-eNBs 124 may control one or more cells (or sectors) that provide radio coverage for the UEs 112.

A gNB and/or an ng-eNB of FIG. 1B may be connected to the 5G-CN 130 using an NG interface. A gNB and/or an ng-eNB may be connected with other gNBs and/or ng-eNBs using an Xn interface. The NG or the Xn interfaces are logical connections that may be established using an underlying transport network. The interface between a UE and a gNB or between a UE and an ng-eNBs may be referred to as the Uu interface. An interface (e.g., Uu, NG or Xn) may be established by using a protocol stack that enables data and control signaling exchange between entities in the mobile communications system of FIG. 1B. When a protocol stack is used for transmission of user data, the protocol stack may be referred to as user plane protocol stack. When a protocol stack is used for transmission of control signaling, the protocol stack may be referred to as control plane protocol stack. Some protocol layer may be used in both of the user plane protocol stack and the control plane protocol stack while other protocol layers may be specific to the user plane or control plane.

The NG interface of FIG. 1B may include an NG-User plane (NG-U) interface between a gNB and the UPF 134 (or an ng-eNB and the UPF 134) and an NG-Control plane (NG-C) interface between a gNB and the AMF 132 (or an ng-eNB and the AMF 132). The NG-U interface may provide non-guaranteed delivery of user plane PDUs between a gNB and the UPF or an ng-eNB and the UPF. The NG-C interface may provide services such as NG interface management, UE context management, UE mobility management, transport of NAS messages, paging, PDU session management, configuration transfer and/or warning message transmission.

The UEs 112 and a gNB may be connected using the Uu interface and using the NR user plane and control plane protocol stack. The UEs 112 and an ng-eNB may be connected using the Uu interface using the LTE user plane and control plane protocol stack.

In the example mobile communications system of FIG. 1B, a 5G-CN is connected to a RAN comprised of 4G LTE and/or 5G NR RATs. In other example mobile communications systems, a RAN based on the 5G NR RAT may be connected to a 4G CN (e.g., EPC). For example, earlier releases of 5G standards may support a non-standalone mode of operation where a NR based RAN is connected to the 4G EPC. In an example non-standalone mode, a UE may be connected to both a 5G NR gNB and a 4G LTE eNB (e.g., a ng-eNB) and the control plane functionalities (such as initial access, paging and mobility) may be provided through the 4G LTE eNB. In a standalone operation, the 5G NR gNB is connected to a 5G-CN and the user plane and the control plane functionalities are provided by the 5G NR gNB.

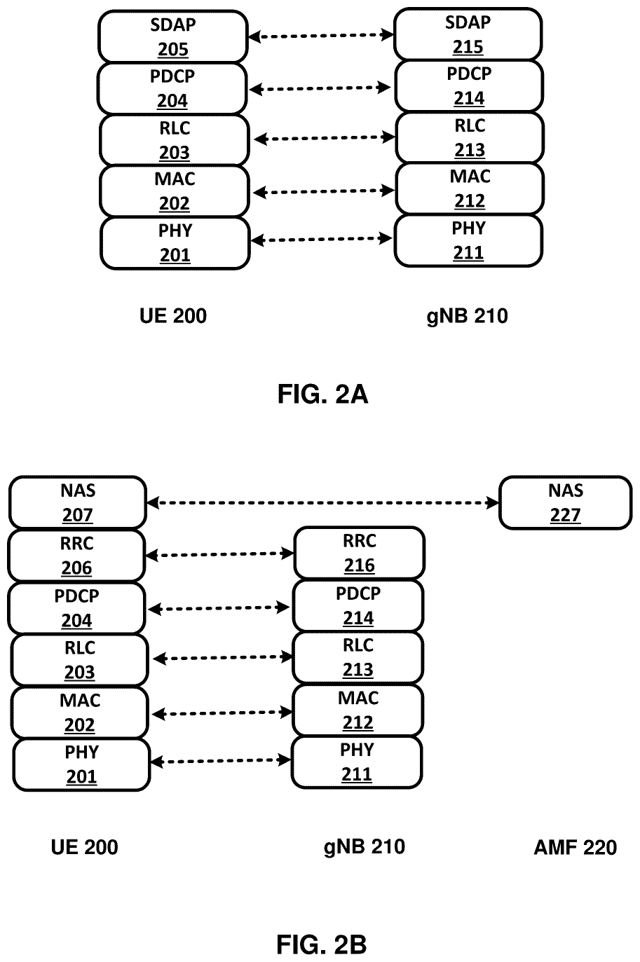

FIG. 2A shows an example of the protocol stack for the user plan of an NR Uu interface in accordance with several of various embodiments of the present disclosure. The user plane protocol stack comprises five protocol layers that terminate at the UE 200 and the gNB 210. The five protocol layers, as shown in FIG. 2A, include physical (PHY) layer referred to as PHY 201 at the UE 200 and PHY 211 at the gNB 210, medium access control (MAC) layer referred to as MAC 202 at the UE 200 and MAC 212 at the gNB 210, radio link control (RLC) layer referred to as RLC 203 at the UE 200 and RLC 213 at the gNB 210, packet data convergence protocol (PDCP) layer referred to as PDCP 204 at the UE 200 and PDCP 214 at the gNB 210, and service data application protocol (SDAP) layer referred to as SDAP 205 at the UE 200 and SDAP 215 at the gNB 210. The PHY layer, also known as layer 1 (L1), offers transport services to higher layers. The other four layers of the protocol stack (MAC, RLC, PDCP and SDAP) are collectively known as layer 2 (L2).

FIG. 2B shows an example of the protocol stack for the control plan of an NR Uu interface in accordance with several of various embodiments of the present disclosure. Some of the protocol layers (PHY, MAC, RLC and PDCP) are common between the user plane protocol stack shown in FIG. 2A and the control plan protocol stack. The control plane protocol stack also includes the RRC layer, referred to RRC 206 at the UE 200 and RRC 216 at the gNB 210, that also terminates at the UE 200 and the gNB 210. In addition, the control plane protocol stack includes the NAS layer that terminates at the UE 200 and the AMF 220. In FIG. 2B, the NAS layer is referred to as NAS 207 at the UE 200 and NAS 227 at the AMF 220.

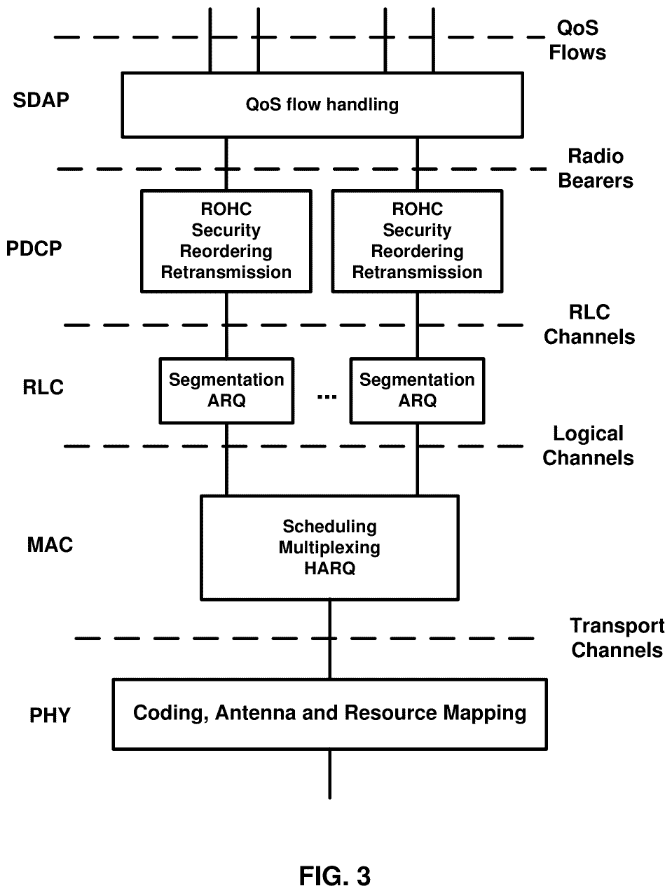

FIG. 3 shows example functions and services offered to other layers by a layer in the NR user plane protocol stack of FIG. 2A in accordance with several of various embodiments of the present disclosure. For example, the SDAP layer of FIG. 3 (shown in FIG. 2A as SDAP 205 at the UE side and SDAP 215 at the gNB side) may perform mapping and de-mapping of QoS flows to data radio bearers. The mapping and de-mapping may be based on QoS (e.g., delay, throughput, jitter, error rate, etc.) associated with a QoS flow. A QoS flow may be a QoS differentiation granularity for a PDU session which is a logical connection between a UE 200 and a data network. A PDU session may contain one or more QoS flows. The functions and services of the SDAP layer include mapping and de-mapping between one or more QoS flows and one or more data radio bearers. The SDAP layer may also mark the uplink and/or downlink packets with a QoS flow ID (QFI).

The PDCP layer of FIG. 3 (shown in FIG. 2A as PDCP 204 at the UE side and PDCP 214 at the gNB side) may perform header compression and decompression (e.g., using Robust Header Compression (ROHC) protocol) to reduce the protocol header overhead, ciphering and deciphering and integrity protection and verification to enhance the security over the air interface, reordering and in-order delivery of packets and discarding of duplicate packets. A UE may be configured with one PDCP entity per bearer.

In an example scenario not shown in FIG. 3, a UE may be configured with dual connectivity and may connect to two different cell groups provided by two different base stations. For example, a base station of the two base stations may be referred to as a master base station and a cell group provided by the master base station may be referred to as a master cell group (MCG). The other base station of the two base stations may be referred to as a secondary base station and the cell group provided by the secondary base station may be referred to as a secondary cell group (SCG). A bearer may be configured for the UE as a split bearer that may be handled by the two different cell groups. The PDCP layer may perform routing of packets corresponding to a split bearer to and/or from RLC channels associated with the cell groups.

In an example scenario not shown in FIG. 3, a bearer of the UE may be configured (e.g., with control signaling) with PDCP packet duplication. A bearer configured with PDCP duplication may be mapped to a plurality of RLC channels each corresponding to different one or more cells. The PDCP layer may duplicate packets of the bearer configured with PDCP duplication and the duplicated packets may be mapped to the different RLC channels. With PDCP packet duplication, the likelihood of correct reception of packets increases thereby enabling higher reliability.

The RLC layer of FIG. 3 (shown in FIG. 2A as RLC 203 at the UE side and RLC 213 at the gNB side) provides service to upper layers in the form of RLC channels. The RLC layer may include three transmission modes: transparent mode (TM), Unacknowledged mode (UM) and Acknowledged mode (AM). The RLC layer may perform error correction through automatic repeat request (ARQ) for the AM transmission mode, segmentation of RLC service data units (SDUs) for the AM and UM transmission modes and re-segmentation of RLC SDUs for AM transmission mode, duplicate detection for the AM transmission mode, RLC SDU discard for the AM and UM transmission modes, etc. The UE may be configured with one RLC entity per RLC channel.

The MAC layer of FIG. 3 (shown in FIG. 2A as MAC 202 at the UE side and MAC 212 at the gNB side) provides services to the RLC layer in form of logical channels. The MAC layer may perform mapping between logical channels and transport channels, multiplexing/demultiplexing of MAC SDUs belonging to one or more logical channels into/from transport blocks (TBs) delivered to/from the physical layer on transport channels, reporting of scheduling information, error correction through hybrid automatic repeat request (HARQ), priority handling between UEs by means of dynamic scheduling, priority handling between logical channels of one UE by means of logical channel prioritization and/or padding. In case of carrier aggregation, a MAC entity may comprise one HARQ entity per cell. A MAC entity may support multiple numerologies, transmission timings and cells. The control signaling may configure logical channels with mapping restrictions. The mapping restrictions in logical channel prioritization may control the numerology(ies), cell(s), and/or transmission timing(s)/duration(s) that a logical channel may use.

The PHY layer of FIG. 3 (shown in FIG. 2A as PHY 201 at the UE side and PHY 211 at the gNB side) provides transport services to the MAC layer in form of transport channels. The physical layer may handle coding/decoding, HARQ soft combining, rate matching of a coded transport channel to physical channels, mapping of coded transport channels to physical channels, modulation and demodulation of physical channels, frequency and time synchronization, radio characteristics measurements and indication to higher layers, RF processing, and mapping to antennas and radio resources.

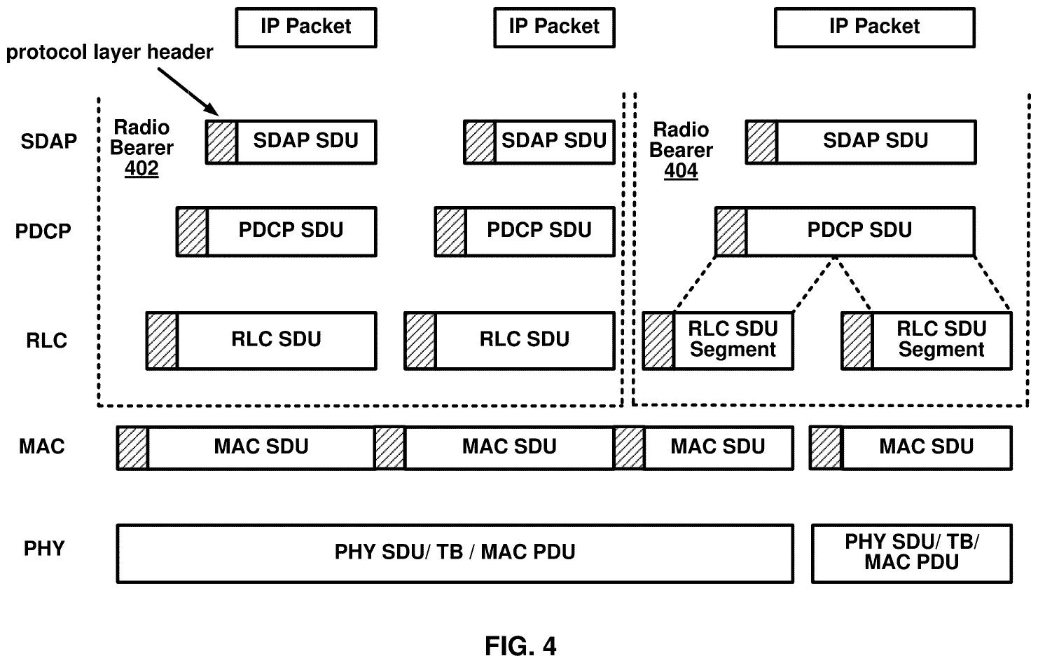

FIG. 4 shows example processing of packets at different protocol layers in accordance with several of various embodiments of the present disclosure. In this example, three Internet Protocol (IP) packets that are processed by the different layers of the NR protocol stack. The term SDU shown in FIG. 4 is the data unit that is entered from/to a higher layer. In contrast, a protocol data unit (PDU) is the data unit that is entered to/from a lower layer. The flow of packets in FIG. 4 is for downlink. An uplink data flow through layers of the NR protocol stack is similar to FIG. 4. In this example, the two leftmost IP packets are mapped by the SDAP layer (shown as SDAP 205 and SDAP 215 in FIG. 2A) to radio bearer 402 and the rightmost packet is mapped by the SDAP layer to the radio bearer 404. The SDAP layer adds SDAP headers to the IP packets which are entered into the PDCP layer as PDCP SDUs. The PDCP layer is shown as PDCP 204 and PDCP 214 in FIG. 2A. The PDCP layer adds the PDCP headers to the PDCP SDUs which are entered into the RLC layer as RLC SDUs. The RLC layer is shown as RLC 203 and RLC 213 in FIG. 2A. An RLC SDU may be segmented at the RLC layer. The RLC layer adds RLC headers to the RLC SDUs after segmentation (if segmented) which are entered into the MAC layer as MAC SDUs. The MAC layer adds the MAC headers to the MAC SDUs and multiplexes one or more MAC SDUs to form a PHY SDU (also referred to as a transport block (TB) or a MAC PDU).

In FIG. 4, the MAC SDUs are multiplexed to form a transport block. The MAC layer may multiplex one or more MAC control elements (MAC CEs) with zero or more MAC SDUs to form a transport block. The MAC CEs may also be referred to as MAC commands or MAC layer control signaling and may be used for in-band control signaling. The MAC CEs may be transmitted by a base station to a UE (e.g., downlink MAC CEs) or by a UE to a base station (e.g., uplink MAC CEs). The MAC CEs may be used for transmission of information useful by a gNB for scheduling (e.g., buffer status report (BSR) or power headroom report (PHR)), activation/deactivation of one or more cells, activation/deactivation of configured radio resources for or one or more processes, activation/deactivation of one or more processes, indication of parameters used in one or more processes, etc.

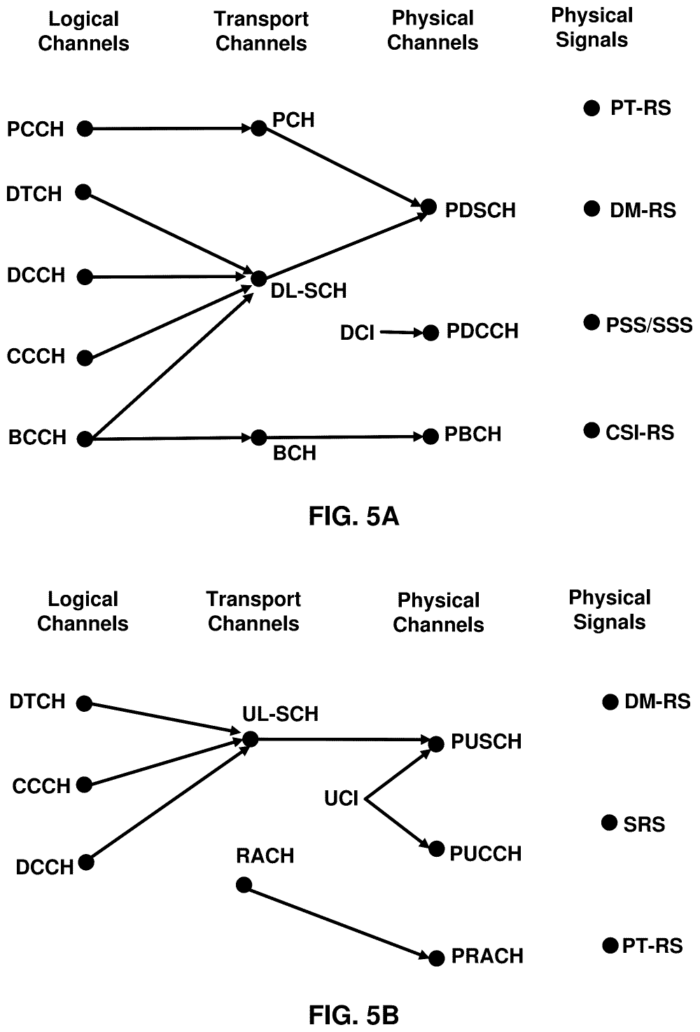

FIG. 5A and FIG. 5B show example mapping between logical channels, transport channels and physical channels for downlink and uplink, respectively in accordance with several of various embodiments of the present disclosure. As discussed before, the MAC layer provides services to higher layer in the form of logical channels. A logical channel may be classified as a control channel, if used for transmission of control and/or configuration information, or a traffic channel if used for transmission of user data. Example logical channels in NR include Broadcast Control Channel (BCCH) used for transmission of broadcast system control information, Paging Control Channel (PCCH) used for carrying paging messages for wireless devices with unknown locations, Common Control Channel (CCCH) used for transmission of control information between UEs and network and for UEs that have no RRC connection with the network, Dedicated Control Channel (DCCH) which is a point-to-point bi-directional channel for transmission of dedicated control information between a UE that has an RRC connection and the network and Dedicated Traffic Channel (DTCH) which is point-to-point channel, dedicated to one UE, for the transfer of user information and may exist in both uplink and downlink.

As discussed before, the PHY layer provides services to the MAC layer and higher layers in the form of transport channels. Example transport channels in NR include Broadcast Channel (BCH) used for transmission of part of the BCCH referred to as master information block (MIB), Downlink Shared Channel (DL-SCH) used for transmission of data (e.g., from DTCH in downlink) and various control information (e.g., from DCCH and CCCH in downlink and part of the BCCH that is not mapped to the BCH), Uplink Shared Channel (UL-SCH) used for transmission of uplink data (e.g., from DTCH in uplink) and control information (e.g., from CCCH and DCCH in uplink) and Paging Channel (PCH) used for transmission of paging information from the PCCH. In addition, Random Access Channel (RACH) is a transport channel used for transmission of random access preambles. The RACH does not carry a transport block. Data on a transport channel (except RACH) may be organized in transport blocks, wherein One or more transport blocks may be transmitted in a transmission time interval (TTI).

The PHY layer may map the transport channels to physical channels. A physical channel may correspond to time-frequency resources that are used for transmission of information from one or more transport channels. In addition to mapping transport channels to physical channels, the physical layer may generate control information (e.g., downlink control information (DCI) or uplink control information (UCI)) that may be carried by the physical channels. Example DCI include scheduling information (e.g., downlink assignments and uplink grants), request for channel state information report, power control command, etc. Example UCI include HARQ feedback indicating correct or incorrect reception of downlink transport blocks, channel state information report, scheduling request, etc. Example physical channels in NR include a Physical Broadcast Channel (PBCH) for carrying information from the BCH, a Physical Downlink Shared Channel (PDSCH) for carrying information form the PCH and the DL-SCH, a Physical Downlink Control Channel (PDCCH) for carrying DCI, a Physical Uplink Shared Channel (PUSCH) for carrying information from the UL-SCH and/or UCI, a Physical Uplink Control Channel (PUCCH) for carrying UCI and Physical Random Access Channel (PRACH) for transmission of RACH (e.g., random access preamble).

The PHY layer may also generate physical signals that are not originated from higher layers. As shown in FIG. 5A, example downlink physical signals include Demodulation Reference Signal (DM-RS), Phase Tracking Reference Signal (PT-RS), Channel State Information Reference Signal (CSI-RS), Primary Synchronization Signal (PSS) and Secondary Synchronization Signal (SSS). As shown in FIG. 5B, example uplink physical signals include DM-RS, PT-RS and sounding reference signal (SRS).

As indicated earlier, some of the protocol layers (PHY, MAC, RLC and PDCP) of the control plane of an NR Uu interface, are common between the user plane protocol stack (as shown in FIG. 2A) and the control plane protocol stack (as shown in FIG. 2B). In addition to PHY, MAC, RLC and PDCP, the control plane protocol stack includes the RRC protocol layer and the NAS protocol layer.

The NAS layer, as shown in FIG. 2B, terminates at the UE 200 and the AMF 220 entity of the 5G-C 130. The NAS layer is used for core network related functions and signaling including registration, authentication, location update and session management. The NAS layer uses services from the AS of the Uu interface to transmit the NAS messages.

The RRC layer, as shown in FIG. 2B, operates between the UE 200 and the gNB 210 (more generally NG-RAN 120) and may provide services and functions such as broadcast of system information (SI) related to AS and NAS as well as paging initiated by the 5G-C 130 or NG-RAN 120. In addition, the RRC layer is responsible for establishment, maintenance and release of an RRC connection between the UE 200 and the NG-RAN 120, carrier aggregation configuration (e.g., addition, modification and release), dual connectivity configuration (e.g., addition, modification and release), security related functions, radio bearer configuration/maintenance and release, mobility management (e.g., maintenance and context transfer), UE cell selection and reselection, inter-RAT mobility, QoS management functions, UE measurement reporting and control, radio link failure (RLF) detection and NAS message transfer. The RRC layer uses services from PHY, MAC, RLC and PDCP layers to transmit RRC messages using signaling radio bearers (SRBs). The SRBs are mapped to CCCH logical channel during connection establishment and to DCCH logical channel after connection establishment.

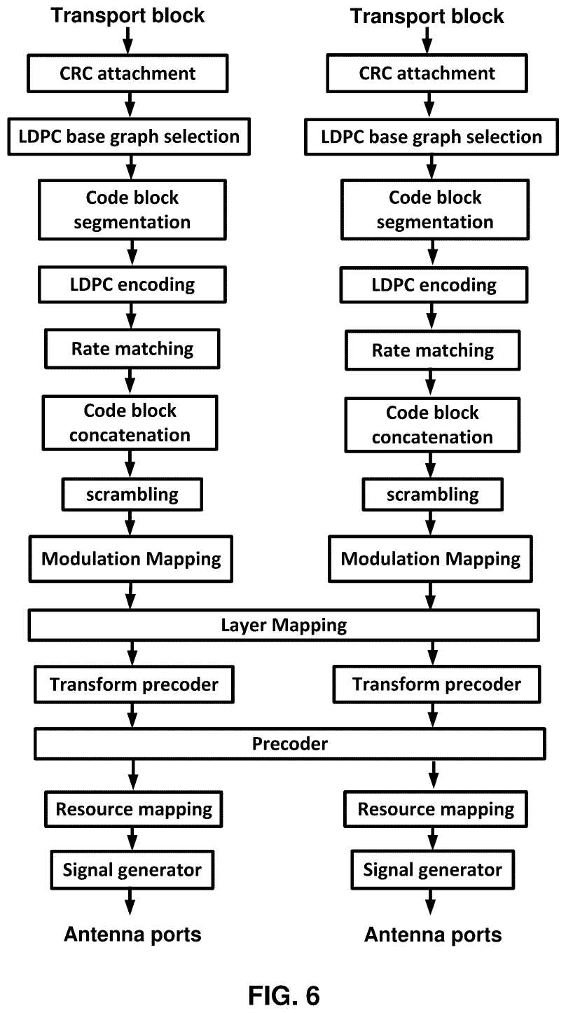

FIG. 6 shows example physical layer processes for signal transmission in accordance with several of various embodiments of the present disclosure. Data and/or control streams from MAC layer may be encoded/decoded to offer transport and control services over the radio transmission link. For example, one or more (e.g., two as shown in FIG. 6) transport blocks may be received from the MAC layer for transmission via a physical channel (e.g., a physical downlink shared channel or a physical uplink shared channel). A cyclic redundancy check (CRC) may be calculated and attached to a transport block in the physical layer. The CRC calculation may be based on one or more cyclic generator polynomials. The CRC may be used by the receiver for error detection. Following the transport block CRC attachment, a low-density parity check (LDPC) base graph selection may be performed. In example embodiments, two LDPC base graphs may be used wherein a first LDPC base graph may be optimized for small transport blocks and a second LDPC base graph may be optimized for comparatively larger transport blocks.

The transport block may be segmented into code blocks and code block CRC may be calculated and attached to a code block. A code block may be LDPC coded and the LDPC coded blocks may be individually rate matched. The code blocks may be concatenated to create one or more codewords. The contents of a codeword may be scrambled and modulated to generate a block of complex-valued modulation symbols. The modulation symbols may be mapped to a plurality of transmission layers (e.g., multiple-input multiple-output (MIMO) layers) and the transmission layers may be subject to transform precoding and/or precoding. The precoded complex-valued symbols may be mapped to radio resources (e.g., resource elements). The signal generator block may create a baseband signal and up-convert the baseband signal to a carrier frequency for transmission via antenna ports. The signal generator block may employ mixers, filters and/or other radio frequency (RF) components prior to transmission via the antennas. The functions and blocks in FIG. 6 are illustrated as examples and other mechanisms may be implemented in various embodiments.

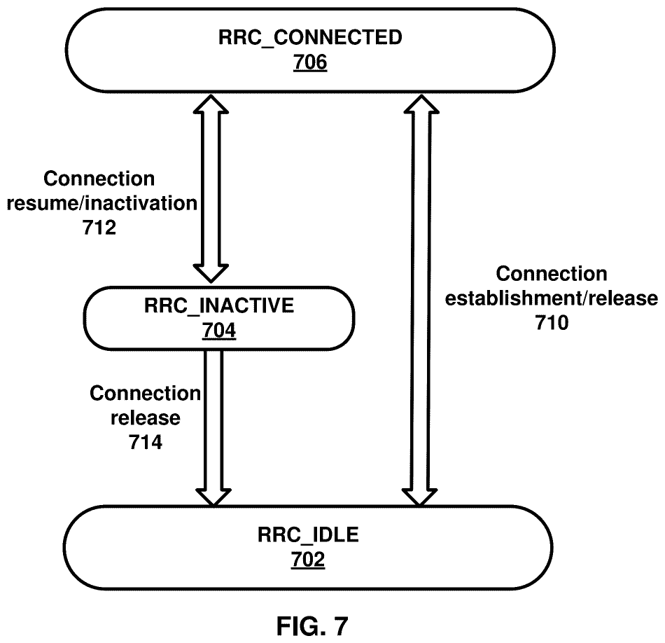

FIG. 7 shows examples of RRC states and RRC state transitions at a UE in accordance with several of various embodiments of the present disclosure. A UE may be in one of three RRC states: RRC_IDLE 702, RRC INACTIVE 704 and RRC_CONNECTED 706. In RRC_IDLE 702 state, no RRC context (e.g., parameters needed for communications between the UE and the network) may be established for the UE in the RAN. In RRC_IDLE 702 state, no data transfer between the UE and the network may take place and uplink synchronization is not maintained. The wireless device may sleep most of the time and may wake up periodically to receive paging messages. The uplink transmission of the UE may be based on a random access process and to enable transition to the RRC_CONNECTED 706 state. The mobility in RRC_IDLE 702 state is through a cell reselection procedure where the UE camps on a cell based on one or more criteria including signal strength that is determined based on the UE measurements.

In RRC_CONNECTED 706 state, the RRC context is established and both the UE and the RAN have necessary parameters to enable communications between the UE and the network. In the RRC_CONNECTED 706 state, the UE is configured with an identity known as a Cell Radio Network Temporary Identifier (C-RNTI) that is used for signaling purposes (e.g., uplink and downlink scheduling, etc.) between the UE and the RAN. The wireless device mobility in the RRC_CONNECTED 706 state is managed by the RAN. The wireless device provides neighboring cells and/or current serving cell measurements to the network and the network may make hand over decisions. Based on the wireless device measurements, the current serving base station may send a handover request message to a neighboring base station and may send a handover command to the wireless device to handover to a cell of the neighboring base station. The transition of the wireless device from the RRC_IDLE 702 state to the RRC_CONNECTED 706 state or from the RRC_CONNECTED 706 state to the RRC_IDLE 702 state may be based on connection establishment and connection release procedures (shown collectively as connection establishment/release 710 in FIG. 7).

To enable a faster transition to the RRC_CONNECTED 706 state (e.g., compared to transition from RRC_IDLE 702 state to RRC_CONNECTED 706 state), an RRC_INACTIVE 704 state is used for an NR UE wherein, the RRC context is kept at the UE and the RAN. The transition from the RRC_INACTIVE 704 state to the RRC_CONNECTED 706 state is handled by RAN without CN signaling. Similar to the RRC_IDLE 702 state, the mobility in RRC_INACTIVE 704 state is based on a cell reselection procedure without involvement from the network. The transition of the wireless device from the RRC_INACTIVE 704 state to the RRC_CONNECTED 706 state or from the RRC_CONNECTED 706 state to the RRC_INACTIVE 704 state may be based on connection resume and connection inactivation procedures (shown collectively as connection resume/inactivation 712 in FIG. 7). The transition of the wireless device from the RRC_INACTIVE 704 state to the RRC_IDLE 702 state may be based on a connection release 714 procedure as shown in FIG. 7.

In NR, Orthogonal Frequency Division Multiplexing (OFDM), also called cyclic prefix OFDM (CP-OFDM), is the baseline transmission scheme in both downlink and uplink of NR and the Discrete Fourier Transform (DFT) spread OFDM (DFT-s-OFDM) is a complementary uplink transmission in addition to the baseline OFDM scheme. OFDM is multi-carrier transmission scheme wherein the transmission bandwidth may be composed of several narrowband sub-carriers. The subcarriers are modulated by the complex valued OFDM modulation symbols resulting in an OFDM signal. The complex valued OFDM modulation symbols are obtained by mapping, by a modulation mapper, the input data (e.g., binary digits) to different points of a modulation constellation diagram. The modulation constellation diagram depends on the modulation scheme. NR may use different types of modulation schemes including Binary Phase Shift Keying (BPSK), π/2-BPSK, Quadrature Phase Shift Keying (QPSK), 16 Quadrature Amplitude Modulation (16QAM), 64QAM and 256QAM. Different and/or higher order modulation schemes (e.g., M-QAM in general) may be used. An OFDM signal with N subcarriers may be generated by processing N subcarriers in parallel for example by using Inverse Fast Fourier Transform (IFFT) processing. The OFDM receiver may use FFT processing to recover the transmitted OFDM modulation symbols. The subcarrier spacing of subcarriers in an OFDM signal is inversely proportional to an OFDM modulation symbol duration. For example, for a 15 KHz subcarrier spacing, duration of an OFDM signal is nearly 66.7ps. To enhance the robustness of OFDM transmission in time dispersive channels, a cyclic prefix (CP) may be inserted at the beginning of an OFDM symbol. For example, the last part of an OFDM symbol may be copied and inserted at the beginning of an OFDM symbol. The CP insertion enhanced the OFDM transmission scheme by preserving subcarrier orthogonality in time dispersive channels.

In NR, different numerologies may be used for OFDM transmission. A numerology of OFDM transmission may indicate a subcarrier spacing and a CP duration for the OFDM transmission. For example, a subcarrier spacing in NR may generally be a multiple of 15 KHz and expressed as Δf=2^{μ}·15 KHz (μ=0, 1, 2, . . . ). Example subcarrier spacings used in NR include 15 KHz (μ=0), 30 KHz (μ=1), 60 KHz (μ=2), 120 KHz (μ=3) and 240 KHz (μ=4). As discussed before, a duration of OFDM symbol is inversely proportional to the subcarrier spacing and therefor OFDM symbol duration may depend on the numerology (e.g., the p value).

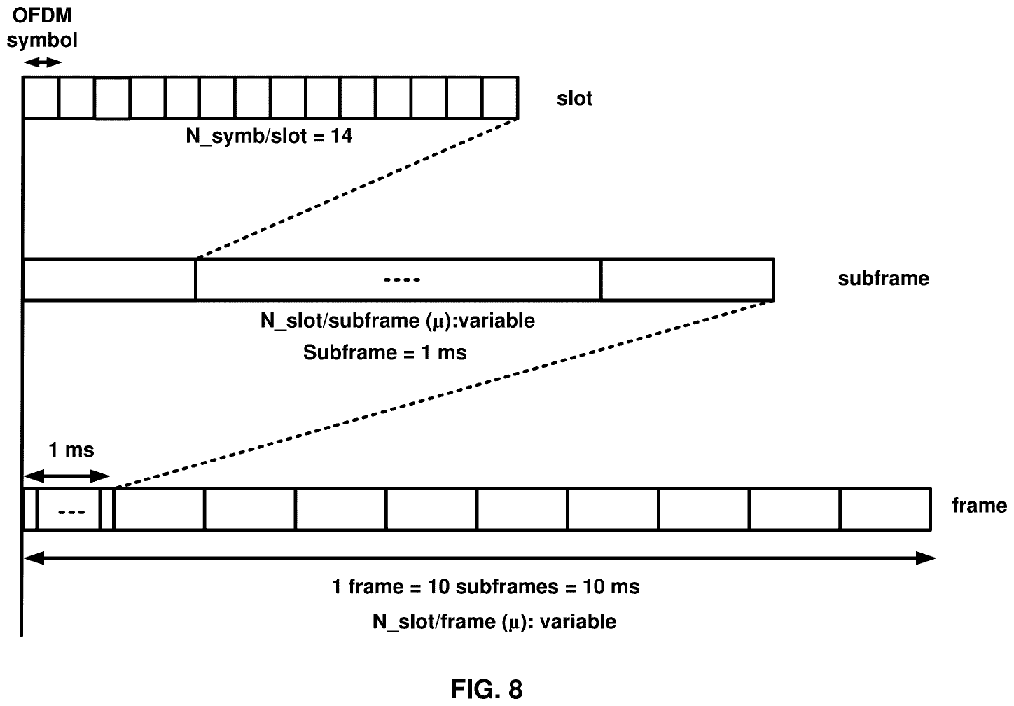

FIG. 8 shows an example time domain transmission structure in NR wherein OFDM symbols are grouped into slots, subframes and frames in accordance with several of various embodiments of the present disclosure. A slot is a group of N_{symb}^{slot} OFDM symbols, wherein the N_{symb}^{slot} may have a constant value (e.g., 14). Since different numerologies result in different OFDM symbol durations, duration of a slot may also depend on the numerology and may be variable. A subframe may have a duration of 1 ms and may be composed of one or more slots, the number of which may depend on the slot duration. The number of slots per subframe is therefore a function of μ and may generally expressed as Nₛₗₒₜ^{subframe,μ}, and the number of symbols per subframe may be expressed as N_{symb}^{subframe,μ}=N_{symb}^{slot}Nₛₗₒₜ^{subframe,μ}. A frame may have a duration of 10 ms and may consist of 10 subframes. The number of slots per frame may depend on the numerology and therefore may be variable. The number of slots per frame may generally be expressed as Nₛₗₒₜ^{frame,μ}.

An antenna port may be defined as a logical entity such that channel characteristics over which a symbol on the antenna port is conveyed may be inferred from the channel characteristics over which another symbol on the same antenna port is conveyed. For example, for DM-RS associated with a PDSCH, the channel over which a PDSCH symbol on an antenna port is conveyed may be inferred from the channel over which a DM-RS symbol on the same antenna port is conveyed, for example, if the two symbols are within the same resource as the scheduled PDSCH and/or in the same slot and/or in the same precoding resource block group (PRG). For example, for DM-RS associated with a PDCCH, the channel over which a PDCCH symbol on an antenna port is conveyed may be inferred from the channel over which a DM-RS symbol on the same antenna port is conveyed if, for example, the two symbols are within resources for which the UE may assume the same precoding being used. For example, for DM-RS associated with a PBCH, the channel over which a PBCH symbol on one antenna port is conveyed may be inferred from the channel over which a DM-RS symbol on the same antenna port is conveyed if, for example, the two symbols are within a SS/PBCH block transmitted within the same slot, and with the same block index. The antenna port may be different from a physical antenna. An antenna port may be associated with an antenna port number and different physical channels may correspond to different ranges of antenna port numbers.

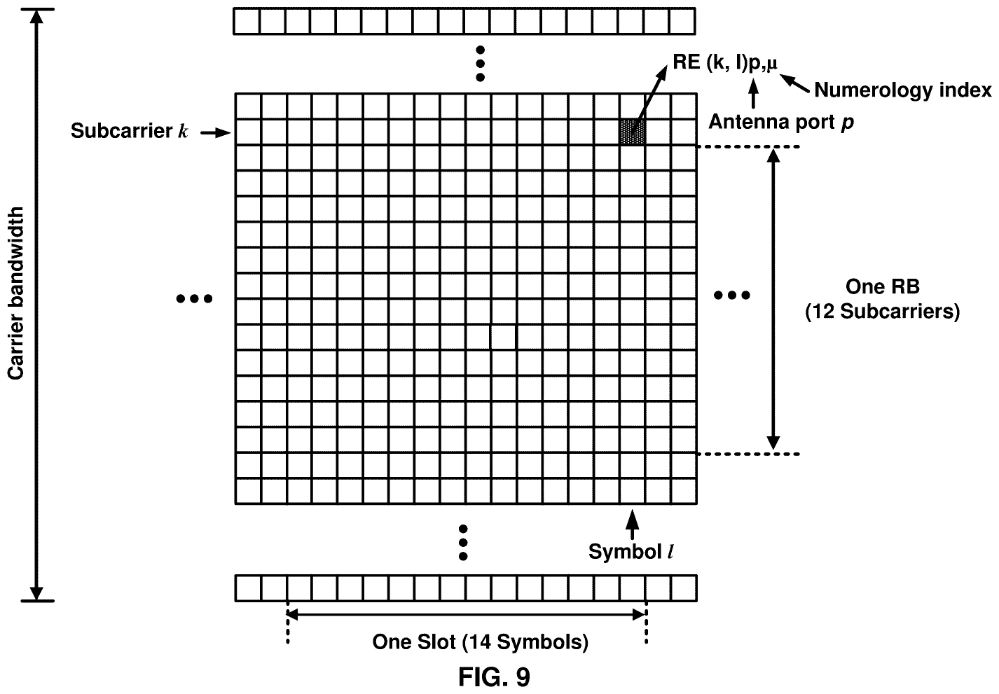

FIG. 9 shows an example of time-frequency resource grid in accordance with several of various embodiments of the present disclosure. The number of subcarriers in a carrier bandwidth may be based on the numerology of OFDM transmissions in the carrier. A resource element, corresponding to one symbol duration and one subcarrier, may be the smallest physical resource in the time-frequency grid. A resource element (RE) for antenna port p and subcarrier spacing configuration μ may be uniquely identified by (k, l)_{p,μ} where k is the index of a subcarrier in the frequency domain and l may refer to the symbol position in the time domain relative to some reference point. A resource block may be defined as N_{SC}^{RB}=12 subcarriers. Since subcarrier spacing depends on the numerology of OFDM transmission, the frequency domain span of a resource block may be variable and may depend on the numerology. For example, for a subcarrier spacing of 15 KHz (e.g., μ=0), a resource block may be 180 KHz and for a subcarrier spacing of 30 KHz (e.g., μ=1), a resource block may be 360 KHz.

With large carrier bandwidths defined in NR and due to limited capabilities for some UEs (e.g., due to hardware limitations), a UE may not support an entire carrier bandwidth. Receiving on the full carrier bandwidth may imply high energy consumption. For example, transmitting downlink control channels on the full downlink carrier bandwidth may result in high power consumption for wide carrier bandwidths. NR may use a bandwidth adaptation procedure to dynamically adapt the transmit and receive bandwidths. The transmit and receive bandwidth of a UE on a cell may be smaller than the bandwidth of the cell and may be adjusted. For example, the width of the transmit and/or receive bandwidth may change (e.g., shrink during period of low activity to save power); the location of the transmit and/or receive bandwidth may move in the frequency domain (e.g., to increase scheduling flexibility); and the subcarrier spacing of the transmit or receive bandwidth may change (e.g., to allow different services). A subset of the cell bandwidth may be referred to as a Bandwidth Part (BWP) and bandwidth adaptation may be achieved by configuring the UE with one or more BWPs. The base station may configure a UE with a set of downlink BWPs and a set of uplink BWPs. A BWP may be characterized by a numerology (e.g., subcarrier spacing and cyclic prefix) and a set of consecutive resource blocks in the numerology of the BWP. One or more first BWPs of the one or more BWPs of the cell may be active at a time. An active BWP may be an active downlink BWP or an active uplink BWP.

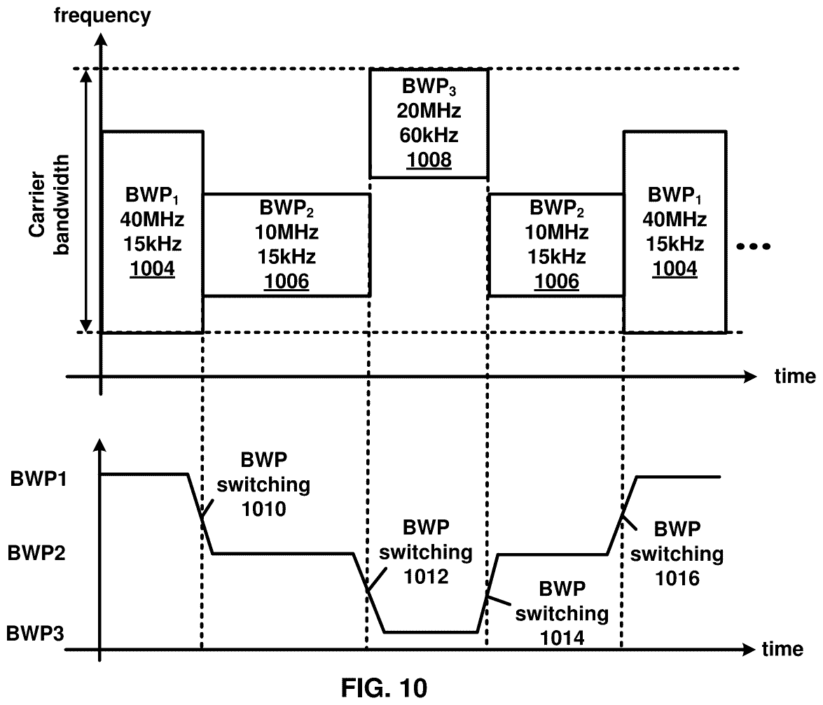

FIG. 10 shows an example of bandwidth part adaptation and switching. In this example, three BWPs (BWP₁ 1004, BWP₂ 1006 and BWP₃ 1008) are configured for a UE on a carrier bandwidth. The BWP₁ is configured with a bandwidth of 40 MHz and a numerology with subcarrier spacing of 15 KHz, the BWP₂ is configured with a bandwidth of 10 MHz and a numerology with subcarrier spacing of 15 KHz and the BWP₃ is configured with a bandwidth of 20 MHz and a subcarrier spacing of 60 KHz. The wireless device may switch from a first BWP (e.g., BWP₁) to a second BWP (e.g., BWP₂). An active BWP of the cell may change from the first BWP to the second BWP in response to the BWP switching.

The BWP switching (e.g., BWP switching 1010, BWP switching 1012, BWP switching 1014, or BWP switching 1016 in FIG. 10) may be based on a command from the base station. The command may be a DCI comprising scheduling information for the UE in the second BWP. In case of uplink BWP switching, the first BWP and the second BWP may be uplink BWPs and the scheduling information may be an uplink grant for uplink transmission via the second BWP. In case of downlink BWP switching, the first BWP and the second BWP may be downlink BWPs and the scheduling information may be a downlink assignment for downlink reception via the second BWP.

The BWP switching (e.g., BWP switching 1010, BWP switching 1012, BWP switching 1014, or BWP switching 1016 in FIG. 10) may be based on an expiry of a timer. The base station may configure a wireless device with a BWP inactivity timer and the wireless device may switch to a default BWP (e.g., default downlink BWP) based on the expiry of the BWP inactivity timer. The expiry of the BWP inactivity timer may be an indication of low activity on the current active downlink BWP. The base station may configure the wireless device with the default downlink BWP. If the base station does not configure the wireless device with the default BWP, the default BWP may be an initial downlink BWP. The initial active BWP may be the BWP that the wireless device receives scheduling information for remaining system information upon transition to an RRC_CONNECTED state.

A wireless device may monitor a downlink control channel of a downlink BWP. For example, the UE may monitor a set of PDCCH candidates in configured monitoring occasions in one or more configured COntrol REsource SETs (CORESETs) according to the corresponding search space configurations. A search space configuration may define how/where to search for PDCCH candidates. For example, the search space configuration parameters may comprise a monitoring periodicity and offset parameter indicating the slots for monitoring the PDCCH candidates. The search space configuration parameters may further comprise a parameter indicating a first symbol with a slot within the slots determined for monitoring PDCCH candidates. A search space may be associated with one or more CORESETs and the search space configuration may indicate one or more identifiers of the one or more CORESETs. The search space configuration parameters may further indicate that whether the search space is a common search space or a UE-specific search space. A common search space may be monitored by a plurality of wireless devices and a UE-specific search space may be dedicated to a specific UE.

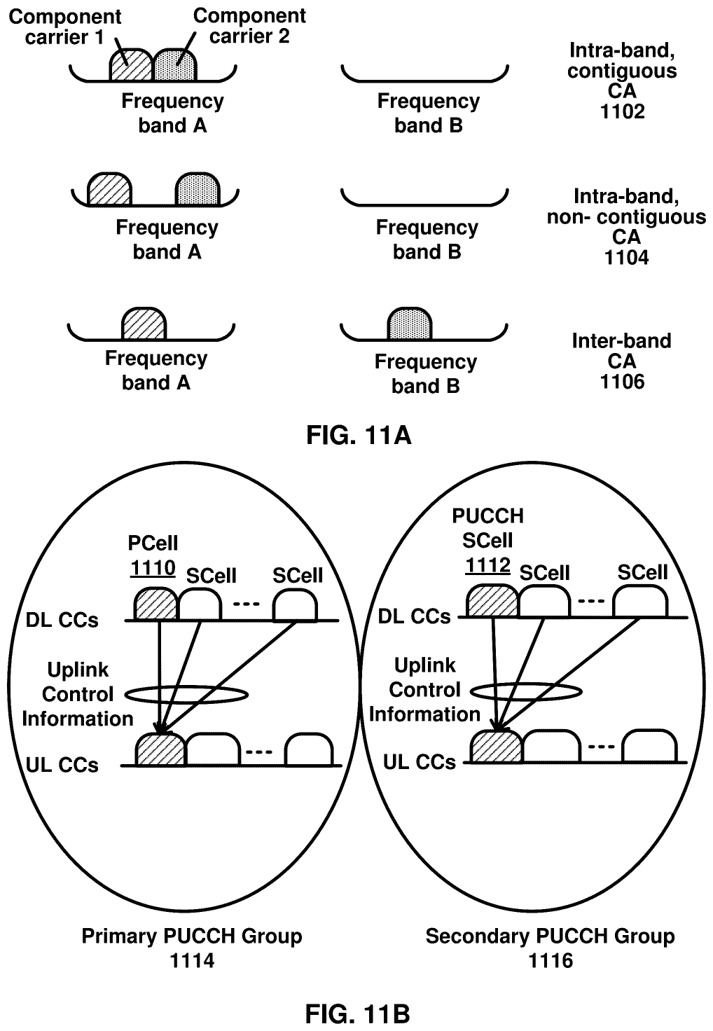

FIG. 11A shows example arrangements of carriers in carrier aggregation in accordance with several of various embodiments of the present disclosure. With carrier aggregation, multiple NR component carriers (CCs) may be aggregated. Downlink transmissions to a wireless device may take place simultaneously on the aggregated downlink CCs resulting in higher downlink data rates. Uplink transmissions from a wireless device may take place simultaneously on the aggregated uplink CCs resulting in higher uplink data rates. The component carriers in carrier aggregation may be on the same frequency band (e.g., intra-band carrier aggregation) or on different frequency bands (e.g., inter-band carrier aggregation). The component carriers may also be contiguous or non-contiguous. This results in three possible carrier aggregation scenarios, intra-band contiguous CA 1102, intra-band non-contiguous CA 1104 and inter-band CA 1106 as shown in FIG. 11A. Depending on the UE capability for carrier aggregation, a UE may transmit and/or receive on multiple carriers or for a UE that is not capable of carrier aggregation, the UE may transmit and/or receive on one component carrier at a time. In this disclosure, the carrier aggregation is described using the term cell and a carrier aggregation capable UE may transmit and/or receive via multiple cells.

In carrier aggregation, a UE may be configured with multiple cells. A cell of the multiple cells configured for the UE may be referred to as a Primary Cell (PCell). The PCell may be the first cell that the UE is initially connected to. One or more other cells configured for the UE may be referred to as Secondary Cells (SCells). The base station may configure a UE with multiple SCells. The configured SCells may be deactivated upon configuration and the base station may dynamically activate or deactivate one or more of the configured SCells based on traffic and/or channel conditions. The base station may activate or deactivate configured SCells using a SCell Activation/Deactivation MAC CE. The SCell Activation/Deactivation MAC CE may comprise a bitmap, wherein each bit in the bitmap may correspond to a SCell and the value of the bit indicates an activation status or deactivation status of the SCell.

An SCell may also be deactivated in response to expiry of a SCell deactivation timer of the SCell. The expiry of an SCell deactivation timer of an SCell may be an indication of low activity (e.g., low transmission or reception activity) on the SCell. The base station may configure the SCell with an SCell deactivation timer. The base station may not configure an SCell deactivation timer for an SCell that is configured with PUCCH (also referred to as a PUCCH SCell). The configuration of the SCell deactivation timer may be per configured SCell and different SCells may be configured with different SCell deactivation timer values. The SCell deactivation timer may be restarted based on one or more criteria including reception of downlink control information on the SCell indicating uplink grant or downlink assignment for the SCell or reception of downlink control information on a scheduling cell indicating uplink grant or downlink assignment for the SCell or transmission of a MAC PDU based on a configured uplink grant or reception of a configured downlink assignment.

A PCell for a UE may be an SCell for another UE and a SCell for a UE may be PCell for another UE. The configuration of PCell may be UE-specific. One or more SCells of the multiple SCells configured for a UE may be configured as downlink-only SCells, e.g., may only be used for downlink reception and may not be used for uplink transmission. In case of self-scheduling, the base station may transmit signaling for uplink grants and/or downlink assignments on the same cell that the corresponding uplink or downlink transmission takes place. In case of cross-carrier scheduling, the base station may transmit signaling for uplink grants and/or downlink assignments on a cell different from the cell that the corresponding uplink or downlink transmission takes place.

FIG. 11B shows examples of uplink control channel groups in accordance with several of various embodiments of the present disclosure. A base station may configure a UE with multiple PUCCH groups wherein a PUCCH group comprises one or more cells. For example, as shown in FIG. 11B, the base station may configure a UE with a primary PUCCH group 1114 and a secondary PUCCH group 1116. The primary PUCCH group may comprise the PCell 1110 and one or more first SCells. First UCI corresponding to the PCell and the one or more first SCells of the primary PUCCH group may be transmitted by the PUCCH of the PCell. The first UCI may be, for example, HARQ feedback for downlink transmissions via downlink CCs of the PCell and the one or more first SCells. The secondary PUCCH group may comprise a PUCCH SCell and one or more second SCells. Second UCI corresponding to the PUCCH SCell and the one or more second SCells of the secondary PUCCH group may be transmitted by the PUCCH of the PUCCH SCell. The second UCI may be, for example, HARQ feedback for downlink transmissions via downlink CCs of the PUCCH SCell and the one or more second SCells.

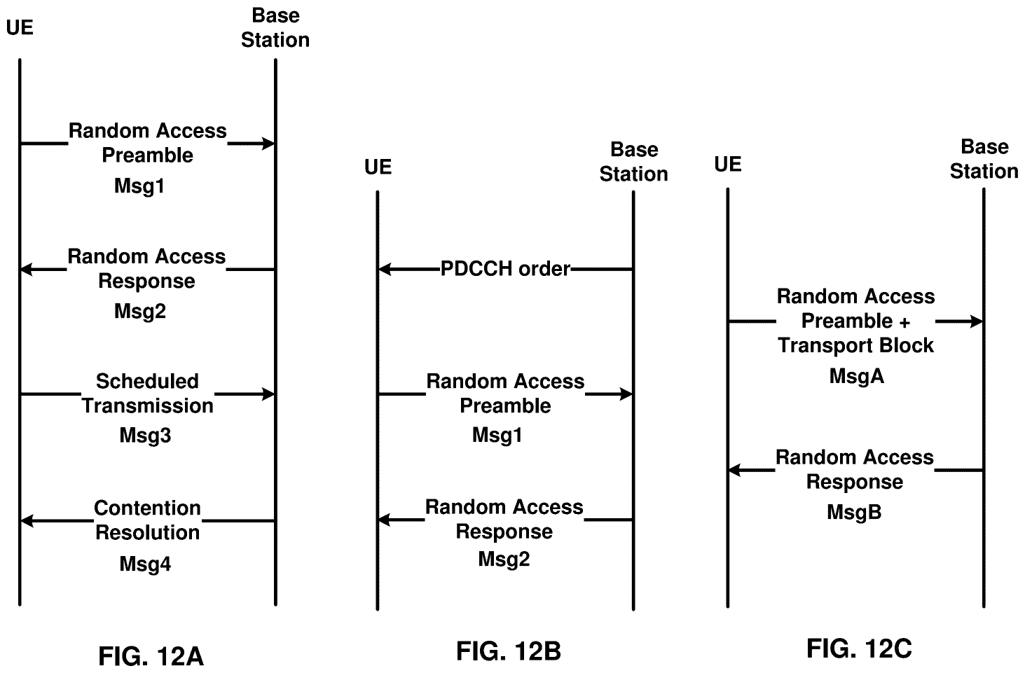

FIG. 12A, FIG. 12B and FIG. 12C show example random access processes in accordance with several of various embodiments of the present disclosure. FIG. 12A shows an example of four step contention-based random access (CBRA) procedure. The four-step CBRA procedure includes exchanging four messages between a UE and a base station. Msg1 may be for transmission (or retransmission) of a random access preamble by the wireless device to the base station. Msg2 may be the random access response (RAR) by the base station to the wireless device. Msg3 is the scheduled transmission based on an uplink grant indicated in Msg2 and Msg4 may be for contention resolution.

The base station may transmit one or more RRC messages comprising configuration parameters of the random access parameters. The random access parameters may indicate radio resources (e.g., time-frequency resources) for transmission of the random access preamble (e.g., Msg1), configuration index, one or more parameters for determining the power of the random access preamble (e.g., a power ramping parameter, a preamble received target power, etc.), a parameter indicating maximum number of preamble transmission, RAR window for monitoring RAR, cell-specific random access parameters and UE specific random access parameters. The UE-specific random access parameters may indicate one or more PRACH occasions for random access preamble (e.g., Msg1) transmissions. The random access parameters may indicate association between the PRACH occasions and one or more reference signals (e.g., SSB or CSI-RS). The random access parameters may further indicate association between the random access preambles and one or more reference signals (e.g., SBB or CSI-RS). The UE may use one or more reference signals (e.g., SSB(s) or CSI-RS(s)) and may determine a random access preamble to use for Msg1 transmission based on the association between the random access preambles and the one or more reference signals. The UE may use one or more reference signals (e.g., SSB(s) or CSI-RS(s)) and may determine the PRACH occasion to use for Msg1 transmission based on the association between the PRACH occasions and the reference signals. The UE may perform a retransmission of the random access preamble if no response is received with the RAR window following the transmission of the preamble. UE may use a higher transmission power for retransmission of the preamble. UE may determine the higher transmission power of the preamble based on the power ramping parameter.

Msg2 is for transmission of RAR by the base station. Msg2 may comprise a plurality of RARs corresponding to a plurality of random access preambles transmitted by a plurality of UEs. Msg2 may be associated with a random access temporary radio identifier (RA-RNTI) and may be received in a common search space of the UE. The RA-RNTI may be based on the PRACH occasion (e.g., time and frequency resources of a PRACH) in which a random access preamble is transmitted. RAR may comprise a timing advance command for uplink timing adjustment at the UE, an uplink grant for transmission of Msg3 and a temporary C-RNTI. In response to the successful reception of Msg2, the UE may transmit the Msg3. Msg3 and Msg4 may enable contention resolution in case of CBRA. In a CBRA, a plurality of UEs may transmit the same random access preamble and may consider the same RAR as being corresponding to them. UE may include a device identifier in Msg3 (e.g., a C-RNTI, temporary C-RNTI or other UE identity). Base station may transmit the Msg4 with a PDSCH and UE may assume that the contention resolution is successful in response to the PDSCH used for transmission of Msg4 being associated with the UE identifier included in Msg3.

FIG. 12B shows an example of a contention-free random access (CFRA) process. Msg 1 (random access preamble) and Msg 2 (random access response) in FIG. 12B for CFRA may be analogous to Msg 1 and Msg 2 in FIG. 12A for CBRA. In an example, the CFRA procedure may be initiated in response to a PDCCH order from a base station. The PDCCH order for initiating the CFRA procedure by the wireless device may be based on a DCI having a first format (e.g., format 1_0). The DCI for the PDCCH order may comprise a random access preamble index, an UL/SUL indicator indicating an uplink carrier of a cell (e.g., normal uplink carrier or supplementary uplink carrier) for transmission of the random access preamble, a SS/PBCH index indicating the SS/PBCH that may be used to determine a RACH occasion for PRACH transmission, a PRACH mask index indicating the RACH occasion associated with the SS/PBCH indicated by the SS/PBCH index for PRACH transmission, etc. In an example, the CFRA process may be started in response to a beam failure recovery process. The wireless device may start the CFRA for the beam failure recovery without a command (e.g., PDCCH order) from the base station and by using the wireless device dedicated resources.

FIG. 12C shows an example of a two-step random access process comprising two messages exchanged between a wireless device and a base station. Msg A may be transmitted by the wireless device to the base station and may comprise one or more transmissions of a preamble and/or one or more transmissions of a transport block. The transport block in Msg A and Msg 3 in FIG. 12A may have similar and/or equivalent contents. The transport block of Msg A may comprise data and control information (e.g., SR, HARQ feedback, etc.). In response to the transmission of Msg A, the wireless device may receive Msg B from the base station. Msg B in FIG. 12C and Msg 2 (e.g., RAR) illustrated in FIGS. 12A and 12B may have similar and/or equivalent content.

The base station may periodically transmit synchronization signals (SSs), e.g., primary SS (PSS) and secondary SS (SSS) along with PBCH on each NR cell. The PSS/SSS together with PBCH is jointly referred to as a SS/PBCH block. The SS/PBCH block enables a wireless device to find a cell when entering to the mobile communications network or find new cells when moving within the network. The SS/PBCH block spans four OFDM symbols in time domain. The PSS is transmitted in the first symbol and occupies 127 subcarriers in frequency domain. The SSS is transmitted in the third OFDM symbol and occupies the same 127 subcarriers as the PSS. There are eight and nine empty subcarriers on each side of the SSS. The PBCH is transmitted on the second OFDM symbol occupying 240 subcarriers, the third OFDM symbol occupying 48 subcarriers on each side of the SSS, and on the fourth OFDM symbol occupying 240 subcarriers. Some of the PBCH resources indicated above may be used for transmission of the demodulation reference signal (DMRS) for coherent demodulation of the PBCH. The SS/PBCH block is transmitted periodically with a period ranging from 5 ms to 160 ms. For initial cell search or for cell search during inactive/idle state, a wireless device may assume that that the SS/PBCH block is repeated at least every 20 ms.

In NR, transmissions using of antenna arrays, with many antenna elements, and beamforming plays an important role specially in higher frequency bands. Beamforming enables higher capacity by increasing the signal strength (e.g., by focusing the signal energy in a specific direction) and by lowering the amount interference received at the wireless devices. The beamforming techniques may generally be divided to analog beamforming and digital beamforming techniques. With digital beamforming, signal processing for beamforming is carried out in the digital domain before digital-to-analog conversion and detailed control of both amplitude and phase of different antenna elements may be possible. With analog beamforming, the signal processing for beamforming is carried out in the analog domain and after the digital to analog conversion. The beamformed transmissions may be in one direction at a time. For example, the wireless devices that are in different directions relative to the base station may receive their downlink transmissions at different times. For analog receiver-side beamforming, the receiver may focus its receiver beam in one direction at a time.

In NR, the base station may use beam sweeping for transmission of SS/PBCH blocks. The SS/PBCH blocks may be transmitted in different beams using time multiplexing. The set of SS/PBCH blocks that are transmitted in one beam sweep may be referred to as a SS/PBCH block set. The period of PBCH/SSB block transmission may be a time duration between a SS/PBCH block transmission in a beam and the next SS/PBCH block transmission in the same beam. The period of SS/PBCH block is, therefore, also the period of the SS/PBCH block set.

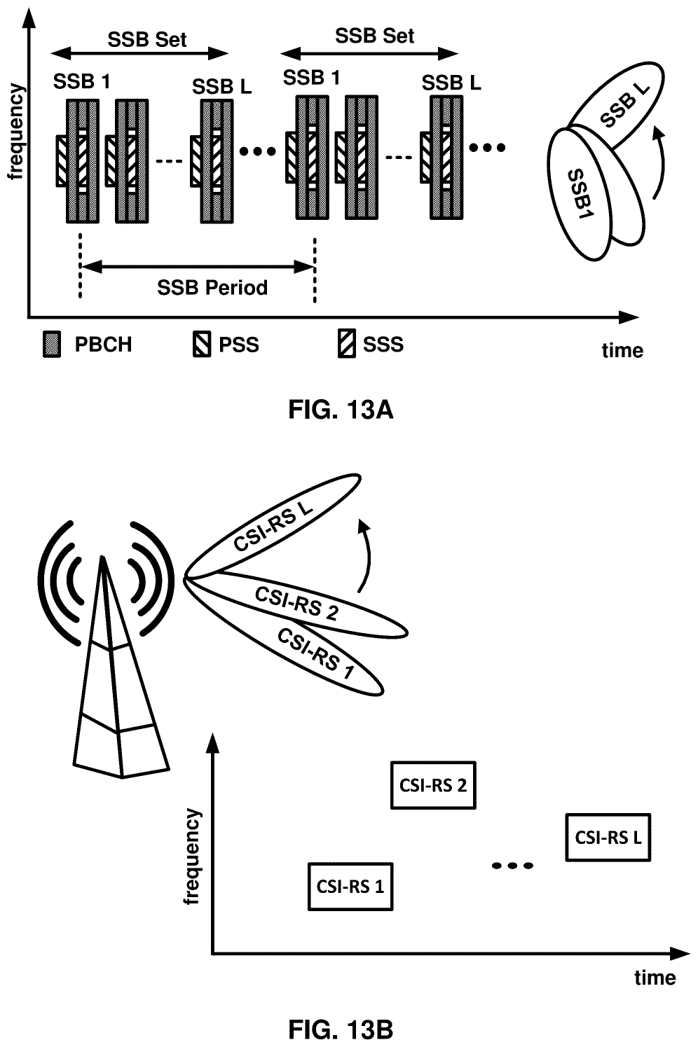

FIG. 13A shows example time and frequency structure of SS/PBCH blocks and their associations with beams in accordance with several of various embodiments of the present disclosure. In this example, a SS/PBCH block (also referred to as SSB) set comprise L SSBs wherein an SSB in the SSB set is associated with (e.g., transmitted in) one of L beams of a cell. The transmission of SBBs of an SSB set may be confined within a 5 ms interval, either in a first half-frame or a second half-frame of a 10 ms frame. The number of SSBs in an SSB set may depend on the frequency band of operation. For example, the number of SSBs in a SSB set may be up to four SSBs in frequency bands below 3 GHz enabling beam sweeping of up to four beams, up to eight SSBs in frequency bands between 3 GHz and 6 GHz enabling beam sweeping of up to eight beams, and up to sixty four SSBs in higher frequency bands enabling beam sweeping of up to sixty four beams. The SSs of an SSB may depend on a physical cell identity (PCI) of the cell and may be independent of which beam of the cell is used for transmission of the SSB. The PBCH of an SSB may indicate a time index parameter and the wireless device may determine the relative position of the SSB within the SSB set using the time index parameter. The wireless device may use the relative position of the SSB within an SSB set for determining the frame timing and/or determining RACH occasions for a random access process.

A wireless device entering the mobile communications network may first search for the PSS. After detecting the PSS, the wireless device may determine the synchronization up to the periodicity of the PSS. By detecting the PSS, the wireless device may determine the transmission timing of the SSS. The wireless device may determine the PCI of the cell after detecting the SSS. The PBCH of a SS/PBCH block is a downlink physical channel that carries the MIB. The MIB may be used by the wireless device to obtain remaining system information (RMSI) that is broadcast by the network. The RMSI may include System Information Block 1 (SIB1) that contains information required for the wireless device to access the cell.

As discussed earlier, the wireless device may determine a time index parameter from the SSB. The PBCH comprises a half-frame parameter indicating whether the SSB is in the first 5 ms half or the second 5 ms half of a 10 ms frame. The wireless device may determine the frame boundary using the time index parameter and the half-frame parameter. In addition, the PBCH may comprise a parameter indicating the system frame number (SFN) of the cell.

The base station may transmit CSI-RS and a UE may measure the CSI-RS to obtain channel state information (CSI). The base station may configure the CSI-RS in a UE-specific manner. In some scenarios, same set of CSI-RS resources may be configured for multiple UEs and one or more resource elements of a CSI-RS resource may be shared among multiple UEs. A CSI-RS resource may be configured such that it does not collide with a CORESET configured for the wireless device and/or with a DMRS of a PDSCH scheduled for the wireless device and/or transmitted SSBs. The UE may measure one or more CSI-RSs configured for the UE and may generate a CSI report based on the CSI-RS measurements and may transmit the CSI report to the base station for scheduling, link adaptation and/or other purposes.

NR supports flexible CSI-RS configurations. A CSI-RS resource may be configured with single or multiple antenna ports and with configurable density. Based on the number of configured antenna ports, a CSI-RS resource may span different number of OFDM symbols (e.g., 1, 2, and 4 symbols). The CSI-RS may be configured for a downlink BWP and may use the numerology of the downlink BWP. The CSI-RS may be configured to cover the full bandwidth of the downlink BWP or a portion of the downlink BWP. In some cases, the CSI-RS may be repeated in every resource block of the CSI-RS bandwidth, referred to as CSI-RS with density equal to one. In some cases, the CSI-RS may be configured to be repeated in every other resource block of the CSI-RS bandwidth. CSI-RS may be non-zero power (NZP) CSI-RS or zero-power (ZP) CSI-RS.

The base station may configure a wireless device with one or more sets of NZP CSI-RS resources. The base station may configure the wireless device with a NZP CSI-RS resource set using an RRC information element (IE) NZP-CSI-RS-ResourceSet indicating a NZP CSI-RS resource set identifier (ID) and parameters specific to the NZP CSI-RS resource set. An NZP CSI-RS resource set may comprise one or more CSI-RS resources. An NZP CSI-RS resource set may be configured as part of the CSI measurement configuration.

The CSI-RS may be configured for periodic, semi-persistent or aperiodic transmission. In case of the periodic and semi-persistent CSI-RS configurations, the wireless device may be configured with a CSI resource periodicity and offset parameter that indicate a periodicity and corresponding offset in terms of number of slots. The wireless device may determine the slots that the CSI-RSs are transmitted. For semi-persistent CSI-RS, the CSI-RS resources for CSI-RS transmissions may be activated and deactivated by using a semi-persistent (SP) CSI-CSI Resource Set Activation/Deactivation MAC CE. In response to receiving a MAC CE indicating activation of semi-persistent CSI-RS resources, the wireless device may assume that the CSI-RS transmissions will continue until the CSI-RS resources for CSI-RS transmissions are activated.

As discussed before, CSI-RS may be configured for a wireless device as NZP CSI-RS or ZP CSI-RS. The configuration of the ZP CSI-RS may be similar to the NZP CSI-RS with the difference that the wireless device may not carry out measurements for the ZP CSI-RS. By configuring ZP CSI-RS, the wireless device may assume that a scheduled PDSCH that includes resource elements from the ZP CSI-RS is rate matched around those ZP CSI-RS resources. For example, a ZP CSI-RS resource configured for a wireless device may be an NZP CSI-RS resource for another wireless device. For example, by configuring ZP CSI-RS resources for the wireless device, the base station may indicate to the wireless device that the PDSCH scheduled for the wireless device is rate matched around the ZP CSI-RS resources.

A base station may configure a wireless device with channel state information interference measurement (CSI-IM) resources. Similar to the CSI-RS configuration, configuration of locations and density of CSI-IM resources may be flexible. The CSI-IM resources may be periodic (configured with a periodicity), semi-persistent (configured with a periodicity and activated and deactivated by MAC CE) or aperiodic (triggered by a DCI).

Tracking reference signals (TRSs) may be configured for a wireless device as a set of sparse reference signals to assist the wireless in time and frequency tracking and compensating time and frequency variations in its local oscillator. The wireless device may further use the TRSs for estimating channel characteristics such as delay spread or doppler frequency. The base station may use a CSI-RS configuration for configuring TRS for the wireless device. The TRS may be configured as a resource set comprising multiple periodic NZP CSI-RS resources.

A base station may configure a UE and the UE may transmit sounding reference signals (SRSs) to enable uplink channel sounding/estimation at the base station. The SRS may support up to four antenna ports and may be designed with low cubic metric enabling efficient operation of the wireless device amplifier. The SRS may span one or more (e.g., one, two or four) consecutive OFDM symbols in time domain and may be located within the last n (e.g., six) symbols of a slot. In the frequency domain, the SRS may have a structure that is referred to as a comb structure and may be transmitted on every Nth subcarrier. Different SRS transmissions from different wireless devices may have different comb structures and may be multiplexed in frequency domain.

A base station may configure a wireless device with one or more SRS resource sets and an SRS resource set may comprise one or more SRS resources. The SRS resources in an SRS resources set may be configured for periodic, semi-persistent or aperiodic transmission. The periodic SRS and the semi-persistent SRS resources may be configured with periodicity and offset parameters. The Semi-persistent SRS resources of a configured semi-persistent SRS resource set may be activated or deactivated by a semi-persistent (SP) SRS Activation/Deactivation MAC CE. The set of SRS resources included in an aperiodic SRS resource set may be activated by a DCI. A value of a field (e.g., an SRS request field) in the DCI may indicate activation of resources in an aperiodic SRS resource set from a plurality of SRS resource sets configured for the wireless device.

An antenna port may be associated with one or more reference signals. The receiver may assume that the one or more reference signals, associated with the antenna port, may be used for estimating channel corresponding to the antenna port. The reference signals may be used to derive channel state information related to the antenna port. Two antenna ports may be referred to as quasi co-located if characteristics (e.g., large-scale properties) of the channel over which a symbol is conveyed on one antenna port may be inferred from the channel over which a symbol is conveyed from another antenna port. For example, a UE may assume that radio channels corresponding to two different antenna ports have the same large-scale properties if the antenna ports are specified as quasi co-located. In some cases, the UE may assume that two antenna ports are quasi co-located based on signaling received from the base station. Spatial quasi-colocation (QCL) between two signals may be, for example, due to the two signals being transmitted from the same location and in the same beam. If a receive beam is good for a signal in a group of signals that are spatially quasi co-located, it may be assumed also be good for the other signals in the group of signals.

The CSI-RS in the downlink and the SRS in uplink may serve as quasi-location (QCL) reference for other physical downlink channels and physical uplink channels, respectively. For example, a downlink physical channel (e.g., PDSCH or PDCCH) may be spatially quasi co-located with a downlink reference signal (e.g., CSI-RS or SSB). The wireless device may determine a receive beam based on measurement on the downlink reference signal and may assume that the determined received beam is also good for reception of the physical channels (e.g., PDSCH or PDCCH) that are spatially quasi co-located with the downlink reference signal. Similarly, an uplink physical channel (e.g., PUSCH or PUCCH) may be spatially quasi co-located with an uplink reference signal (e.g., SRS). The base station may determine a receive beam based on measurement on the uplink reference signal and may assume that the determined received beam is also good for reception of the physical channels (e.g., PUSCH or PUCCH) that are spatially quasi co-located with the uplink reference signal.

The Demodulation Reference Signals (DM-RSs) enables channel estimation for coherent demodulation of downlink physical channels (e.g., PDSCH, PDCCH and PBH) and uplink physical channels (e.g., PUSCH and PUCCH). The DM-RS may be located early in the transmission (e.g., front-loaded DM-RS) and may enable the receiver to obtain the channel estimate early and reduce the latency. The time-domain structure of the DM-RS (e.g., symbols wherein the DM-RS are located in a slot) may be based on different mapping types.

The Phase Tracking Reference Signals (PT-RSs) enables tracking and compensation of phase variations across the transmission duration. The phase variations may be, for example, due to oscillator phase noise. The oscillator phase noise may become more severe in higher frequencies (e.g., mmWave frequency bands). The base station may configure the PT-RS for uplink and/or downlink. The PT-RS configuration parameters may indicate frequency and time density of PT-RS, maximum number of ports (e.g., uplink ports), resource element offset, configuration of uplink PT-RS without transform precoder (e.g., CP-OFDM) or with transform precoder (e.g., DFT-s-OFDM), etc. The subcarrier number and/or resource blocks used for PT-RS transmission may be based on the C-RNTI of the wireless device to reduce risk of collisions between PT-RSs of wireless devices scheduled on overlapping frequency domain resources.

FIG. 13B shows example time and frequency structure of CSI-RSs and their association with beams in accordance with several of various embodiments of the present disclosure. A beam of the L beams shown in FIG. 13B may be associated with a corresponding CSI-RS resource. The base station may transmit the CSI-RSs using the configured CSI-RS resources and a UE may measure the CSI-RSs (e.g., received signal received power (RSRP) of the CSI-RSs) and report the CSI-RS measurements to the base station based on a reporting configuration. For example, the base station may determine one or more transmission configuration indication (TCI) states and may indicate the one or more TCI states to the UE (e.g., using RRC signaling, a MAC CE and/or a DCI). Based on the one or more TCI states indicated to the UE, the UE may determine a downlink receive beam and receive downlink transmissions using the receive beam. In case of a beam correspondence, the UE may determine a spatial domain filter of a transmit beam based on spatial domain filter of a corresponding receive beam. Otherwise, the UE may perform an uplink beam selection procedure to determine the spatial domain filter of the transmit beam. The UE may transmit one or more SRSs using the SRS resources configured for the UE and the base station may measure the SRSs and determine/select the transmit beam for the UE based the SRS measurements. The base station may indicate the selected beam to the UE. The CSI-RS resources shown in FIG. 13B may be for one UE. The base station may configure different CSI-RS resources associated with a given beam for different UEs by using frequency division multiplexing.

A base station and a wireless device may perform beam management procedures to establish beam pairs (e.g., transmit and receive beams) that jointly provide good connectivity. For example, in the downlink direction, the UE may perform measurements for a beam pair and estimate channel quality for a transmit beam by the base station (or a transmission reception point (TRP) more generally) and the receive beam by the UE. The UE may transmit a report indicating beam pair quality parameters. The report may comprise one or more parameters indicating one or more beams (e.g., a beam index, an identifier of reference signal associated with a beam, etc.), one or more measurement parameters (e.g., RSRP), a precoding matrix indicator (PMI), a channel quality indicator (CQI), and/or a rank indicator (RI).

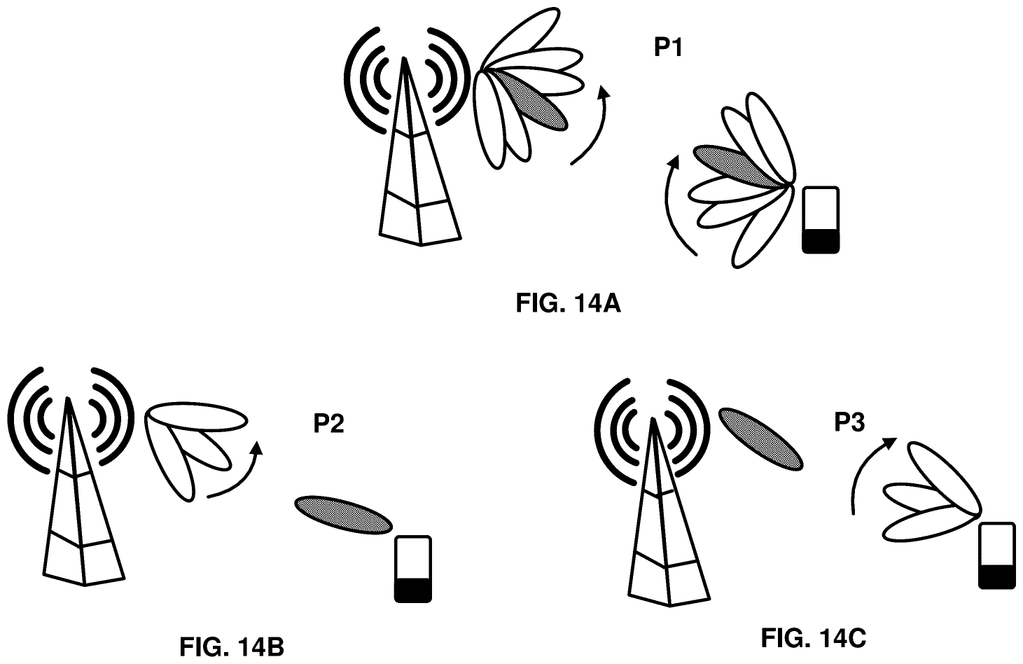

FIG. 14A, FIG. 14B and FIG. 14C show example beam management processes (referred to as P1, P2 and P3, respectively) in accordance with several of various embodiments of the present disclosure. The P1 process shown in FIG. 14A may enable, based on UE measurements, selection of a base station (or TRP more generally) transmit beam and/or a wireless device receive beam. The TRP may perform a beam sweeping procedure where the TRP may sequentially transmit reference signals (e.g., SSB and/or CSI-RS) on a set of beams and the UE may select a beam from the set of beams and may report the selected beam to the TRP. The P2 procedure as shown in FIG. 14B may be a beam refinement procedure. The selection of the TRP transmit beam and the UE receive beam may be regularly reevaluated due to movements and/or rotations of the UE or movement of other objects. In an example, the base station may perform the beam sweeping procedure over a smaller set of beams and the UE may select the best beam over the smaller set. In an example, the beam shape may be narrower compared to beam selected based on the P1 procedure. Using the P3 procedure as shown in FIG. 14C, the TRP may fix its transmit beam and the UE may refine its receive beam.

A wireless device may receive one or more messages from a base station. The one or more messages may comprise one or more RRC messages. The one or more messages may comprise configuration parameters of a plurality of cells for the wireless device. The plurality of cells may comprise a primary cell and one or more secondary cells. For example, the plurality of cells may be provided by a base station and the wireless device may communicate with the base station using the plurality of cells. For example, the plurality of cells may be provided by multiple base stations (e.g., in case of dual and/or multi-connectivity). The wireless device may communicate with a first base station, of the multiple base stations, using one or more first cells of the plurality of cells. The wireless device may communicate with a second base station of the multiple base stations using one or more second cells of the plurality of cells.

The one or more messages may comprise configuration parameters used for processes in physical, MAC, RLC, PCDP, SDAP, and/or RRC layers of the wireless device. For example, the configuration parameters may include values of timers used in physical, MAC, RLC, PCDP, SDAP, and/or RRC layers. For example, the configuration parameters may include parameters for configurating different channels (e.g., physical layer channel, logical channels, RLC channels, etc.) and/or signals (e.g., CSI-RS, SRS, etc.).

Upon starting a timer, the timer may start running until the timer is stopped or until the timer expires. A timer may be restarted if it is running. A timer may be started if it is not running (e.g., after the timer is stopped or after the timer expires). A timer may be configured with or may be associated with a value (e.g., an initial value). The timer may be started or restarted with the value of the timer. The value of the timer may indicate a time duration that the timer may be running upon being started or restarted and until the timer expires. The duration of a timer may not be updated until the timer is stopped or expires (e.g., due to BWP switching). This specification may disclose a process that includes one or more timers. The one or more timers may be implemented in multiple ways. For example, a timer may be used by the wireless device and/or base station to determine a time window [t1, t2], wherein the timer is started at time t1 and expires at time t2 and the wireless device and/or the base station may be interested in and/or monitor the time window [t1, t2], for example to receive a specific signaling. Other examples of implementation of a timer may be provided.

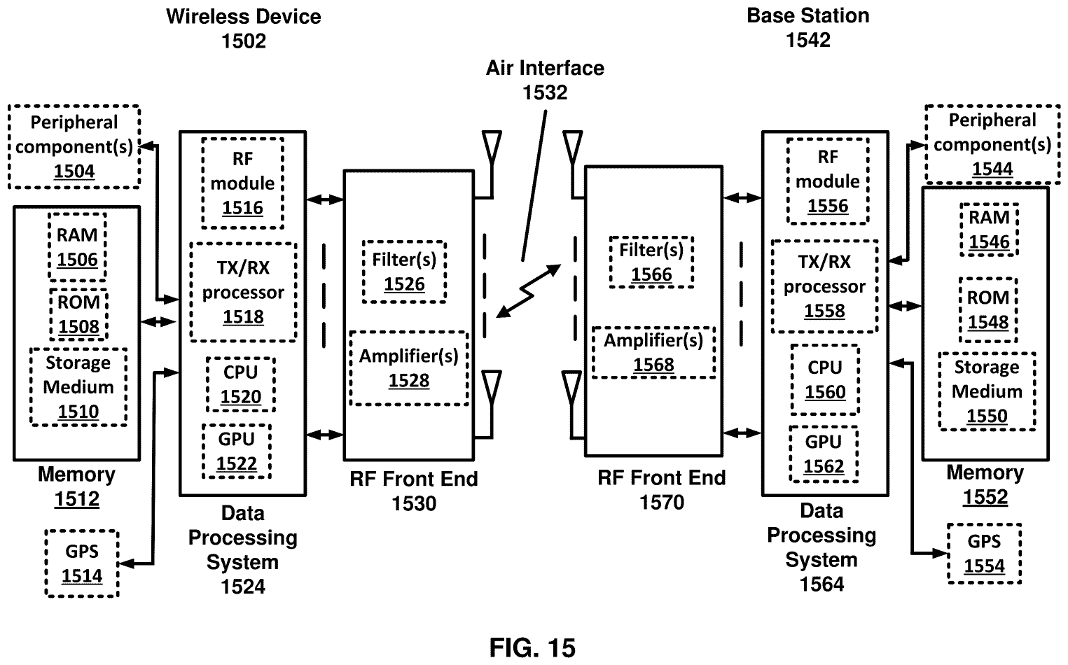

FIG. 15 shows example components of a wireless device and a base station that are in communication via an air interface in accordance with several of various embodiments of the present disclosure. The wireless device 1502 may communicate with the base station 1542 over the air interface 1532. The wireless device 1502 may include a plurality of antennas. The base station 1542 may include a plurality of antennas. The plurality of antennas at the wireless device 1502 and/or the base station 1542 enables different types of multiple antenna techniques such as beamforming, single-user and/or multi-user MIMO, etc.

The wireless device 1502 and the base station 1542 may have one or more of a plurality of modules/blocks, for example RF front end (e.g., RF front end 1530 at the wireless device 1502 and RF front end 1570 at the base station 1542), Data Processing System (e.g., Data Processing System 1524 at the wireless device 1502 and Data Processing System 1564 at the base station 1542), Memory (e.g., Memory 1512 at the wireless device 1502 and Memory 1542 at the base station 1542). Additionally, the wireless device 1502 and the base station 1542 may have other modules/blocks such as GPS (e.g., GPS 1514 at the wireless device 1502 and GPS 1554 at the base station 1542).

An RF front end module/block may include circuitry between antennas and a Data Processing System for proper conversion of signals between these two modules/blocks. An RF front end may include one or more filters (e.g., Filter(s) 1526 at RF front end 1530 or Filter(s) 1566 at the RF front end 1570), one or more amplifiers (e.g., Amplifier(s) 1528 at the RF front end 1530 and Amplifier(s) 1568 at the RF front end 1570). The Amplifier(s) may comprise power amplifier(s) for transmission and low-noise amplifier(s) (LNA(s)) for reception.

The Data Processing System 1524 and the Data Processing System 1564 may process the data to be transmitted or the received signals by implementing functions at different layers of the protocol stack such as PHY, MAC, RLC, etc. Example PHY layer functions that may be implemented by the Data Processing System 1524 and/or 1564 may include forward error correction, interleaving, rate matching, modulation, precoding, resource mapping, MIMO processing, etc. Similarly, one or more functions of the MAC layer, RLC layer and/or other layers may be implemented by the Data Processing System 1524 and/or the Data Processing System 1564. One or more processes described in the present disclosure may be implemented by the Data Processing System 1524 and/or the Data Processing System 1564. A Data Processing System may include an RF module (RF module 1516 at the Data Processing System 1524 and RF module 1556 at the Data Processing System 1564) and/or a TX/RX processor (e.g., TX/RX processor 1518 at the Data Processing System 1524 and TX/RX processor 1558 at the Data Processing System 1566) and/or a central processing unit (CPU) (e.g., CPU 1520 at the Data Processing System 1524 and CPU 1560 at the Data Processing System 1564) and/or a graphical processing unit (GPU) (e.g., GPU 1522 at the Data Processing System 1524 and GPU 1562 at the Data Processing System 1564).

The Memory 1512 may have interfaces with the Data Processing System 1524 and the Memory 1552 may have interfaces with Data Processing System 1564, respectively. The Memory 1512 or the Memory 1552 may include non-transitory computer readable mediums (e.g., Storage Medium 1510 at the Memory 1512 and Storage Medium 1550 at the Memory 1552) that may store software code or instructions that may be executed by the Data Processing System 1524 and Data Processing System 1564, respectively, to implement the processes described in the present disclosure. The Memory 1512 or the Memory 1552 may include random-access memory (RAM) (e.g., RAM 1506 at the Memory 1512 or RAM 1546 at the Memory 1552) or read-only memory (ROM) (e.g., ROM 1508 at the Memory 1512 or ROM 1548 at the Memory 1552) to store data and/or software codes.

The Data Processing System 1524 and/or the Data Processing System 1564 may be connected to other components such as a GPS module 1514 and a GPS module 1554, respectively, wherein the GPS module 1514 and a GPS module 1554 may enable delivery of location information of the wireless device 1502 to the Data Processing System 1524 and location information of the base station 1542 to the Data Processing System 1564. One or more other peripheral components (e.g., Peripheral Component(s) 1504 or Peripheral Component(s) 1544) may be configured and connected to the data Processing System 1524 and data Processing System 1564, respectively.

In example embodiments, a wireless device may be configured with parameters and/or configuration arrangements. For example, the configuration of the wireless device with parameters and/or configuration arrangements may be based on one or more control messages that may be used to configure the wireless device to implement processes and/or actions. The wireless device may be configured with the parameters and/or the configuration arrangements regardless of the wireless device being in operation or not in operation. For example, software, firmware, memory, hardware and/or a combination thereof and/or alike may be configured in a wireless device regardless of the wireless device being in operation or not operation. The configured parameters and/or settings may influence the actions and/or processes performed by the wireless device when in operation.

In example embodiments, a wireless device may receive one or more messages comprising configuration parameters. For example, the one or more messages may comprise radio resource control (RRC) messages. A parameter of the configuration parameters may be in at least one of the one or more messages. The one or more messages may comprise information element (IEs). An information element may be a structural element that includes single or multiple fields. The fields in an IE may be individual contents of the IE. The terms configuration parameter, IE and field may be used equally in this disclosure. The IEs may be implemented using a nested structure, wherein an IE may include one or more other IEs and an IE of the one or more other IEs may include one or more additional IEs. With this structure, a parent IE contains all the offspring IEs as well. For example, a first IE containing a second IE, the second IE containing a third IE, and the third IE containing a fourth IE may imply that the first IE contains the third IE and the fourth IE.

In an example, Semi-Persistent Scheduling (SPS) may be configured by RRC for a Serving Cell per BWP. Multiple assignments may be active simultaneously in the same BWP. Activation and deactivation of the DL SPS may be independent among the Serving Cells.

In an example, for the DL SPS, a DL assignment may be provided by PDCCH, and stored or cleared based on L1 signaling indicating SPS activation or deactivation.

In an example, RRC may configure the following parameters when the SPS is configured: cs-RNTI: CS-RNTI for activation, deactivation, and retransmission; nrofHARQ-Processes: the number of configured HARQ processes for SPS; harq-ProcID-Offset: Offset of HARQ process for SPS; periodicity: periodicity of configured downlink assignment for SPS.

In an example, when the SPS is released by upper layers, the corresponding configurations may be released.

In an example, after a downlink assignment is configured for SPS, the MAC entity may consider sequentially that the Nth downlink assignment occurs in the slot for which:

(numberOfSlotsPerFrame×SFN+slot number in the frame)=[(numberOfSlotsPerFrame×SFNstart time+slotstart time)+N×periodicity×numberOfSlotsPerFrame/10]modulo(1024×numberOfSlotsPerFrame)

where SFNstart time and slotstart time are the SFN and slot, respectively, of the first transmission of PDSCH where the configured downlink assignment was (re-)initialized.

In an example, there may be two types of transmission without dynamic grant: configured grant Type 1 where an uplink grant is provided by RRC, and stored as configured uplink grant; configured grant Type 2 where an uplink grant is provided by PDCCH, and stored or cleared as configured uplink grant based on L1 signalling indicating configured uplink grant activation or deactivation.

In an example, Type 1 and Type 2 may be configured by RRC for a Serving Cell per BWP. Multiple configurations may be active simultaneously in the same BWP. For Type 2, activation and deactivation may be independent among the Serving Cells. For the same BWP, the MAC entity may be configured with both Type 1 and Type 2.

In an example, RRC may configure the following parameters when the configured grant Type 1 is configured: cs-RNTI: CS-RNTI for retransmission; cg-SDT-CS-RNTI: CS-RNTI for CG-SDT retransmission; cg-SDT-RSRP-ThresholdSSB: an RSRP threshold configured for SSB selection for CG-SDT (e.g., configured grant based small data transmission); periodicity: periodicity of the configured grant Type 1; timeDomainOffset: Offset of a resource with respect to SFN=timeReferenceSFN in time domain; timeDomainAllocation: Allocation of configured uplink grant in time domain which contains startSymbolAndLength or startSymbol; nrofHARQ-Processes: the number of HARQ processes for configured grant; harq-ProcID-Offset: offset of HARQ process for configured grant configured with cg-RetransmissionTimer for operation with shared spectrum channel access; harq-ProcID-Offset2: offset of HARQ process for configured grant not configured with cg-RetransmissionTimer; timeReferenceSFN: SFN used for determination of the offset of a resource in time domain. The UE may use the closest SFN with the indicated number preceding the reception of the configured grant configuration.

In an example, RRC may configure the following parameters when the configured grant Type 2 is configured: cs-RNTI: CS-RNTI for activation, deactivation, and retransmission; periodicity: periodicity of the configured grant Type 2; nrofHARQ-Processes: the number of HARQ processes for configured grant; harq-ProcID-Offset: offset of HARQ process for configured grant configured with cg-RetransmissionTimer for operation with shared spectrum channel access; harq-ProcID-Offset2: offset of HARQ process for configured grant not configured with cg-RetransmissionTimer.

In an example, RRC may configure the following parameter when retransmissions on configured uplink grant is configured: cg-RetransmissionTimer: the duration after a configured grant (re)transmission of a HARQ process when the UE may not autonomously retransmit that HARQ process; cg-SDT-RetransmissionTimer: the duration after a configured grant (re)trasnmission of a HARQ process of the initial CG-SDT transmission with CCCH message when the UE may not autonomously retransmit the HARQ process.

In an example, upon configuration of a configured grant Type 1 for a BWP of a Serving Cell by upper layers, the MAC entity may: store the uplink grant provided by upper layers as a configured uplink grant for the indicated BWP of the Serving Cell; initialize or re-initialize the configured uplink grant to start in the symbol according to timeDomainOffset, timeReferenceSFN, and S (derived from SLIV or provided by startSymbol), and to reoccur with periodicity.

In an exmaple, after an uplink grant is configured for a configured grant Type 1, the MAC entity may consider sequentially that the Nth (N >=0) uplink grant occurs in the symbol for which:

[(SFN×numberOfSlotsPerFrame×numberOfSymbolsPerSlot)+(slot number in the frame×numberOfSymbolsPerSlot)+symbol number in the slot]=(timeReferenceSFN×numberOfSlotsPerFrame×numberOfSymbolsPerSlot+timeDomainOffset×numberOfSymbolsPerSlot+S+N×periodicity)modulo(1024×numberOfSlotsPerFrame×numberOfSymbolsPerSlot)

In an example, an uplink grant may be configured for configured grant Type 1 for CG-SDT (e.g., configured grant based small data transmission, e.g., in RRC inactive state) on the selected uplink carrier. CG-SDT may be triggered and not terminated. A configured uplink grant may be valid and the above formula may be satisfied.

In an example, after initial transmission for CG-SDT with CCCH message may have been performed and PDCCH addressed to the MAC entity's C-RNTI has not been received. The SSB corresponding to the configured UL grant may have the same SSB index as the SSB selected for initial transmission for CG-SDT with CCCH message (e.g., retransmission of initial transmission of CG-SDT). The MAC entity may: select this SSB; indicate the SSB index corresponding to the configured uplink grant to the lower layer; consider this configured uplink grant as valid.

In an example, at least one SSB configured for CG-SDT with SS-RSRP above cg-SDT-RSRP-ThresholdSSB may be available. At least one SSB corresponding to the configured uplink grant with SS-RSRP above the cg-SDT-RSRP-ThresholdSSB may be available. This may be the initial transmission of CG-SDT with CCCH message after the CG-SDT procedure is initiated (e.g., initial transmission for CG-SDT). The MAC entity may select an SSB with SS-RSRP above cg-SDT-RSRP-ThresholdSSB amongst the SSB(s) associated with the configured uplink grant.

In an example, at least one SSB configured for CG-SDT with SS-RSRP above cg-SDT-RSRP-ThresholdSSB may be available. At least one SSB corresponding to the configured uplink grant with SS-RSRP above the cg-SDT-RSRP-ThresholdSSB may be available. PDCCH addressed to C-RNTI may have been received after the initial transmission of CG-SDT with CCCH message (e.g., subsequent new transmission for CG-SDT). If SS-RSRP of the SSB selected for the previous transmission for CG-SDT is above cg-SDT-RSRP-ThresholdSSB and this SSB is associated with this configured uplink grant, the MAC entity may select this SSB. If SS-RSRP of the SSB selected for the previous transmission for CG-SDT is not above cg-SDT-RSRP-ThresholdSSB, the MAC entity may select an SSB with SS-RSRP above cg-SDT-RSRP-ThresholdSSB amongst the SSB(s) associated with the configured uplink grant.

In an example, if SSB is selected, the MAC entity may indicate the SSB index to the lower layer; and may consider this configured uplink grant as valid.

In an example, at least one SSB configured for CG-SDT with SS-RSRP above cg-SDT-RSRP-ThresholdSSB may not be available. The MAC entity may consider this configured uplink grant as not valid. PDCCH addressed to C-RNTI after the initial transmission of the CG-SDT with CCCH message may have been received. If there is data available for transmission for at least one RB configured for SDT: the MAC entity may initiate Random Access procedure.

In an example, after an uplink grant is configured for a configured grant Type 2, the MAC entity may consider sequentially that the Nth (N >=0) uplink grant occurs in the symbol for which:

[(SFN×numberOfSlotsPerFrame×numberOfSymbolsPerSlot)+(slot number in the frame×numberOfSymbolsPerSlot)+symbol number in the slot]=[(SFNstart time×numberOfSlotsPerFrame×numberOfSymbolsPerSlot+slotstart time×numberOfSymbolsPerSlot+symbolstart time)+N×periodicity]modulo(1024×numberOfSlotsPerFrame×numberOfSymbolsPerSlot)

where SFNstart time, slotstart time, and symbolstart time may be the SFN, slot, and symbol, respectively, of the first transmission opportunity of PUSCH where the configured uplink grant was (re-)initialized.

In an example, if cg-nrofPUSCH-InSlot or cg-nrofSlots is configured for a configured grant Type 1 or Type 2, the MAC entity may consider the uplink grants occur in those additional PUSCH allocations.

In an example, when the configured uplink grant is released by upper layers, the corresponding configurations may be released and corresponding uplink grants may be cleared.

In an example, at least one configured uplink grant confirmation may have been triggered and not cancelled. The MAC entity may have UL resources allocated for new transmission. If, in this MAC entity, at least one configured uplink grant is configured by configuredGrantConfigToAddModList, the MAC entity may instruct the Multiplexing and Assembly procedure to generate a Multiple Entry Configured Grant Confirmation MAC CE. Otherwise, the MAC entity may instruct the Multiplexing and Assembly procedure to generate a Configured Grant Confirmation MAC CE.

In an example, for a configured grant Type 2, the MAC entity may clear the configured uplink grant(s) immediately after first transmission of Configured Grant Confirmation MAC CE or Multiple Entry Configured Grant Confirmation MAC CE which confirms the configured uplink grant deactivation.

In an example, retransmissions use: repetition of configured uplink grants; or received uplink grants addressed to CS-RNTI; or configured uplink grants with cg-RetransmissionTimer or cg-SDT-RetransmissionTimer configured.

In an exmaple, a Power Headroom reporting procedure may be used to provide the serving gNB with the following information: Type 1 power headroom: the difference between the nominal UE maximum transmit power and the estimated power for UL-SCH transmission per activated Serving Cell; Type 2 power headroom: the difference between the nominal UE maximum transmit power and the estimated power for UL-SCH and PUCCH transmission on SpCell of the other MAC entity (e.g., E-UTRA MAC entity in EN-DC, NE-DC, and NGEN-DC cases); Type 3 power headroom: the difference between the nominal UE maximum transmit power and the estimated power for SRS transmission per activated Serving Cell; MPE P-MPR: the power backoff to meet the MPE FR2 requirements for a Serving Cell operating on FR2.

In an example, RRC may control Power Headroom reporting by configuring the following parameters: phr-PeriodicTimer; phr-ProhibitTimer; phr-Tx-PowerFactorChange; phr-Type2OtherCell; phr-ModeOtherCG; multiplePHR; mpe-Reporting-FR2; mpe-ProhibitTimer; mpe-Threshold; numberOfN; mpe-ResourcePoolToAddModList; twoPHRMode.

In an example, a Power Headroom Report (PHR) may be triggered if one or more of the following events occur. Example embodiments may enhance the PHR triggering (e.g., introduce additional PHR triggering conditions) and/or the PHR reporting procedure. In an example, the PHR may be triggered if phr-ProhibitTimer expires or has expired and the path loss has changed more than phr-Tx-PowerFactorChange dB for at least one RS used as pathloss reference for one activated Serving Cell of any MAC entity of which the active DL BWP is not dormant BWP since the last transmission of a PHR in this MAC entity when the MAC entity has UL resources for new transmission. In an example, the PHR may be triggered if phr-PeriodicTimer expires. In an example, the PHR may be triggered upon configuration or reconfiguration of the power headroom reporting functionality by upper layers, which is not used to disable the function. In an example, the PHR may be triggered upon activation of an SCell of any MAC entity with configured uplink of which firstActiveDownlinkBWP-Id is not set to dormant BWP. In an example, the PHR may be triggered upon activation of an SCG. In an example, the PHR may be triggered upon addition of the PSCell except if the SCG is deactivated (e.g., PSCell is newly added or changed). In an example, the PHR may be triggered upon expiry of phr-ProhibitTimer, when the MAC entity has UL resources for new transmission, and the following is true for any of the activated Serving Cells of any MAC entity with configured uplink: there are UL resources allocated for transmission or there is a PUCCH transmission on this cell, and the required power backoff due to power management for this cell has changed more than phr-Tx-PowerFactorChange dB since the last transmission of a PHR when the MAC entity had UL resources allocated for transmission or PUCCH transmission on this cell. In an example, the PHR may be triggered upon switching of activated BWP from dormant BWP to non-dormant DL BWP of an SCell of any MAC entity with configured uplink.

In example embodiments, various techniques in time, frequency, spatial and power domains may be used for network energy saving.

An example time domain technique for network energy saving may be based on adapting transmission/reception of common channels/signals. In this technique, the transmission pattern (when applicable) of downlink common and broadcast signals, such as SSB/system information (SI)/paging/cell common PDCCH, and/or the transmission pattern/availability of uplink random access opportunities may be adapted. Adaptation of the transmission pattern may include changes to periodicity, time resource locations, and omitting of specific signals/channels. The transmission pattern may be adapted semi-statically or dynamically.

In an example, a simplified version of SSB, such as only PSS, only PSS and SSS without PBCH, or PSS and SSS with partial PBCH may be used for network energy saving. In an example, a signaling mechanism may be used to inform the UE about the use of simplified version of SSB. In an example, due to changes to SSB, SI acquisition, initial access, RRM/RLM measurements, and mobility for legacy UEs and UEs that may not support the technique, may be enhanced. In an example, this technique be enabled for a carrier only when legacy UEs are not using the carrier.

In an example, a SSB and/or SIB1 transmission occasion may be skipped for network energy saving. In an example, a signaling mechanism may be used to inform the UE about the skipping of SSB/SIB transmission occasions. In an example, skipping of common signals and channels, such as SSB and SIB1, may have impact on initial access, RRM/RLM/BM measurements, and performance for legacy UEs and UEs that may not support the technique. In an example, this technique may be enabled for a carrier only when legacy UEs are not using the carrier.

In an example, configuration/adaptation of longer periodicity of SSB/SIB1 and/or uplink random access opportunities may be used for network energy saving. In an example, a signaling mechanism may be used to inform the UE about the configuration/adaptation. In an example, adaption of common signals and channels may have impact on SI acquisition, initial access, RRM/RLM/BM measurements, and performance for legacy UEs and UEs that may not support the technique.

In an example, paging resources may be grouped in a compact manner for network energy saving.

In an example, dynamic adaptation of PRACH periodicity and occasions may be used for network energy saving. In an example, a signaling mechanism may be used to inform the UE about the RACH enhancement resources.

In an example, scheduling of SIB1 may be without PDCCH for network energy saving. A signaling mechanism may be used to inform the UE about the use of SIB1 without PDCCH.

An example time domain technique for network energy saving may be based on adaptation of UE specific signals and channels. The semi-static configured UE specific channels/signals may require the gNB to perform periodic transmission or reception if they are activated. The configurations for the UE-specific signals/channels may be BWP-specific. This technique may enable reducing or omitting time occasions for the UE specific resources during low activity/non-active periods of the cell. The potential UE specific resources include periodic/semi-static CSI-RS, group-common/UE-specific PDCCH, SPS PDSCH, PUCCH carrying SR, PUCCH/PUSCH carrying CSI reports, PUCCH carrying HARQ-ACK for SPS, CG-PUSCH, SRS, positioning RS (PRS).

In an example, UEs may assist the network with information related to the traffic (e.g., about which resources are necessary or unnecessary) so that the network can optimize its scheduling and achieve more sleep opportunities.

An example of time domain technique for network energy saving may be based on a UE wake up signal (WUS) for gNB. This technique may enable the UE to send an uplink wake-up signal to request transitioning of a cell from no or reduced transmission/reception activity to active transmission or reception of a channel/signal. The technique may be applied to UEs in one or more RRC states. In an example, the UE wake up signal (WUS) may be used to trigger the SSB/SIB transmission.

In an example, with the support of WUS, the gNB might be inactive (e.g., where it does not transmit nor receive signal/channel or where it only transmits and receives limited signals). A gNB may transit to become active for transmitting or receiving a channel/signal upon reception of an uplink signal from the UE.

An example time domain technique for network energy saving may be based on adaptation of discontinuous transmission (DTX)/discontinuous reception (DRX) state of a cell. In an example, a mechanism may be used for informing UE whether the cell stays inactive. This may include enhancements to UE DRX configuration, e.g., to align/omit DRX cycles or start offsets of DRX, for UEs in connected mode or idle/inactive mode, potentially allowing longer opportunities for cell inactivity. During a cell DTX/DRX, the cell may have no transmission/reception or only keep limited transmission/reception. For example, the cell may not need to transmit or receive some periodic signals/channels, such as common channels/signals or UE specific signals/channels.

In an example, cell DTX/DRX may be applied to at least UEs in RRC_CONNECTED state. A periodic Cell DTX/DRX (e.g., active and non-active periods) may be configured by gNB via UE-specific RRC signaling per serving cell.

In an example, gNB may be expected to turn off transmission and reception for data traffic and reference signal during Cell DTX/DRX non-active periods.

In an example, gNB may be expected to turn off its transmission/reception only for data traffic during Cell DTX/DRX non-active periods (e.g., gNB may still transmit/receive reference signals).

In an example, gNB may be expected to turn off its dynamic data transmission/reception during Cell DTX/DRX non-active periods (e.g., gNB may be expected to still perform transmission/reception in periodic resources, including SPS, CG-PUSCH, SR, RACH, and SRS).

In an example, gNB may be expected to only transmit reference signals (e.g., CSI-RS for measurement) during Cell DTX/DRX non-active periods.

In an example, the Cell DTX/DRX mode may be activated/de-activated via dynamic L1/L2 signaling and UE-specific RRC signaling. Both UE specific and common L1/L2 signaling may be considered for activating/deactivating the Cell DTX/DRX mode.

In an example, Cell DTX and Cell DRX modes may be configured and operated separately (e.g., one RRC configuration set for DL and another for UL). Cell DTX/DRX may also be configured and operated together. At least the following parameters may be configured per Cell DTX/DRX configuration: periodicity, start slot/offset, on duration. In an example multiple Cell DTX/DRX configurations may be configured for a wireless device and/or for a cell configured for a wireless device.

In an example, UE DRX may be aligned with Cell DTX. In an example, DRX may be aligned among multiple UEs.

In an example, the cell DTX/DRX information may be considered necessary to be exchanged and coordinated between neighbor gNBs. The gNB may use the received cell DTX/DTX information to determine its own cell DTX/DRX configuration for network energy saving purposes.

An example time domain technique for network energy saving may be based on adaptation of SSB/SIB1 including on-demand SSB/SIB1.

In an example, SSB/SIB1-less operation may be used, where UE may retrieve system information from and may perform synchronization based on another intra-band cell that transmits SSB and SIB1.

In an example, a UE may obtain system information from other associated carriers/cells and may synchronize from other associated carriers/cells and/or synchronize from signal(s) transmitted on the cell.

In an example, an SCell without SSB in intra-band CA may be considered as baseline, i.e., for a serving cell without transmission of SS/PBCH blocks, a UE may acquire time and frequency synchronization with the serving cell based on receptions of SS/PBCH blocks on the SpCell or the SCell, of the cell group.

In an example a network energy saving (NES) cell may be used without SIB/SSB.

The concept of non-anchor NES cell without SIB may be applicable in multi-carrier scenario, where the UE is in coverage of an anchor cell and one or multiple non-anchor NES cell(s). The anchor cell may be a cell where a UE is capable of receiving SSB, system information and paging. A non-anchor NES cell without SIB is a cell where the UE cannot receive SIB. A non-anchor NES cell without SSB and SIB may be a cell where a UE can receive neither SSB nor SIB.

In an example, the access may occur only via anchor cell or also directly in the non-anchor NES cell. If access directly to a non-anchor NES cell is supported, the SIB transmitted by anchor cell may also include the necessary information to access the non-anchor NES cell.

In an example, synchronization and QCL relationship of the non-anchor NES cell without SSB and SIB may be determined via another cell.

In an example, UE may camp on an anchor cell, not on a non-anchor NES cell without SIB (or without SSB and SIB).

In an example, periodic DTX may be used. The gNB may provide indication, via dedicated dynamic L1/L2 signaling, to UE about Network DTX mode/configuration.

In an example, UE DRX may be aligned with network/cell DTX. In an example, DRX may be aligned among multiple UEs.

In an example, periodic cell DTX/DRX pattern may be configured by UE-specific RRC. Periodic cell DTX/DRX may be activated/deactivated by L1/L2 signaling and UE-specific RRC signaling. In an example, both UE specific and common L1/L2 signaling may be considered for at least activating/deactivating the cell DTX/DRX pattern.

In an example, cell DTX and cell DRX modes may be configured and operated separately (e.g., one RRC configuration set for DL and the other set for UL). In an example, cell DTX/DRX may be configured and operated together.

In an example, it may be up to NW whether legacy UEs can access cells with Cell DTX/DRX.

In an example, cell DTX/DRX may be configured per serving cell and may be applicable for different cells in carrier aggregation (CA).

In an example, multiple Cell DTX/DRX configurations may be configured (e.g., for a cell).

In an example, at least the following parameters may be configured per cell DTX/DRX configuration: periodicity, start slot/offset, on duration.

In an example, a UE may have capability to follow the frame timing change of the reference cell in connected state. The uplink frame transmission takes place (N_{TA}+N_{TA offset})×T_{c} before the reception of the first detected path (in time) of the corresponding downlink frame from the reference cell. For serving cell(s) in PTAG, UE may use the SpCell as the reference cell for deriving the UE transmit timing for cells in the pTAG. For serving cell(s) in sTAG, UE may use any of the activated SCells as the reference cell for deriving the UE transmit timing for the cells in the sTAG.

In an example, the Scheduling Request (SR) may be used for requesting UL-SCH resources for new transmission.

In an example, the MAC entity may be configured with zero, one, or more SR configurations. An SR configuration may comprise of a set of PUCCH resources for SR across different BWPs and cells. For a logical channel or for SCell beam failure recovery and for consistent LBT failure recovery, at most one PUCCH resource for SR may be configured per BWP. For a logical channel serving a radio bearer configured with SDT, PUCCH resource for SR may not be configured for SDT. For beam failure recovery of BFD-RS set(s) of Serving Cell, up to two PUCCH resources for SR may be configured per BWP. For positioning measurement gap activation/deactivation request, a dedicated SR configuration may be configured.

In an example, a SR configuration may correspond to one or more logical channels and/or to SCell beam failure recovery and/or to consistent LBT failure recovery and/or to beam failure recovery of a BFD-RS set and/or to positioning measurement gap activation/deactivation request. A logical channel, SCell beam failure recovery, beam failure recovery of a BFD-RS set and consistent LBT failure recovery, may be mapped to zero or one SR configuration, which may be configured by RRC. The SR configuration of the logical channel that triggered a BSR or the SCell beam failure recovery or the beam failure recovery of a BFD-RS set or the consistent LBT failure recovery (if such a configuration exists) or positioning measurement gap activation/deactivation request may be considered as corresponding SR configuration for the triggered SR. Any SR configuration may be used for an SR triggered by Pre-emptive BSR or Timing Advance reporting.

In an example, RRC may configure the following parameters for the scheduling request procedure: sr-ProhibitTimer (per SR configuration); sr-TransMax (per SR configuration).

In an example, the following UE variable may be used for the scheduling request procedure: SR_COUNTER (per SR configuration).

In an exmaple, if an SR is triggered and there may be no other SRs pending corresponding to the same SR configuration, the MAC entity may set the SR_COUNTER of the corresponding SR configuration to 0.

In an example, when an SR is triggered, it may be considered as pending until it is cancelled.

In an exmaple, pending SR(s) for BSR triggered according to the BSR procedure prior to the MAC PDU assembly may be cancelled and each respective sr-ProhibitTimer may be stopped when the MAC PDU is transmitted and this PDU may include a Long or Short BSR MAC CE which may contain buffer status up to (and including) the last event that triggered a BSR prior to the MAC PDU assembly. The pending SR(s) for BSR triggered according to the BSR procedure may be cancelled and each respective sr-ProhibitTimer may be stopped when the UL grant(s) can accommodate all pending data available for transmission.

In an example, if the MAC entity may be configured with one or more SCells, the network may activate and deactivate the configured SCells. Upon configuration of an SCell, the SCell may be deactivated unless the parameter sCellState is set to activated for the SCell by upper layers.

In an example, the configured SCell(s) may be activated and deactivated by: receiving an SCell Activation/Deactivation MAC CE; receiving an Enhanced SCell Activation/Deactivation MAC CE; configuring sCellDeactivationTimer timer per configured SCell (except the SCell configured with PUCCH, if any): the associated SCell may be deactivated upon its expiry; configuring sCellState per configured SCell: if configured, the associated SCell may be activated upon SCell configuration; receiving scg-State: the SCells of SCG may be deactivated.

In an example, in response to activation of a SCell, normal SCell operation may include SRS transmissions on the SCell; CSI reporting for the SCell; PDCCH monitoring on the SCell; PDCCH monitoring on the SCell; PDCCH monitoring for the SCell; PUCCH transmissions on the SCell, if configured.

A wireless device may communicate with base station via one or more cells that are configured with cell DTX and/or cell DRX. A cell in the one or more cells may be configured with one or more cell DTX and/or cell DRX patterns resulting in no or reduced uplink or downlink transmission of one or more channels/signals. The operation according to the cell DTX and/or cell DRX and/or no/reduced transmission of the channels/signals may result in degradation and reducing efficiency of existing one or more L1 and/or L2 processes. There is a need to enhance the existing L1 and/or L2 processes when one or more cells are configured with cell DTX and/or cell DRX patterns. Example embodiments enhance the one or more L1 and/or L2 processes when one or more cells are configured with cell DTX and/or cell DRX patterns.

In example embodiments, a cell may be configured to operate (e.g., UE specifically for a wireless device or for a group of wireless devices) based on a cell DTX pattern and/or based on a cell DRX pattern. In an example, a cell DTX/DRX pattern may be jointly configured (e.g., configured as one pattern that applies for both cell DTX and cell DRX) for a cell and may indicate both a cell DTX pattern and a cell DRX pattern. The cell DTX pattern may indicate timings that the cell does not transmit (e.g., a base station does not transmit to a wireless device via the cell) one or more signals/channels and/or transmission of the one or more signals/channels via the cell is reduced (e.g., with a lower frequency/number or with a simplified version). The cell DRX pattern may indicate timings that the cell does not receive (e.g., a base station does not receive from a wireless device via the cell) one or more signals/channels and/or reception of the one or more signals/channels via the cell is reduced (e.g., with a lower frequency/number or with a simplified version). At a given timing, a cell may be in a cell DTX state in which case the cell does not transmit the one or more signals/channels and/or transmission of the one or more signals/channels via the cell is reduced or the cell may be in the non-cell DTX state in which case the cell transmits the one or more signals/channels. At a given timing, a cell may be in a cell DRX state in which case the cell does not receive the one or more signals/channels and/or reception of the one or more signals/channels via the cell is reduced or the cell may be in the non-cell DRX state in which case the cell receives the one or more signals/channels.

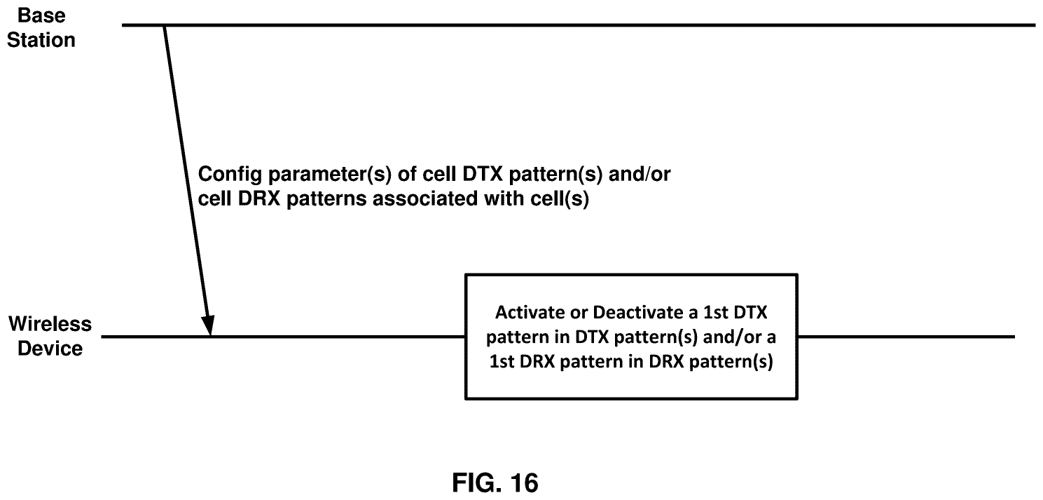

In an example embodiment as shown in FIG. 16, a wireless device may receive one or more messages (e.g., one or more RRC messages) comprising configuration parameters (e.g., RRC configuration parameters). The configuration parameters may include configuration parameters of one or more cell discontinuous transmission (DTX) and/or cell discontinuous reception (DRX) patterns. The one or more cell DTX and/or cell DRX patterns may be associated with/applicable to/configured for one or more cells (e.g., one or more cells that are configured for the wireless device for communications with one or more base stations). In an example, a cell DTX pattern and/or a cell DRX pattern may be configured cell specifically or may be configured for/applicable to/associated with a plurality of cells (e.g., a plurality of cells in a cell group or a plurality of cells associated with a MAC entity). In an example, a cell DTX/DRX pattern for a cell may be associated with/applicable to/configured for both cell discontinuous transmission (DTX) and cell discontinuous reception (DRX), e.g., may be used jointly for cell DTX and cell DRX (e.g., used jointly for determination of timings of cell DTX and cell DRX). In an example, separate patterns may be associated with/applicable to/configured for cell DTX and cell DRX for the cell, e.g., a cell DTX pattern may be associated with/applicable to/configured for the cell DTX for the cell (e.g., used in determination of timings of cell DTX) and a cell DRX pattern, which may be different from the cell DTX pattern, may be associated with/applicable to/configured for cell DRX for the cell (e.g., used in determination of timings of cell DRX).

A cell DTX pattern and/or a cell DRX pattern may be a time domain pattern. In an example, in case of separate configurations of cell DTX pattern and cell DRX pattern, a cell DTX pattern for a cell may indicate, and the wireless device may determine based on the cell DTX pattern, timings that the cell is in a no-transmission/reduced transmission mode (e.g., timings that the base station does not transmit a signal/channel via the cell or transmission of signal(s)/channel(s) via the cell are reduced, e.g., reduced in frequency/number or transmission of signal(s)/channel(s) is with a simplified version) and timings that the cell is not in the no-transmission/reduced transmission mode; and a cell DRX pattern for a cell may indicate, and the wireless device may determine based on the cell DRX pattern, timings that the cell is in a no-reception/reduced reception mode (e.g., timings that the base station does not receive a signal/channel via the cell or reception of signal(s)/channel(s) via the cell are reduced, e.g., reduced in frequency/number or reception of signal(s)/channel(s) is with a simplified version) and timings that the cell is not in the no-reception/reduced reception mode. In an example, in case that a DTX/DRX pattern is applicable to/configured for (e.g., jointly applicable to/configured for) a cell DTX and cell DRX, the cell DTX/DRX pattern for a cell may indicate, and the wireless device may determine based on the cell DTX/DRX pattern, timings that the cell is in a no-transmission/reduced transmission or no-reception/reduced reception mode (e.g., timings that the base station does not transmit/receive a signal/channel via the cell or transmission/reception of signal(s)/channel(s) via the cell are reduced e.g., reduced in frequency/number or transmission/reception of signal(s)/channel(s) is with a simplified version) and timings that the cell is not in the no-transmission/reduced transmission or no-reception/reduced reception mode.

In an example, a cell DTX pattern or a cell DRX pattern or a cell DTX/DRX pattern (e.g., joint cell DTX/DRX pattern) may comprise OFF duration(s) and ON duration(s). An OFF duration for a cell DTX pattern for a cell may indicate (based on which the wireless device may determine) that the cell is in a no-transmission/reduced transmission mode and an ON duration for the cell DTX pattern for the cell may indicate (based on which the wireless device may determine) that the cell is not in the no-transmission/reduced transmission mode. An OFF duration for a cell DRX pattern for a cell may indicate (based on which the wireless device may determine) that the cell is in a no-reception/reduced reception mode and an ON duration for the cell DRX pattern for the cell may indicate (based on which the wireless device may determine) that the cell is not in the no-reception/reduced reception mode. An OFF duration for a cell DTX/DRX pattern (e.g., joint cell DTX/DRX pattern) for a cell may indicate (based on which the wireless device may determine) that the cell is in a no-transmission/reduced transmission and no-reception/reduced reception mode and an ON duration for the cell DTX/DRX pattern (e.g., joint cell DTX/DRX pattern) for the cell may indicate (based on which the wireless device may determine) that the cell is not in the no-transmission/reduced transmission not in the no-reception/reduced reception mode.

In an example, configuration of a cell DTX pattern and/or cell DRX pattern may include parameters indicating a periodicity, a start slot/offset (e.g., offset to a command/message, e.g., an activation command/message) that the cell DTX pattern and/or the cell DRX pattern and/or a joint cell DTX/DRX pattern starts or is applicable, an ON duration associated with the cell DTX pattern and/or the cell DRX pattern and/or the joint cell DTX/DRX pattern, etc. The wireless device, based on the configuration of the cell DTX pattern and/or the cell DRX pattern and/or the joint cell DTX/DRX pattern for a cell, may determine timings that the cell is in in the no transmission/reduced transmission and/or in the no reception/reduced reception mode. In an example, the wireless device may determine timings that the cell is in in the no transmission/reduced transmission and/or the no reception/reduced reception mode further based on a command/message (e.g., timing of the command/message) indicating activation of the cell DTX pattern and/or the cell DRX pattern.

The wireless device may activate (e.g., apply) or deactivate (e.g., stop applying) a first cell DTX pattern, in the one or more cell DTX patterns configured for the wireless device, and/or a first cell DRX pattern, in the one or more cell DRX patterns configured for the wireless device. In an example as shown in FIG. 16, the wireless may activate the first cell DTX pattern and/or the first cell DRX pattern in response to receiving the configuration parameters of the one or more cell DTX patterns and/or cell DRX patterns, e.g., in response to receiving one or more messages (e.g., one or more RRC messages) that include the configuration parameters of the one or more cell DTX patterns and/or cell DRX patterns. In an example, the configuration parameters of the one or more cell DTX patterns and/or cell DRX patterns may comprise first configuration parameters of a first cell DTX pattern and/or a first cell DRX pattern. In an example, the wireless device may activate the first cell DTX pattern and/or the first cell DRX pattern in response to receiving the first configuration parameters (e.g., the one or more messages (e.g., the one or more RRC messages) comprising the first configuration parameters) and without receiving an activation command (e.g., a L1 (e.g., DCI) or L2 (e.g., MAC CE) activation command). The first configuration parameters may comprise at least one parameter indicating whether activation of the first cell DTX pattern and/or the first cell DRX pattern is in response to receiving the first configuration parameters of the first cell DTX pattern and/or the first cell DRX pattern (e.g., in response to receiving the one or more messages (e.g., the one or more RRC messages) comprising the first configuration parameters). The at least one parameter may indicate whether activation of the first cell DTX pattern and/or the first cell DRX pattern is in response to receiving the first configuration parameters (e.g., the one or more messages comprising the first configuration parameters) and without an activation command (e.g., a L1 (e.g., DCI)/L2 (e.g., MAC CE) activation command). For example, a first value of the at least one parameter may indicate that the activation of the first cell DTX pattern and/or the first cell DRX pattern is in response to receiving the first configuration parameters (e.g., the one or more messages comprising the first configuration parameters) and without an activation command, and a second value of the at least one parameter may indicate that the activation of the first cell DTX pattern and/or the first cell DRX pattern is in response to receiving the first configuration parameters (e.g., the one or more messages comprising the first configuration parameters) and further receiving the activation command (e.g., the L1/L2 activation command).

In an example, the wireless device may activate the first cell DTX pattern and/or the first cell DRX pattern based on a timing of reception of the one or more messages (e.g., the one or more RRC messages) and based on an offset (e.g., an offset to a system frame number (e.g., a preconfigured SFN such as SFN 0 or an SFN determined based on/indicated by an RRC configuration parameter)). For example, the offset may be to a preconfigured or configurable SFN prior to reception of the one or more messages (e.g., the one or more RRC messages). In an example, the starting timing/slot of the cell DTX pattern and/or the cell DRX pattern may be based on the reception timing/slot of the one or more messages (e.g., the one or more RRC messages) and the offset (e.g., in a number of slots).

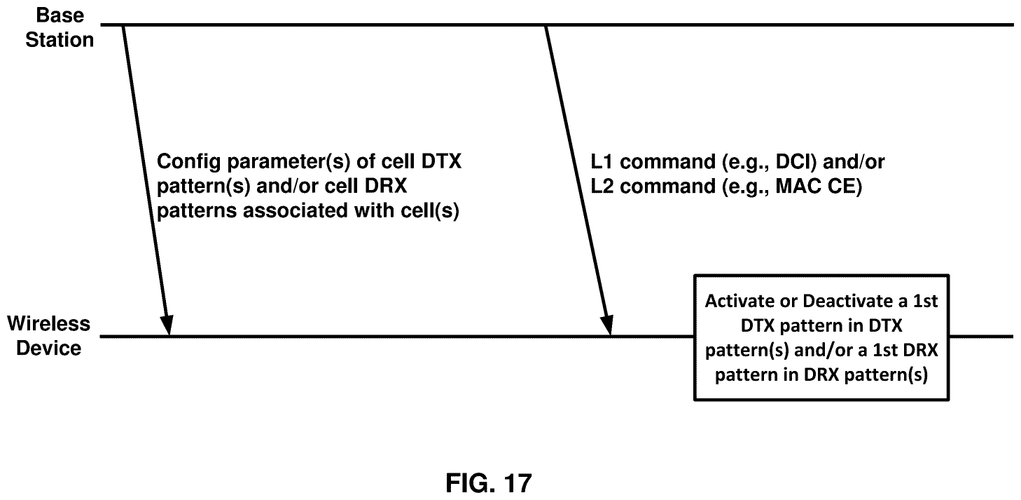

In an example as shown in FIG. 17, the wireless device may receive a L1 command (e.g., a DCI) and/or a L2 command (e.g., a MAC CE) indicating activation or deactivation of the first cell DTX pattern and/or the first cell DRX pattern. In an example, the L1 command/L2 command may indicate activation of the first cell DTX pattern and/or the first cell DRX pattern. The wireless device may activate the first cell DTX pattern and/or the first cell DRX pattern in response to receiving the first configuration parameters of the first cell DTX pattern and/or the first cell DRX pattern (e.g., one or more messages (e.g., one or more RRC messages) comprising the first configuration parameters) and further in response to receiving the L1 command/L2 command. In an example, the L1 command/L2 command may indicate deactivation of the first cell DTX pattern and/or the first cell DRX pattern. The wireless device may deactivate the first cell DTX pattern and/or the first cell DRX pattern in response to receiving the L1 command/L2 command.

In an example the L1/L2 command used for activation or deactivation of a cell DTX pattern and/or a cell DRX pattern may be based on a received DCI. In an example, a format associated with the DCI may indicate that the DCI is for/associated with/usable in activation/deactivation of a cell DTX pattern and/or a cell DRX pattern. The wireless device may determine that a received DCI is for/associated with/usable in activation/deactivation of a cell DTX pattern and/or a cell DRX pattern based on the format associated with the received DCI. In an example, an identifier (e.g., a radio network temporary identifier (e.g., RNTI)) associated with the DCI may indicate that the DCI is for/associated with/usable in activation/deactivation of a cell DTX pattern and/or a cell DRX pattern. The wireless device may determine that a received DCI is for/associated with/usable in activation/deactivation of a cell DTX pattern and/or a cell DRX pattern based on the identifier (e.g., RNTI) associated with the received DCI. In an example, a value of a field of the DCI may indicate that the DCI is for/associated with/usable in activation/deactivation of a cell DTX pattern and/or a cell DRX pattern. The wireless device may determine that a received DCI is for/associated with/usable in activation/deactivation of a cell DTX pattern and/or a cell DRX pattern based on the value of the field of the received DCI. The value of the field of the DCI indicating that the received DCI is for/associated with/usable in activation/deactivation of a cell DTX pattern and/or a cell DRX pattern may be a predetermined/preconfigured value or may be a configurable value determined based on a configuration parameter.

In an example, a value of a field of a received DCI may indicate (and the wireless device may determine based on the value of the field of the DCI) whether the DCI is for/associated with/usable in activation of a cell DTX pattern and/or a cell DRX pattern or whether the DCI is for/associated with/usable in deactivation of the cell DTX pattern and/or the cell DRX pattern. For example, a first value of the field may indicate (and the wireless device may determine based on the field having the first value) that the DCI is for/associated with/usable in activation of a cell DTX pattern and/or a cell DRX pattern. For example, a second value of the field may indicate (and the wireless device may determine based on the field having the second value) that the DCI is for/associated with/usable in deactivation of the cell DTX pattern and/or the cell DRX pattern. For example, the field of the DCI may comprise a first bit. A value of 1 of the first bit may indicate that the DCI is for/associated with/usable in activation of the cell DTX pattern and/or the cell DRX pattern and a value of 0 of the first bit may indicate that the DCI is for/associated with/usable in deactivation of the cell DTX pattern and/or the cell DRX pattern.

In an example, the DCI used for activation/deactivation of a cell DTX pattern and/or cell DRX pattern may be a scheduling DCI (e.g., may have a format associated with a scheduling DCI, such as a format 0_0, 0_1, 0_2, 1_0, 1_1 or 1_2). The DCI may indicate scheduling information/resource allocation for an uplink transmission or a downlink transmission. In an example, the DCI may indicate scheduling information/resource allocation for an uplink transmission or a downlink transmission and may further indicate activation/deactivation of the cell DTX pattern and/or cell DRX pattern. In an example, a value of a first field of the DCI may indicate that the DCI, which has a scheduling format, is not used for scheduling purposes and/or is used for activation/deactivation of a cell DTX pattern and/or cell DRX pattern. In an example, an RNTI associated with the DCI may indicate that the DCI, which has a scheduling format, is not used for scheduling purposes and/or is used for activation/deactivation of a cell DTX pattern and/or cell DRX pattern.

In an example, the DCI used for activation/deactivation of a cell DTX pattern and/or cell DRX pattern may not be a scheduling DCI and/or may be specific for activation/deactivation of a cell DTX pattern and/or a cell DRX pattern for a cell. The DCI may have a format indicating (and the wireless device may determine based on the format associated with the DCI) that the DCI is for activation/deactivation of a cell DTX pattern and/or cell DRX pattern.

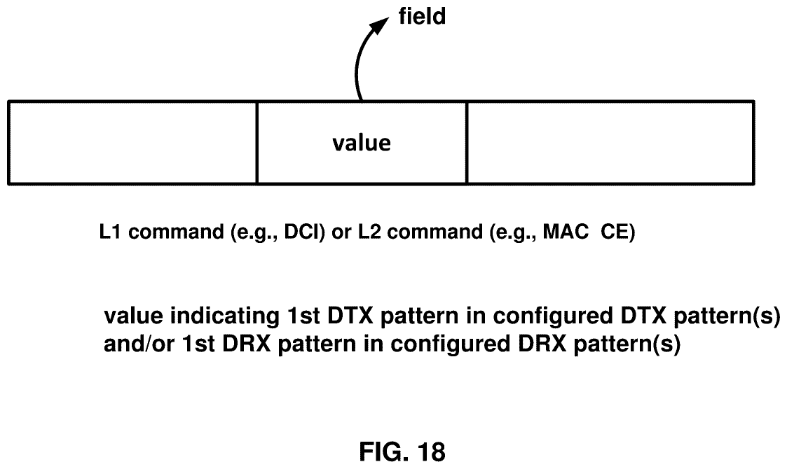

In an example as shown in FIG. 18, the DCI used for activation/deactivation of a cell DTX pattern and/or cell DRX pattern may comprise a field with a value indicating activation or deactivation of the first cell DTX pattern and/or the first cell DRX pattern. The value of the field of the DCI may indicate activation or deactivation of the first cell DTX pattern in one or more cell DTX patterns and/or the first cell DRX pattern in one or more cell DRX patterns. For example, each of the one or more cell DTX patterns and/or each of the one or more cell DRX patterns may be associated with an identifier. For example, configuration parameters of a cell DTX pattern and/or a cell DRX pattern may comprise an identifier parameter indicating the identifier of the cell DTX pattern and/or the cell DRX pattern. For example, in case eight cell DTX pattern and/or cell DRX patterns are configured, the identifiers of the eight cell DTX pattern and/or cell DRX pattern may be 000, 001, 010, 011, 100, 101, 110 and 111. For example, in case sixteen cell DTX pattern and/or cell DRX patterns are configured, the identifiers of the sixteen cell DTX pattern and/or cell DRX pattern may be 0000, 0001, . . . 1111. In an example, the identifier of a cell DTX pattern and/or the cell DRX pattern may identify the cell DTX pattern and/or the cell DRX pattern among a plurality of cell DTX patterns and/or cell DRX patterns that are configured for a cell, or may identify the cell DTX pattern and/or the cell DRX pattern among a plurality of cell DTX patterns and/or cell DRX patterns that are configured for a cell group (e.g., SCG or MCG), or may identify the cell DTX pattern and/or the cell DRX pattern among a plurality of cell DTX patterns and/or cell DRX patterns that are configured for a MAC entity. The value of the field of the DCI may indicate the identifier of the cell DTX pattern and/or the cell DRX pattern to be activated (e.g., applied) or to be deactivated (e.g., stopped to be applied) in response to receiving/based on the DCI. The wireless device may determine the first cell DTX pattern and/or the first cell DRX pattern to be activated (e.g., applied) or to be deactivated (e.g., stopped to be applied) based on the value of the field of the DCI.

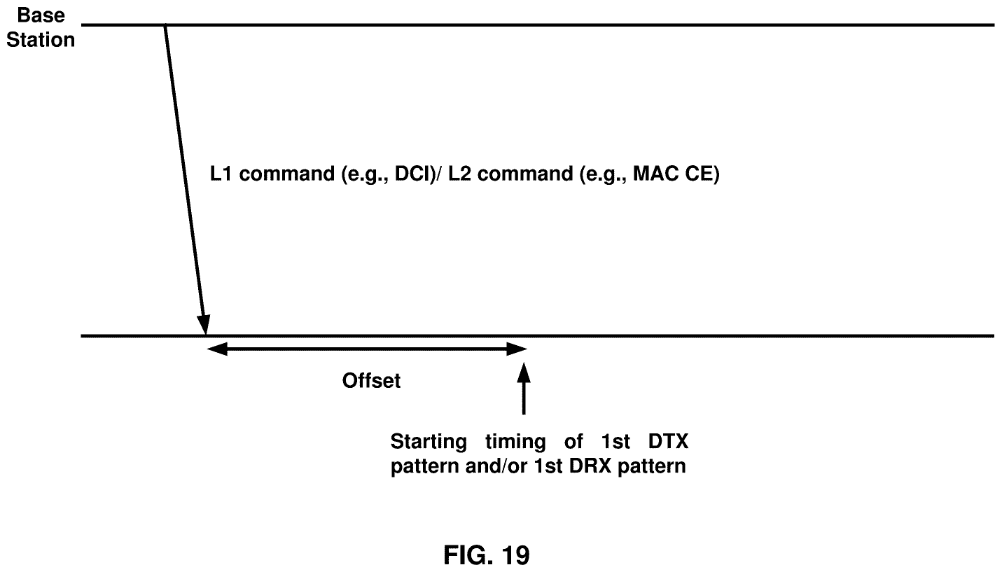

In an example as shown in FIG. 19, a starting timing (e.g., a starting slot/symbol) that the first cell DTX pattern and/or the first cell DRX pattern is/are to be activated/applied may be based on the reception timing of the DCI used for activation/deactivation of a cell DTX pattern and/or cell DRX pattern (e.g., the slot/symbol that the DCI is received) and based on an offset (e.g., an offset in a number of symbols or slots). For example, the offset may be to the reception timing of the DCI (e.g., the slot/symbol that the DCI is received). For example, the offset may be to a system frame number (e.g., SFN 0 or an SFN determined based on/indicated by an RRC configuration parameter). For example, the offset may be to a preconfigured or configurable SFN prior to the reception timing of the DCI. In an example, the configuration parameters (e.g., the configuration parameters of the cell DTX pattern and/or the cell DRX pattern) may comprise an offset parameter indicating the offset. In an example, the DCI may comprise a field with a value indicating the offset. For example, the value of the field of the DCI may indicate a first offset in a plurality of configured (e.g., RRC configured) offsets. The wireless device may receive configuration parameters indicating the plurality of configured offsets. The wireless device may determine the starting timing based on the reception timing of the DCI and based on the offset.

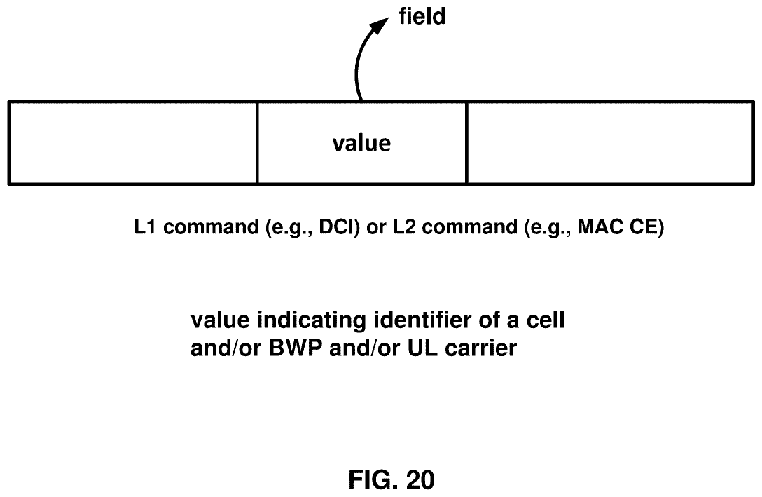

In an example as shown in FIG. 20, the DCI used for activation/deactivation of a cell DTX pattern and/or cell DRX pattern may comprise one or more fields with value(s) indicating an identifier of the cell and/or an identifier of a BWP of a cell and/or an identifier of an uplink carrier of a cell (e.g., a normal uplink carrier (NUL) or a supplementary uplink carrier (SUL) of a cell) on/for which the cell DTX pattern and/or the cell DRX pattern is to be applied/activated. For example, the DCI may comprise a cell identifier field (CIF) field indicating the cell on which the cell DTX pattern and/or the cell DRX pattern to be activated/applied. For example, the configuration parameters of the cell may comprise BWP configuration parameters of a plurality of BWPs for the cell. The configuration parameters of a BWP of a cell may comprise a BWP identifier parameter indicating an identifier of the BWP. The DCI may comprise a field with a value indicating the BWP identifier of the BWP of the cell on which the cell DTX pattern and/or the cell DRX pattern is to be activated/applied. The DCI may comprise a field with a value indicating whether cell DRX patten is to be applied to NUL or a SUL of the cell.

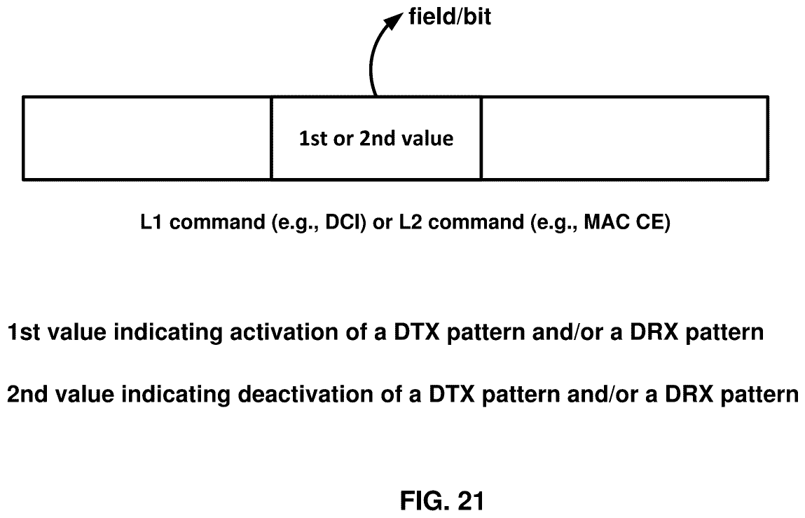

In an example as shown in FIG. 21, the configuration parameters may indicate one cell DTX pattern and/or one cell DRX pattern for the cell. The DCI used for activation/deactivation of cell DTX pattern and/or cell DRX pattern may comprise a field comprising a bit. The field of DCI may comprise a bit. A first value of the bit (e.g., a value of one) may indicate activation of the cell DTX pattern and/or cell DRX pattern configured for the cell and a second value of the bit (e.g., a value of zero) may indicate deactivation of the cell DTX pattern and/or cell DRX pattern configured for the cell. In an example, the cell on which a cell DTX pattern and/or a cell DRX pattern is to be activated or deactivated may be the cell on which the DCI used for activation/deactivation of cell DTX pattern and/or cell DRX pattern is received.

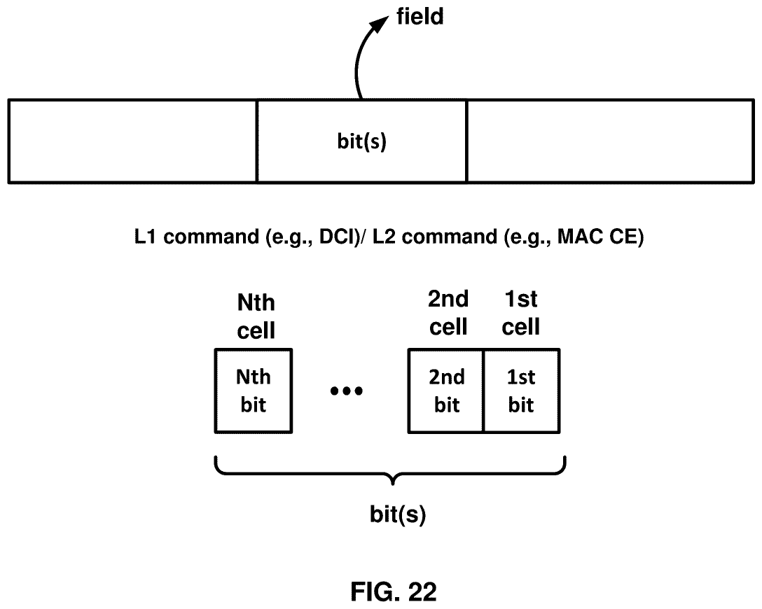

In an example as shown in FIG. 22, the DCI used for activation/deactivation of cell DTX pattern and/or cell DRX pattern may comprise a field comprising a plurality of bits. Each bit in the plurality of bits may be associated with a cell in a plurality of cells. In an example, each bit in the plurality of bits may be associated with a cell in a plurality of configured cells for the wireless device. In an example, each bit in the plurality of bits may be associated with a cell in the plurality of configured cells for the wireless device that are configured with a cell DTX pattern and/or a cell DRX pattern. The value of a first bit in the plurality of bits, that corresponds to a first cell in the plurality of cells, may indicate whether a cell DTX pattern and/or the cell DRX pattern configured for the first cell is to be activated (e.g., is to be applied (e.g., based on a timing)) or is to be deactivated (e.g., stopped to be applied (e.g., based on a timing)). A first value (e.g., value of one) of the first bit may indicate activation of the cell DTX pattern and/or the cell DRX pattern configured for the first cell and/or that the cell DTX pattern and/or the cell DRX pattern configured for the first cell is to be applied (e.g., based on a timing and/or from a starting slot/symbol). A second value (e.g., value of zero) of the first bit may indicate deactivation of the cell DTX pattern and/or the cell DRX pattern configured for the first cell and/or that the cell DTX pattern and/or the cell DRX pattern configured for the first cell is to be deactivated (e.g., is to be stopped from applying (e.g., based on a timing)). In an example, the first cell may be configured with one (e.g., only one) cell DTX pattern and/or cell DRX pattern and the value of the first bit may indicate whether the cell DTX pattern and/or the cell DRX pattern configured for the first cell is to be activated or is to be deactivated. In an example, a position/location of a bit in the plurality of bits may indicate the cell to which the value of the bit (e.g., activation or deactivation) applies. In an example, the bits of the field that are used in determining activation/deactivation of cell DTX pattern/cell DRX pattern may apply to the cells configured for the wireless device that are configured with a cell DTX pattern and/or cell DRX pattern. In an example, a first bit in the plurality of bits (e.g., the rightmost bit of the plurality of bits) that are included in the field of the DCI may correspond to a cell that is configured with a cell DTX pattern and/or cell DRX pattern and that has lowest cell index among the cell index(es) of the cell(s) that are configured with cell DTX pattern and/or cell DRX pattern; a second bit that is adjacent to the first bit (e.g., adjacent to the rightmost bit in the plurality of bits) may correspond to a cell that is configured with a cell DTX pattern and/or cell DRX pattern and that has lowest cell index among the cell index(es) of the cell(s) that are configured with cell DTX pattern and/or cell DRX pattern; and so on. In an example, in case N cell(s) among the cells that are configured for the wireless device are configured with a cell DTX pattern and/or cell DRX pattern, the wireless device may consider the N rightmost bits of the field of the DCI and may ignore any remaining bits in the field.

In an example the L1/L2 command used for activation or deactivation of a cell DTX pattern and/or a cell DRX pattern may be based on a received MAC CE. In an example, a logical channel identifier (LCID) associated with the MAC CE may indicate that the MAC CE is for/associated with/usable in activation/deactivation of a cell DTX pattern and/or a cell DRX pattern. The wireless device may determine that a received MAC CE is for/associated with/usable in activation/deactivation of a cell DTX pattern and/or a cell DRX pattern based on the LCID associated with the received MAC CE. In an example, a value of a field of the MAC CE may indicate that the MAC CE is for/associated with/usable in activation/deactivation of a cell DTX pattern and/or a cell DRX pattern. The wireless device may determine that a received MAC CE is for/associated with/usable in activation/deactivation of a cell DTX pattern and/or a cell DRX pattern based on the value of the field of the received MAC CE. The value of the field of the MAC CE indicating that the received MAC CE is for/associated with/usable in activation/deactivation of a cell DTX pattern and/or a cell DRX pattern may be a predetermined/preconfigured value or may be a configurable value determined based on a configuration parameter.

In an example, a value of a field of a received MAC CE may indicate (and the wireless device may determine based on the value of the field of the MAC CE) whether the MAC CE is for/associated with/usable in activation of a cell DTX pattern and/or a cell DRX pattern or whether the MAC CE is for/associated with/usable in deactivation of the cell DTX pattern and/or the cell DRX pattern. For example, a first value of the field may indicate (and the wireless device may determine based on the field having the first value) that the MAC CE is for/associated with/usable in activation of a cell DTX pattern and/or a cell DRX pattern. For example, a second value of the field may indicate (and the wireless device may determine based on the field having the second value) that the MAC CE is for/associated with/usable in deactivation of the cell DTX pattern and/or the cell DRX pattern. For example, the field of the MAC CE may comprise a first bit. A value of 1 of the first bit may indicate that the MAC CE is for/associated with/usable in activation of the cell DTX pattern and/or the cell DRX pattern and a value of 0 of the first bit may indicate that the MAC CE is for/associated with/usable in deactivation of the cell DTX pattern and/or the cell DRX pattern.

In an example as shown in FIG. 18, the MAC CE used for activation/deactivation of a cell DTX pattern and/or cell DRX pattern may comprise a field with a value indicating activation or deactivation of the first cell DTX pattern and/or the first cell DRX pattern. The value of the field of the MAC CE may indicate activation or deactivation of the first cell DTX pattern in one or more cell DTX patterns and/or the first cell DRX pattern in one or more cell DRX patterns. For example, each of the one or more cell DTX patterns and/or each of the one or more cell DRX patterns may be associated with an identifier. For example, configuration parameters of a cell DTX pattern and/or a cell DRX pattern may comprise an identifier parameter indicating the identifier of the cell DTX pattern and/or the cell DRX pattern. For example, in case eight cell DTX pattern and/or cell DRX patterns are configured, the identifiers of the eight cell DTX pattern and/or cell DRX pattern may be 000, 001, 010, 011, 100, 101, 110 and 111. For example, in case sixteen cell DTX pattern and/or cell DRX patterns are configured, the identifiers of the sixteen cell DTX pattern and/or cell DRX pattern may be 0000, 0001, . . . 1111. In an example, the identifier of a cell DTX pattern and/or the cell DRX pattern may identify the cell DTX pattern and/or the cell DRX pattern among a plurality of cell DTX patterns and/or cell DRX patterns that are configured for a cell, or may identify the cell DTX pattern and/or the cell DRX pattern among a plurality of cell DTX patterns and/or cell DRX patterns that are configured for a cell group (e.g., SCG or MCG), or may identify the cell DTX pattern and/or the cell DRX pattern among a plurality of cell DTX patterns and/or cell DRX patterns that are configured for a MAC entity. The value of the field of the MAC CE may indicate the identifier of the cell DTX pattern and/or the cell DRX pattern to be activated (e.g., applied) or deactivated (e.g., stopped to be applied) in response to receiving/based on the MAC CE. The wireless device may determine the first cell DTX pattern and/or the first cell DRX pattern to be activated (e.g., applied) or to be deactivated (e.g., stopped to be applied) based on the value of the field of the MAC CE.

In an example as shown in FIG. 19, a starting timing (e.g., a starting slot/symbol) that the first cell DTX pattern and/or the first cell DRX pattern is to be activated/applied may be based on the reception timing of the MAC CE used for activation/deactivation of a cell DTX pattern and/or cell DRX pattern (e.g., the slot/symbol that the MAC CE is received) and based on an offset (e.g., an offset in a number of symbols or slots). For example, the offset may be to the reception timing of the MAC CE (e.g., the slot/symbol that the MAC CE is received). For example, the offset may be to a system frame number (e.g., a preconfigured SFN such as SFN 0 or an SFN determined based on/indicated by an RRC configuration parameter). For example, the offset may be to a preconfigured or configurable SFN prior to the reception timing of the MAC CE. In an example, the configuration parameters (e.g., the configuration parameters of the cell DTX pattern and/or the cell DRX pattern) may comprise an offset parameter indicating the offset. In an example, the MAC CE may comprise a field with a value indicating the offset. For example, the value of the field of the MAC CE may indicate a first offset in a plurality of configured (e.g., RRC configured) offsets. The wireless device may receive configuration parameters indicating the plurality of configured offsets. The wireless device may determine the starting timing based on the reception timing of the MAC CE and based on the offset.

In an example as shown in FIG. 20, the MAC CE used for activation/deactivation of a cell DTX pattern and/or cell DRX pattern may comprise one or more fields with value(s) indicating an identifier of the cell and/or an identifier of a BWP of a cell and/or an identifier of an uplink carrier of a cell (e.g., a normal uplink carrier (NUL) or a supplementary uplink carrier (SUL)) on which the cell DTX pattern and/or the cell DRX pattern is to be applied/activated. For example, the MAC CE may comprise a cell identifier field indicating the cell on which the cell DTX pattern and/or the cell DRX pattern to be activated/applied. For example, the configuration parameters of the cell may comprise BWP configuration parameters of a plurality of BWPs for the cell. The configuration parameters of a BWP of a cell may comprise a BWP identifier parameter indicating an identifier of the BWP. The MAC CE may comprise a field with a value indicating the BWP identifier of the BWP of the cell on which the cell DTX pattern and/or the cell DRX pattern is to be activated/applied. The MAC CE may comprise a field with a value indicating whether cell DRX patten is to be applied to NUL or a SUL of the cell.

In an example as shown in FIG. 21, the configuration parameters may indicate one cell DTX pattern and/or one cell DRX pattern for the cell. The MAC CE used for activation/deactivation of cell DTX pattern and/or cell DRX pattern may comprise a field. The field of MAC CE may comprise a bit. A first value of the bit (e.g., a value of one) may indicate activation of the cell DTX pattern and/or cell DRX pattern configured for the cell and a second value of the bit (e.g., a value of zero) may indicate deactivation of the cell DTX pattern and/or cell DRX pattern configured for the cell. In an example, the cell on which a cell DTX pattern and/or a cell DRX pattern is to be activated or deactivated may be the cell on which the MAC CE used for activation/deactivation of cell DTX pattern and/or cell DRX pattern is received.

In an example as shown in FIG. 22, the MAC CE used for activation/deactivation of cell DTX pattern and/or cell DRX pattern may comprise a field comprising a plurality of bits. Each bit in the plurality of bits may be associated with a cell in a plurality of cells (e.g., a plurality of cells configured for the wireless device, or a plurality of configured cells that are configured with a cell DTX pattern and/or a cell DRX pattern). The value of a first bit in the plurality of bits, that corresponds to a first cell in the plurality of cells, may indicate whether a cell DTX pattern and/or the cell DRX pattern configured for the first cell is to be activated or deactivated (e.g., is to be in an activated state or in a deactivated state). A first value (e.g., value of one) of the first bit may indicate activation of the cell DTX pattern and/or the cell DRX pattern configured for the first cell and/or that the cell DTX pattern and/or the cell DRX pattern configured for the first cell is to be activated (e.g., based on a timing and/or from a starting slot/symbol). A second value (e.g., value of zero) of the first bit may indicate deactivation of the cell DTX pattern and/or the cell DRX pattern configured for the first cell and/or that the cell DTX pattern and/or the cell DRX pattern configured for the first cell is to be deactivated (e.g., based on a timing). In an example, the first cell may be configured with one (e.g., only one) cell DTX pattern and/or cell DRX pattern and the value of the first bit may indicate whether the cell DTX pattern and/or the cell DRX pattern configured for the first cell is to be activated/in the activated state or is to be deactivated/in the deactivated state. In an example, a position/location of a bit in the plurality of bits may indicate the cell to which the value of the bit (e.g., activation or deactivation) applies. In an example, the bits of the field that are used in determining activation/deactivation of cell DTX pattern/cell DRX pattern may apply to the cells configured for the wireless device that are configured with a cell DTX pattern and/or cell DRX pattern. In an example, a first bit in the plurality of bits (e.g., the rightmost bit of the plurality of bits) that are included in the field of the MAC CE may correspond to a cell that is configured with a cell DTX pattern and/or cell DRX pattern and that has lowest cell index among the cell index(es) of the cell(s) that are configured with cell DTX pattern and/or cell DRX pattern; a second bit that is adjacent to the first bit (e.g., adjacent to the rightmost bit in the plurality of bits) may correspond to a cell that is configured with a cell DTX pattern and/or cell DRX pattern and that has lowest cell index among the cell index(es) of the cell(s) that are configured with cell DTX pattern and/or cell DRX pattern; and so on. In an example, in case N cell(s) among the cells that are configured for the wireless device are configured with a cell DTX pattern and/or cell DRX pattern, the wireless device may consider the N rightmost bits of the field of the MAC CE and may ignore any remaining bits in the field.

In an example embodiment, the wireless device may receive an L1 (e.g., DCI)/L2 (e.g., MAC CE) command for activation/deactivation of a cell DTX pattern and/or cell DRX pattern. A DCI, e.g., a scheduling DCI (e.g., a DL scheduling DCI or an UL scheduling DCI) or a MAC CE may comprise a field with a value indicating activation of a cell DTX pattern and/or a cell DRX pattern. The starting time of the cell DTX pattern and/or the cell DRX pattern may be based on the reception timing of the DCI/MAC CE and an offset (e.g., a preconfigured/predetermined offset or a configurable offset e.g., based on receiving a configuration parameter indicating the offset), e.g., an offset to the reception timing of the DCI/MAC CE. In an example, the cell DTX pattern and/or the cell DRX pattern may be one of a plurality of configured patterns.

In an example, the DCI/MAC CE may indicate (e.g., comprises one or more fields with values indicating) an identifier of the cell and/or an identifier of the BWP of the cell and/or an identifier of the uplink carrier (e.g., NUL and/or SUL) of the cell for which the cell DTX pattern and/or the cell DRX pattern is to be activated or deactivated.

In an example, the DCI/MAC CE may indicate which of one or more configured cell DTX and/or cell DRX patterns is to be activated. Each of the one or more configured cell DTX/DRX configured patterns is associated with an identifier. The DCI/MAC CE indicates (e.g., may comprise a field with a value indicating) the identifier of the cell DTX and/or cell DRX pattern to be activated.

In an example, there may be (e.g., for a cell) a single cell DTX and/or cell DRX configuration (e.g., a single cell DTX pattern and/or cell DRX pattern configuration). In an example, the MAC CE may have a zero payload. The MAC CE may indicate activation (if currently deactivated) or may indicate activation of the cell DTX pattern and/or cell DRX pattern. In an example, the payload pf the MAC CE or DCI may include a field comprising a bit. A first value of the bit (e.g., value of one) may indicate activation of the cell DTX and/or cell DTX pattern and a second value of the bit (e.g., value of zero) may indicate deactivation of the cell DTX and/or cell DRX pattern.

In an example, the activation/deactivation of the cell DTX and/or cell DRX pattern may be applicable to the cell on which the activation/deactivation command is received.

In an example, the DCI may be associated with a format indicating that the DCI is for activation/deactivation of a cell DTX/cell DRX pattern.

In an example, the DCI may be associated with an RNTI indicating that the DCI is for activation/deactivation of a cell DTX/cell DRX pattern.

In an example, the MAC CE may be associated with an LCID indicating that the MAC CE is for activation/deactivation of a cell DTX/cell DRX pattern.

In an example, the DCI/MAC CE may comprise a field comprising a plurality of bits. Each bit in the plurality of bits may correspond to a cell. A value of the bit may indicate whether the cell DTX/cell DRX pattern is to be activated (e.g., when bit has a value of one) or deactivated (e.g., when bit has a value of zero) for the corresponding cell (e.g., in case one cell DTX/DRX pattern configured per cell).

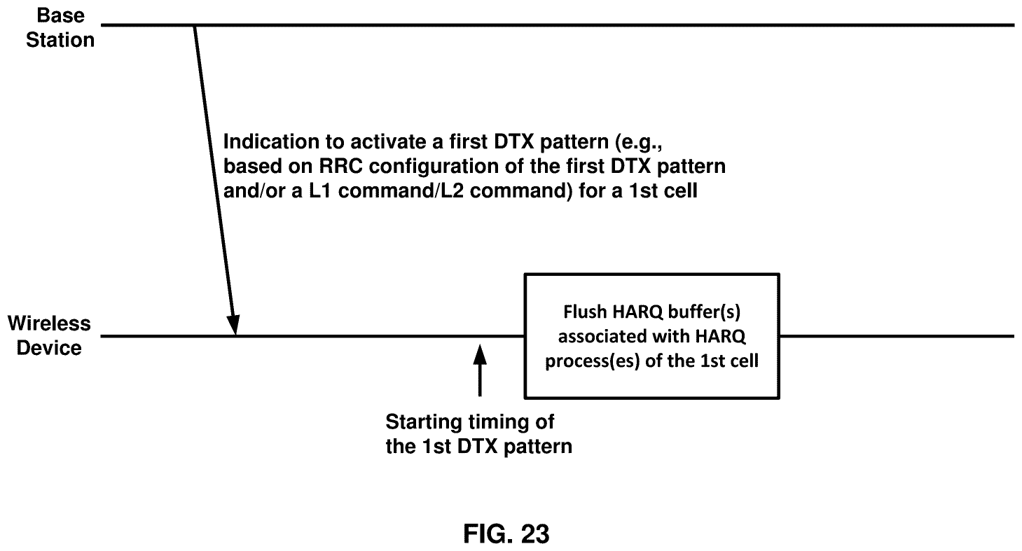

In an example as shown in FIG. 23, the wireless device may activate/apply the first cell DTX pattern for/to a first cell in the one or more cells. In an example, the wireless device may activate/apply the first cell DTX pattern for/to the first cell in response to receiving configuration parameters (e.g., one or more messages (e.g., one or more RRC messages) comprising the configuration parameters) of the first cell DTX pattern. In an example, the wireless device may activate/apply the first cell DTX pattern for/to the first cell in response to receiving a L1 command (e.g., DCI)/L2 command (e.g., MAC CE) indicating activation of/applying the first cell DTX pattern for/to the first cell. The wireless device may flush one or more HARQ buffers associated with one or more HARQ processes (e.g., one or more downlink HARQ processes) of the first cell. The wireless device may flush the one or more HARQ buffers in response to/based on transitioning of the first cell to a cell DTX state (e.g., transitioning from a normal/non-cell DTX state to the cell DTX state) based on the first cell DTX pattern and/or in response to activation of/applying the first cell DTX pattern for/to the first cell. In an example, the wireless device may flush the one or more HARQ buffers in response to/based on receiving the configuration parameters (e.g., one or more messages (e.g., one or more RRC messages) comprising the configuration parameters) of the first cell DTX pattern. In an example, the wireless device may flush the one or more HARQ buffers in response to/based on receiving a L1 command (e.g., DCI)/L2 command (e.g., MAC CE) indicating activation of/applying the first cell DTX pattern for/to the first cell. In an example, the one or more HARQ processes (e.g., the one or more downlink HARQ processes) of the first cell that are flushed may be the HARQ processes (e.g., all of the HARQ processes) configured for the first cell. In an example, the one or more HARQ processes (e.g., the one or more downlink HARQ processes) of the first cell that are flushed may be a subset of the HARQ processes configured for the first cell. The subset of the HARQ processes that are flushed may be the HARQ processes configured for the first cell except (e.g., excluding) the HARQ processes configured for one or more SPS grants/SPS configurations.

In an example, the flushing the one or more HARQ buffers may be based on one or more conditions. In an example, the one or more conditions may be based on one or more parameters associated with the first cell DTX pattern. The one or more parameters may include a cell DTX periodicity associated with the first cell DTX pattern and/or a cell DTX duration (e.g., On duration) associated with the first cell DTX pattern. For example, the one or more conditions may include the cell DTX duration (e.g., the On duration) being larger than a threshold (e.g., a preconfigured threshold or a configurable threshold determined based on a received configuration parameter). For example, the one or more conditions may include the cell DTX periodicity being larger than a threshold (e.g., a preconfigured threshold or a configurable threshold determined based on a received configuration parameter).

In an example, the wireless device may flush (e.g., may determine to flush) the one or more HARQ processes based on a value of a parameter (e.g., a configuration parameter), for example, based on the parameter/configuration parameter having a first value. In an example, the configuration parameter of the one or more cell DTX patterns and/or cell DRX patterns (e.g., the first cell DTX pattern) may comprise the configuration parameter that the flushing/determining to flush is based on.

In an example, the wireless device may activate/apply the first cell DTX pattern for/to the first cell in response to/based on receiving a L1 command (e.g., DCI)/L2 command (e.g., MAC CE). The wireless device may flush (e.g., may determine to flush) the one or more HARQ processes based on the L1/L2 command (e.g., based on the value of a field of the L1/L2 command). The wireless device may flush (e.g., may determine to flush) the one or more HARQ processes based on the field of the L1/L2 command having a first value (e.g., a predetermined/preconfigured or a configurable value).

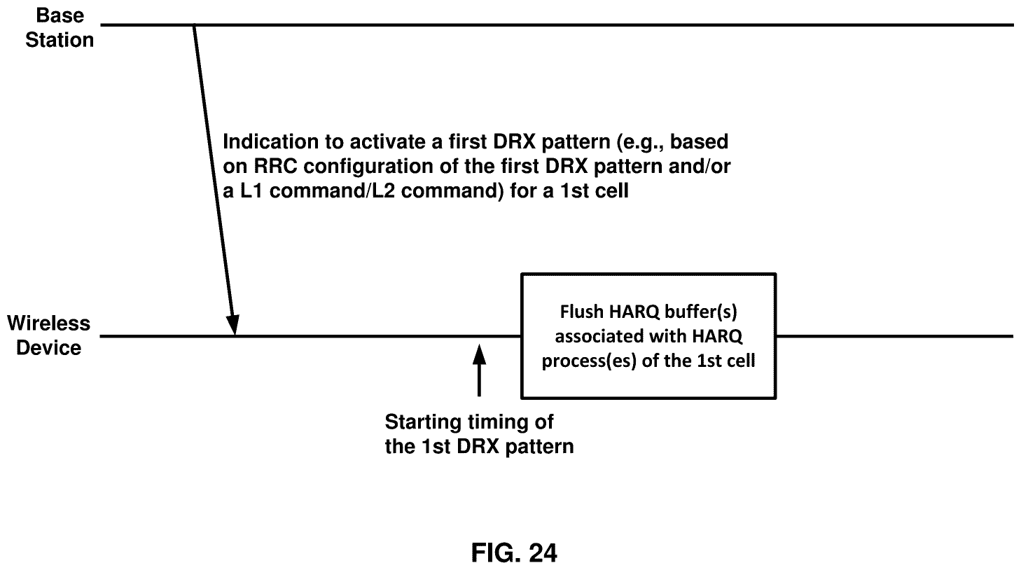

In an example as shown in FIG. 24, the wireless device may activate/apply the first cell DRX pattern for/to a first cell in the one or more cells. In an example, the wireless device may activate/apply the first cell DRX pattern for/to the first cell in response to receiving configuration parameters (e.g., one or more messages (e.g., one or more RRC messages) comprising the configuration parameters) of the first cell DRX pattern. In an example, the wireless device may activate/apply the first cell DRX pattern for/to the first cell in response to receiving a L1 command (e.g., DCI)/L2 command (e.g., MAC CE) indicating activation of/applying the first cell DRX pattern for/to the first cell. The wireless device may flush one or more HARQ buffers associated with one or more HARQ processes (e.g., one or more uplink HARQ processes) of the first cell. The wireless device may flush the one or more HARQ buffers in response to/based on transitioning of the first cell to a cell DRX state (e.g., transitioning from a normal/non-cell DRX state to the cell DRX state) based on the first cell DRX pattern and/or in response to activation of/applying the first cell DRX pattern for/to the first cell. In an example, the wireless device may flush the one or more HARQ buffers in response to/based on receiving the configuration parameters (e.g., one or more messages (e.g., one or more RRC messages) comprising the configuration parameters) of the first cell DRX pattern. In an example, the wireless device may flush the one or more HARQ buffers in response to/based on receiving a L1 command (e.g., DCI)/L2 command (e.g., MAC CE) indicating activation of/applying the first cell DRX pattern for/to the first cell. In an example, the one or more HARQ processes (e.g., the one or more uplink HARQ processes) of the first cell that are flushed may be the HARQ processes (e.g., all of the HARQ processes) configured for the first cell. In an example, the one or more HARQ processes (e.g., the one or more uplink HARQ processes) of the first cell that are flushed may be a subset of the HARQ processes configured for the first cell. The subset of the HARQ processes that are flushed may be the HARQ processes configured for the first cell except (e.g., excluding) the HARQ processes configured for one or more configured grants/configured grant configurations.

In an example, the flushing the one or more HARQ buffers may be based on one or more conditions. The one or more conditions may be based on one or more parameters associated with the first cell DRX pattern. The one or more parameters may include a cell DRX periodicity associated with the first cell DRX pattern and/or a cell DRX duration (e.g., On duration) associated with the first cell DRX pattern. For example, the one or more conditions may include the cell DRX duration (e.g., the On duration) being larger than a threshold (e.g., a preconfigured threshold or a configurable threshold determined based on a received configuration parameter). For example, the one or more conditions may include the cell DRX periodicity being larger than a threshold (e.g., a preconfigured threshold or a configurable threshold determined based on a received configuration parameter).

In an example, the wireless device may flush (e.g., may determine to flush) the one or more HARQ processes based on a value of a parameter (e.g., a configuration parameter), for example, based on the parameter/configuration parameter having a first value. In an example, the configuration parameter of the one or more cell DTX patterns and/or cell DRX patterns (e.g., the first cell DRX pattern) may comprise the configuration parameter that the flushing/determining to flush is based on.

In an example, the wireless device may activate/apply the first cell DRX pattern for/to the first cell in response to/based on receiving a L1 command (e.g., DCI)/L2 command (e.g., MAC CE). The wireless device may flush (e.g., may determine to flush) the one or more HARQ processes based on the L1/L2 command (e.g., based on the value of a field of the L1/L2 command). The wireless device may flush (e.g., may determine to flush) the one or more HARQ processes based on the field of the L1/L2 command having a first value (e.g., a predetermined/preconfigured or a configurable value).

In an example, the number of downlink HARQ processes for/associated with a first cell while the first cell is in a cell DTX state may be a first number. The number of downlink HARQ processes for/associated with the first cell while the first cell is not in the cell DTX state (e.g., is in a normal/non-cell DTX state) may be a second number (e.g., a second number different from the first number). In an example, the second number may be smaller than the first number. In an example, the second number may be one. In an example, the downlink HARQ process(es) used during the cell DTX state may be used for/associated with SPS grant(s)/configuration(s).

In an example, the number of uplink HARQ processes for/associated with a first cell while the first cell is in a cell DRX state may be a first number. The number of uplink HARQ processes for/associated with the first cell while the first cell is not in the cell DRX state (e.g., is in a normal/non-cell DRX state) may be a second number (e.g., a second number different from the first number). In an example, the second number may be smaller than the first number. In an example, the second number may be one. In an example, the uplink HARQ process(es) used during the cell DTX state may be used for/associated with configured grant(s)/configuration(s).

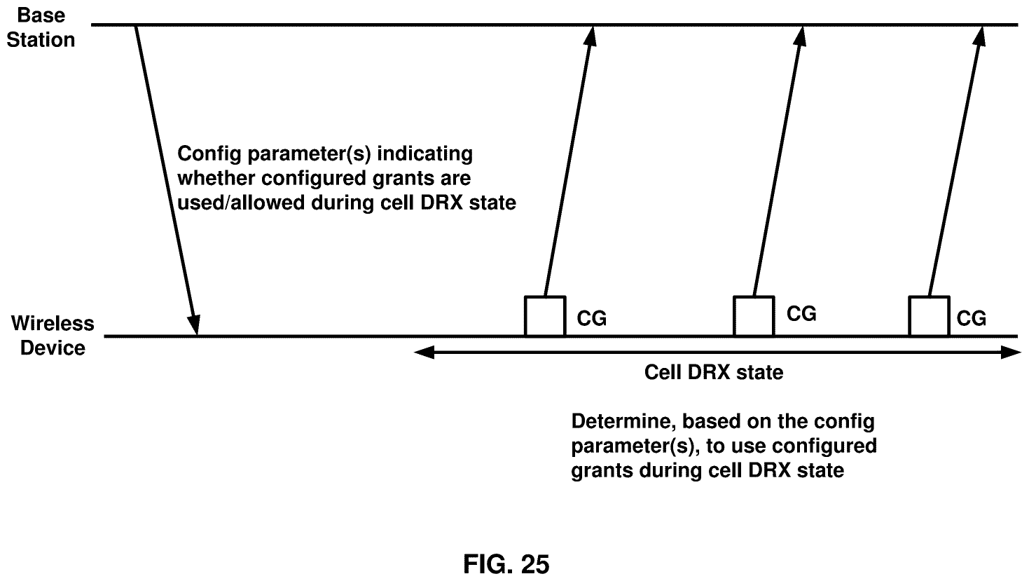

In an example as shown in FIG. 25, configured grants associated with one or more configured grant configurations configured for a first cell may be usable/allowed while the first cell is in a cell DRX state (e.g., as determined based on a cell DRX pattern applied to activated for the first cell). For example, the wireless device may receive a first configuration parameter with a value indicating whether configured grants associated with a first configured grant configuration, configured for the first cell, are usable/allowed while the first cell is in the cell DRX state. For example, a first value (e.g., ‘true’) of the first configuration parameter may indicate that the configured grants associated with the first configured grant configuration are allowed/usable while the first cell is in the cell DRX state and a second value of the first configuration parameter may indicate that the configured grants associated with the first configured grant configuration are not allowed/usable while the first cell is in the cell DRX state. The wireless device may determine based on the first configuration parameter (e.g., based on the value of the configuration parameter) whether configured grants associated with the first configured grant configuration are allowed/usable or are not allowed/usable while the first cell is in the cell DRX state. In an example, the configuration parameters of the first configured grant configuration may comprise the first configuration parameter.

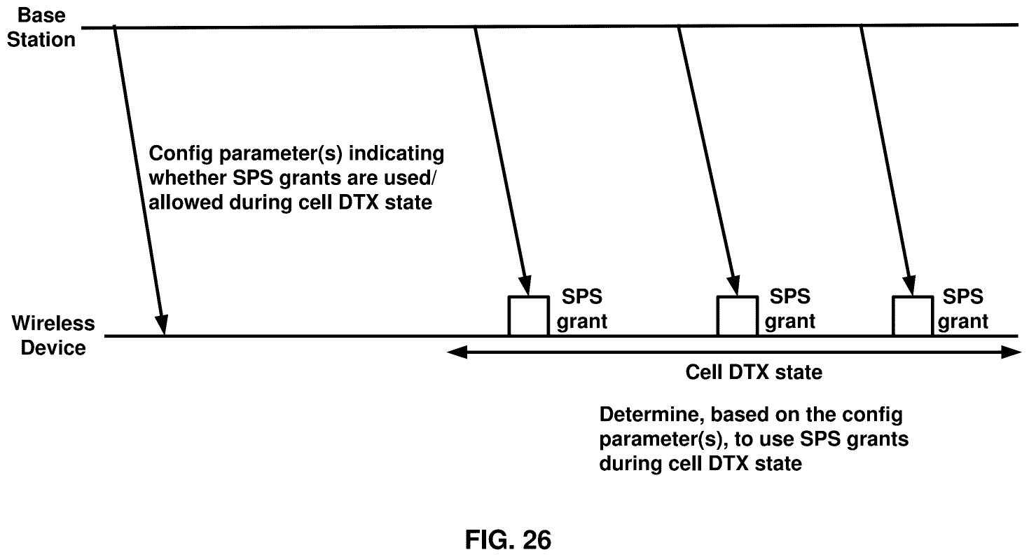

In an example as shown in FIG. 26, SPS grants associated with one or more SPS configurations configured for a first cell may be usable/allowed while the first cell is in a cell DTX state (e.g., as determined based on a cell DTX pattern applied to/activated for the first cell). For example, the wireless device may receive a first configuration parameter with a value indicating whether SPS grants associated with a first SPS configuration, configured for the first cell, are usable/allowed while the first cell is in the cell DTX state. For example, a first value (e.g., ‘true’) of the first configuration parameter may indicate that the SPS grants associated with the first SPS configuration are allowed/usable while the first cell is in the cell DTX state and a second value of the first configuration parameter may indicate that the SPS grants associated with the first SPS configuration are not allowed/usable while the first cell is in the cell DTX state. The wireless device may determine based on the first configuration parameter (e.g., based on the value of the first configuration parameter) whether SPS grants associated with the first SPS configuration are allowed/usable or are not allowed/usable while the first cell is in the cell DTX state. In an example, the first configuration parameters of the first SPS configuration may comprise the first configuration parameter.

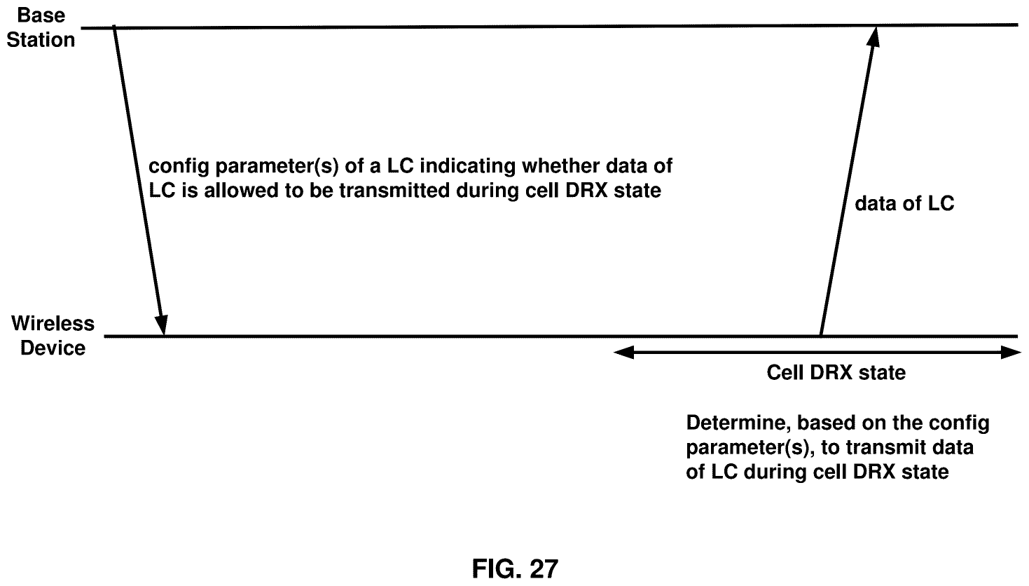

In an example as shown in FIG. 27, the wireless device may receive logical channel configuration parameters of a logical channels. The logical channel configuration parameters may comprise at least one parameter indicating whether data of the logical channel is allowed to be transmitted via/mapped to an uplink grant of a cell (e.g., via a configured grant of the cell and/or via a dynamic grant of the cell) while the cell is in a cell DRX state. The wireless device may determine, based on the value of the at least parameter, whether data of the logical channel is allowed to be transmitted via/mapped to an uplink grant of the cell while the cell is in a cell DRX state. For example, a first value (e.g., value of ‘true’) of the at least one parameter may indicate that the data of the logical channel is allowed to be transmitted via/mapped to the uplink grant of the cell while the cell is in the cell DRX state and a second value of the at least one parameter may indicate that the data of the logical channel is not allowed to be transmitted via/mapped to the uplink grant of the cell while the cell is in the cell DRX state.

In an example, one or more downlink grants (e.g., one or more dynamic grants and/or one or more configured grants) may be received/configured and may indicate resource allocation for scheduled reception of one or more downlink TBs via one or more cells. The scheduled reception of the one or more downlink TBs may be while the one or more cells are in cell DTX state, e.g., as determined based on one or more cell DTX patterns configured/activated for the one or more cells. In an example, the one or more downlink grants, for the scheduled reception of the one or more downlink TBs during the cell DTX state, may comprise SPS grants associated with one or more SPS configurations configured for the one or more cells and the one or more scheduled downlink TBs may comprise scheduled SPS TBs. In an example, the one or more downlink grants may comprise dynamic downlink grants received based on one or more downlink scheduling DCIs indicating resource allocation for downlink reception via the one or more cells while the one or more cells are in cell DTX state. In an example, based on the one or more downlink TBs being scheduled for reception during the cell DTX state, the wireless device may not receive (e.g., may skip reception of) the one or more scheduled downlink TBs.

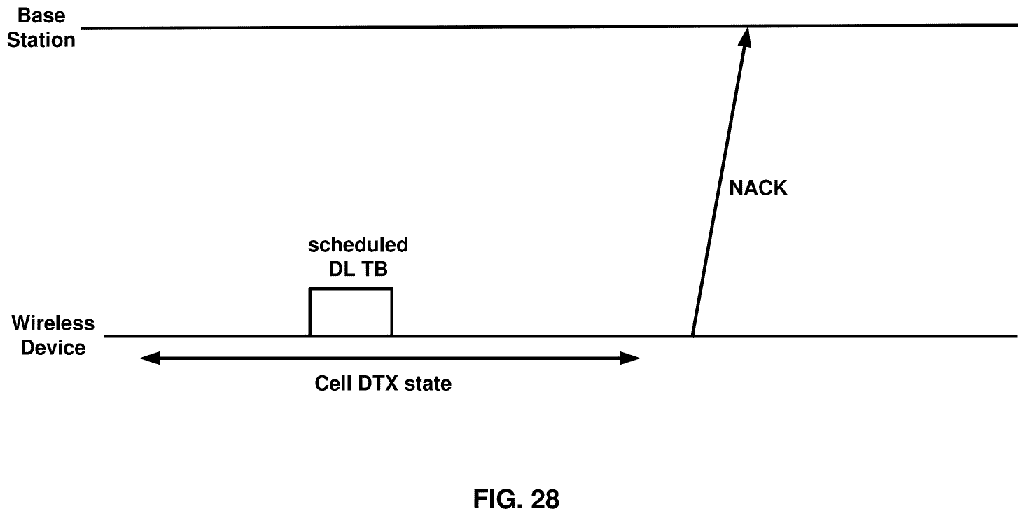

In an example as shown in FIG. 28, the wireless device may report negative acknowledgement(s) (NACK(s)) for HARQ feedback(s) associated with the one or more scheduled downlink TBs. In an example, the wireless device may report NACK(s) for HARQ feedback(s) associated with the one or more downlink TBs, based on the one or more downlink TBs being scheduled (e.g., being scheduled and not received) during the cell DTX state. The wireless device may construct/generate a HARQ feedback codebook comprising a plurality of HARQ feedbacks, wherein one or more HARQ feedbacks, within the HARQ feedback codebook, may be associated with the one or more scheduled downlink TBs. The wireless device may include NACK(s) for the one or more HARQ feedbacks associated with the one or more downlink TBs and may transmit/send the HARQ feedback codebook via an uplink channel (e.g., via PUCCH or PUSCH) to a base station.

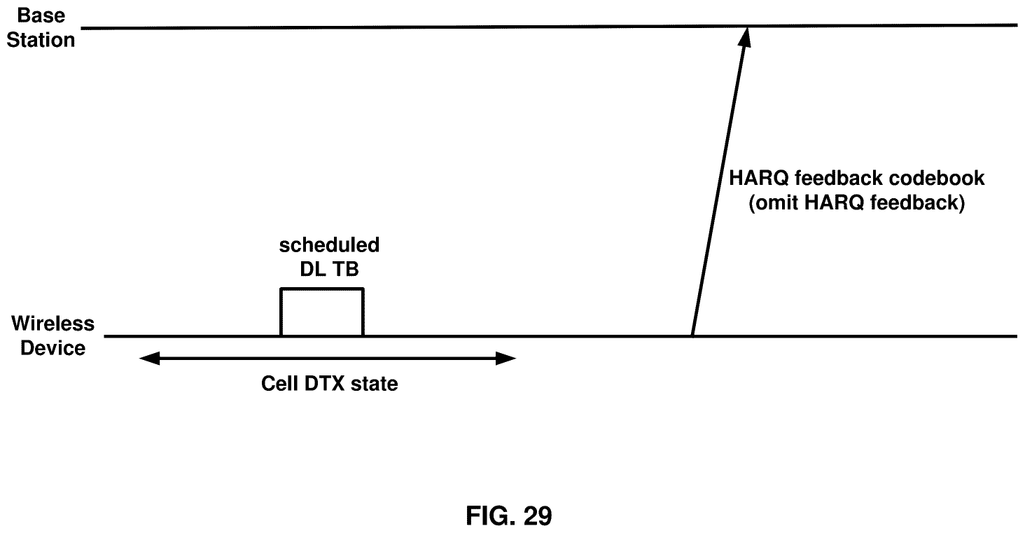

In an example as shown in FIG. 29, the wireless device may omit HARQ feedback(s) associated with the one or more scheduled downlink TBs. In an example, the wireless device may omit the HARQ feedback(s) associated with the one or more downlink TBs, based on the one or more downlink TBs being scheduled (e.g., being scheduled and not received) during the cell DTX state. The wireless device may construct/generate a HARQ feedback codebook comprising a plurality of HARQ feedbacks. The wireless device may omit the one or more HARQ feedbacks associated with the one or more downlink TBs and may transmit/send the HARQ feedback codebook via an uplink channel (e.g., via PUCCH or PUSCH) to a base station.

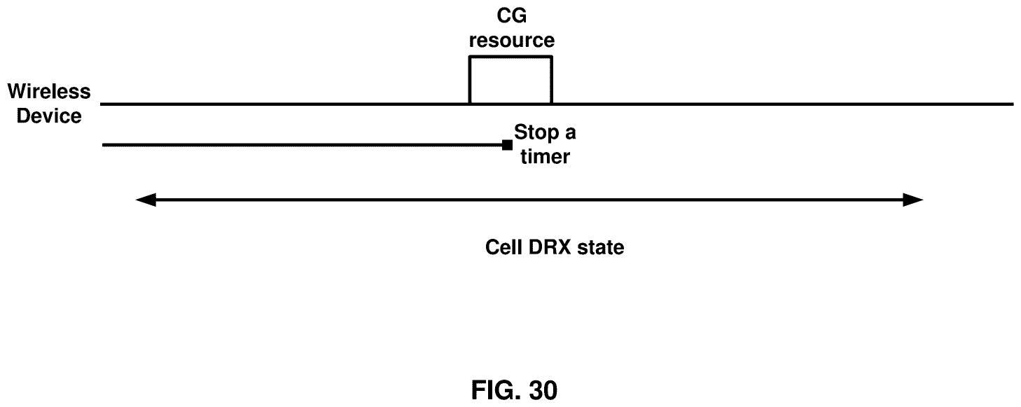

In an example as shown in FIG. 30, the wireless device may receive configured grant configuration parameters of a configured grant configuration for a cell. The configured grant configuration parameters may indicate one or more HARQ process numbers associated with the configured grant configuration. The wireless device may determine a plurality of configured grants based on the configured grant configuration parameters. The wireless device may further receive cell DRX configuration parameters of a cell DRX pattern for the cell. The wireless device may determine, based on the cell DRX configuration parameters and/or based on the cell DRX pattern, that a first configured grant, in the plurality of configured grants, is configured while the cell is in a cell DRX state. The first configured grant, configured while the cell is in the cell DRX state, may be associated with a first HARQ process number in the one or more HARQ process numbers associated with the configure grant configuration. The first HARQ process number may be associated with a first timer (e.g., a configured grant timer, a configured grant retransmission timer, etc.). The wireless device may stop the first timer associated with the first HARQ process number. In an example, the wireless device may stop the first timer based on the first configured grant being configured while the cell is in the cell DRX state.

In an example, in response to transitioning to a cell DTX state and/or receiving a command/message indicating transitioning to the cell DTX state, the wireless device may flush HARQ buffers for one or more UL HARQ processes (e.g., all of the configured UL HARQ processes or a subset of configured UL HARQ processes) associated with the cell that is in cell DTX state (e.g., indicated to transition to cell DTX state). In an example, the subset of UL HARQ processes may be UL HARQ processes excluding one or more HARQ processes associated with one or more configured grant configurations (e.g., if configured grants can be used during cell DTX state). In an example, the flushing may be in response to receiving an RRC configuration parameter (e.g., a cell DRX/DTX configuration parameter in one or more cell DRX/DTX configuration parameters) having a first value and/or indicating the flushing. In an example, the flushing may be based on the cell DTX pattern, e.g., the cell DTX periodicity or duration (e.g., based on the periodicity/duration being longer than a threshold). In an example, the flushing may be based on a L1/L2 command (e.g., DCI or MAC CE) indicating activation of the cell DTX pattern, e.g., based on a value of a field of the L1/L2 command.

In an example, in response to transitioning to cell DRX state and/or receiving a command/message indicating transitioning to cell DRX, the wireless device may flush HARQ buffers for one or more DL HARQ processes (e.g., all of the configured DL HARQ processes or a subset of the configured DL HARQ processes) associated with the cell that is in cell DRX state (e.g., indicated to transition to cell DRX state). In an example, the subset of DL HARQ processes may be DL HARQ processes excluding one or more HARQ processes associated with one or more SPS configurations (e.g., if SPS can be during cell DRX state). In an example, the flushing may be in response to receiving an RRC configuration parameter (e.g., a cell DTX/DRX configuration parameter in one or more cell DTX/DRX configuration parameters) having a first value and/or indicating the flushing. In an example, the flushing may be based on the DRX pattern, e.g., the DRX periodicity or duration (e.g., based on the periodicity/duration being longer than a threshold). In an example, the flushing may be based on an L1/L2 command (e.g., DCI or MAC CE) indicating activation of the DRX pattern, e.g., based on a value of a field of the L1/L2 command.

In an example, the number of HARQ processes in DL and/or UL of a cell while the cell is in the cell DTX/DRX state may be limited (e.g., limited to a maximum of n HARQ processes, e.g., n=1). For example, only HARQ process(es) for configured grant/semi-persistent scheduling (SPS) may be used while the cell is cell DTX/DRX state.

In an example, at least one configuration parameter (e.g., at least one configuration parameter of a configured grant configuration) may indicate whether configured grants in general or configured grants that are associated with a configured grant configuration is allowed/used during cell DTX state. For example, a first value (e.g., ‘true’) of the at least one configuration parameter may indicate configured grants in general or configured grants that are associated with a specific configured grant configuration is allowed/used during cell DTX state.

In an example, at least one configuration parameter (e.g., at least one configuration parameter of a SPS configuration) may indicate whether SPS grants in general or SPS grants that are associated with a specific SPS configuration is allowed/used during cell DRX state. For example, a first value (e.g., ‘true’) of the at least one configuration parameter may indicate that SPS grants in general or SPS grants that are associated with a specific SPS configuration is allowed/used during cell DRX state.

In an example, at least one configuration parameter of a logical channel may indicate whether data of the logical channel is allowed to be transmitted (e.g., allowed to be transmitted via a configured grant) during the cell DTX state. For example, a first value (e.g., ‘true’) of the at least one configuration parameter may indicate that the data of the logical channel is allowed to be transmitted (e.g., allowed to be transmitted via a configured grant) during cell DTX state.

In an example, for one or more DL TBs (e.g., one or more SPS DL TBs or one or more dynamically scheduled DL TBs) that are scheduled on a cell while the cell is in cell DRX state, the wireless device may report corresponding HARQ feedbacks as NACK in a HARQ feedback codebook.

In an example, for one or more DL TBs (e.g., one or more SPS DL TBs or one or more dynamically scheduled DL TBs) that are scheduled on a cell while the cell is in cell DRX state, the wireless device may omit/not report corresponding HARQ feedbacks in a HARQ feedback codebook.

In an example, for a configured grant scheduled on a cell while the cell is in DTX state, the wireless device may stop the configuredGrantTimer for the corresponding HARQ process and/or may stop the cg-Retransmission timer for the corresponding HARQ process.

In an example, the wireless device may receive configuration parameters of a cell. The cell may operate in an unlicensed spectrum. The wireless device may further receive configuration parameters of one or more configured grant configurations for the cell. In an example, based on the cell being configured/activated with a configured grant configuration, the cell may operate in a non-cell DTX state (e.g., may not operate in a cell DTX state). The wireless device may receive downlink control information comprising downlink feedback information (DFI) (e.g., HARQ feedback) associated with the uplink transport blocks transmitted using the configured grants. In an example, based on the cell being configured/activated with the configured grant configuration, the downlink control information comprising downlink feedback information (DFI) (e.g., HARQ feedback) associated with the uplink transport blocks transmitted using the configured grants may be received by the wireless device while the cell is in a cell DTX state.

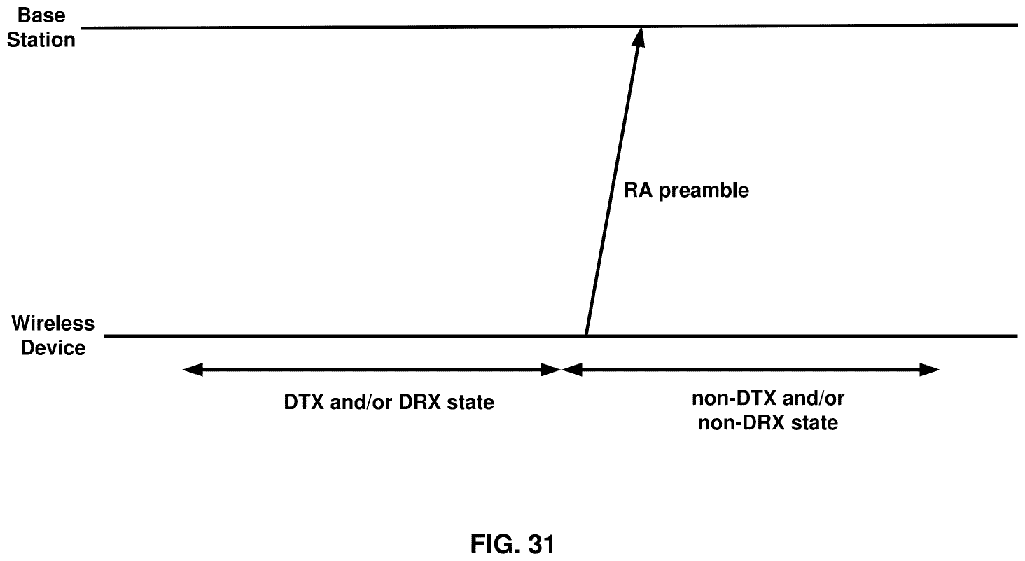

In an example as shown in FIG. 31, the wireless device may transition from a cell DTX state to a non-cell DTX state and/or may transition from a cell DRX state to a non-cell DRX state. The wireless device may transition from the cell DTX state to the non-cell DTX state and/or may transition from the cell DRX state to the non-cell DRX state in response to deactivation of the first cell DTX pattern and/or the first cell DRX pattern (e.g., based on releasing the configuration parameters of the cell DTX pattern and/or the cell DRX pattern or based on receiving a L1 command (e.g., DCI)/L2 command (e.g., MAC CE) indicating deactivation of the first cell DTX pattern and/or first cell DRX pattern). In response to the transitioning to the non-cell DTX state and/or transitioning to the non-cell DRX state, the wireless device may trigger a random access process. In response to the transitioning to the non-cell DTX state and/or transitioning to the non-cell DRX state, the wireless device may initiate a random access process and may transmit a random access preamble.

The wireless device may trigger/initiate the random access process and/or may transmit the random access preamble for obtaining a timing advance value used in determination of uplink timings for uplink transmissions after transitioning to the non-cell DTX state and/or to the non-cell DRX state. In response to the initiation of the random access process/transmission of the random access preamble, the wireless device may receive the timing advance value (e.g., may receive a random access response (RAR) message comprising the timing advance value). The wireless device may perform an uplink transmission after transitioning to the non-cell DTX state and/or to the non-cell DRX state based on the timing advance value.

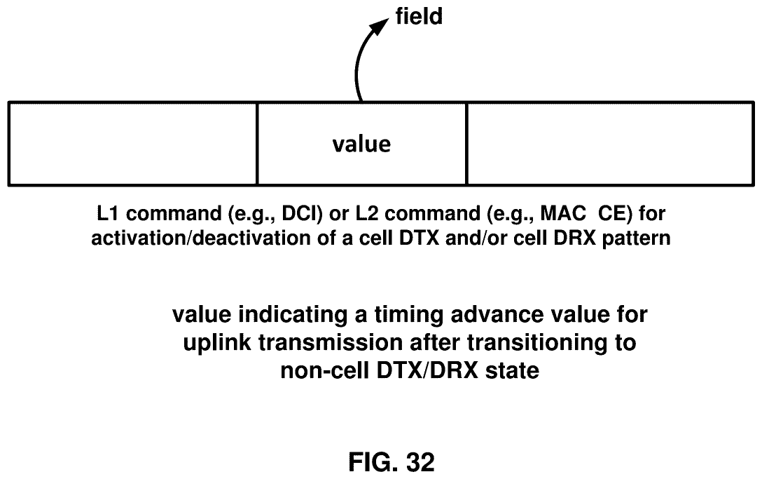

In an example, the wireless device may deactivate the first cell DTX pattern and/or the first cell DRX pattern in response to/based on receiving a L1 command (e.g., DCI)/L2 command (e.g., MAC CE) indicating deactivation of the first cell DTX pattern and/or deactivation of the first cell DRX pattern. As shown in FIG. 32, the L1 command/L2 command may indicate (e.g., may comprise a field with a value indicating) a timing advance value to be used for uplink transmissions in response to/after transitioning from the cell DTX state and/or the cell DRX state to the non-cell DTX state and/or to the non-cell DRX state. The wireless device may perform an uplink transmission after transitioning to the non-cell DTX state and/or to the non-cell DRX state based on the timing advance value.

In an example, the wireless device may determine/obtain a timing advance value for determining uplink timings associated with uplink transmissions after transitioning to the non-cell DTX state and/or to the non-cell DRX state either based on the L1 command (e.g., DCI)/L2 command (e.g., MAC CE) indicating deactivation of a cell DTX pattern and/or cell DRX pattern or may determine/obtain the timing advance value based on performing/initiating a random access process. The determination/obtaining of the timing advance value may be based on whether the cell DTX pattern and/or the cell DRX pattern are activated/deactivated using RRC messages or activated/deactivated using a L1/L2 command. For example, in response to the activation/deactivation of a cell DTX pattern and/or the cell DRX pattern being based on RRC message(s) (e.g., activation when the RRC message(s) indicate configuration of the cell DTX pattern and/or cell DRX pattern and deactivation when the RRC message(s) indicate releasing the configuration of the cell DTX pattern and/or the cell DRX pattern), the timing advance value may be obtained/determined by initiating a random access process/transmitting a random access preamble. In response to the activation/deactivation of the cell DTX pattern and/or the cell pattern being based on a L1 command (e.g., DCI)/L2 command (e.g., MAC CE), the timing advance value may be obtained/determined based on a L1 command/L2 command that indicates deactivation of the cell DTX pattern and/or cell DRX pattern and thereby indicating transitioning to the non-cell DTX state and/or the non-cell DRX state. The wireless device may determine whether the activation/deactivation of a cell DTX pattern and/or cell DRX pattern is based on/in response to receiving the RRC message(s) or is based on/in response to receiving the L1/L2 command based on a configuration parameter in the cell DTX pattern and/or cell DRX pattern configuration parameters.

In an example, the wireless device may receive configuration parameters of a plurality of cells that are grouped into one or more timing advance groups (TAGs). In an example, the plurality of cell may be grouped into a primary TAG (pTAG). In an example, the plurality of cells may comprise one or more first cells grouped into a pTAG and one or more second cells grouped into a secondary TAG (sTAG). The cell(s) within a TAG (e.g., the pTAG or the sTAG) may be associated with the same uplink timing/timing advance. A cell within a TAG (e.g., the pTAG or the sTAG) may be a reference cell. The wireless device may follow the frame timing change of the reference cell in connected state. The uplink frame transmission may take place (N_{TA}+N_{TA offset})×T_{c} before the reception of the first detected path (in time) of the corresponding downlink frame from the reference cell.

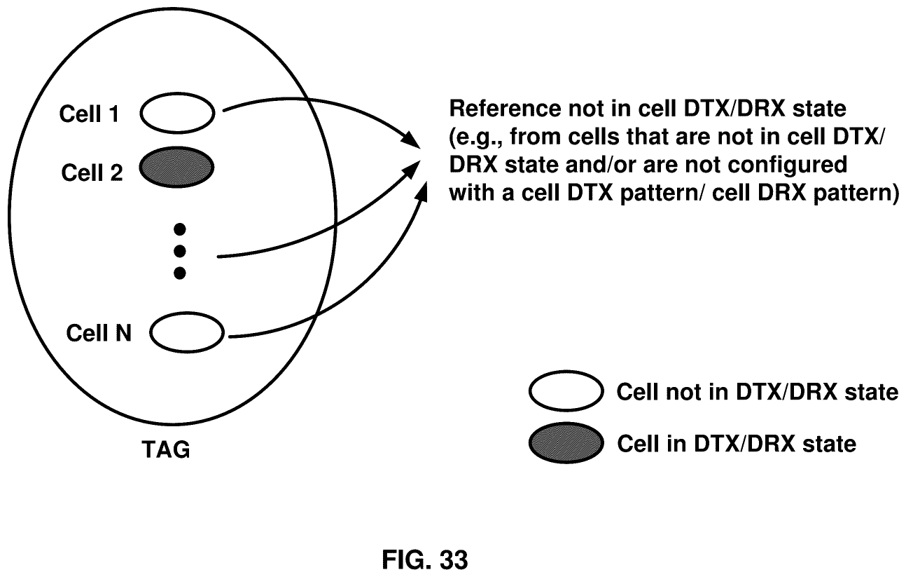

In an example as shown in FIG. 33, the plurality of cells within a TAG (e.g., the pTAG or sTAG) may comprise one or more cells that may be configured with one or more cell DTX patterns and/or cell DRX patterns. The wireless device may receive configuration parameters indicating the one or more cell DTX patterns and/or the cell DRX patterns for the one or more cells. The one or more cell DTX patterns and/or cell DRX patterns may be activated/applied in response to receiving the configuration parameters of one or more cell DTX patterns and/or cell DRX patterns (e.g., one or more messages (e.g., one or more RRC messages) comprising the configuration parameters of one or more cell DTX patterns and/or cell DRX patterns) or may be activated/applied in response to receiving the configuration parameters of one or more cell DTX patterns and/or cell DRX patterns (e.g., the one or more messages) and further receiving a L1/L2 command indicating activation of the one or more cell DTX patterns and/or cell DRX patterns. In an example, for serving cell(s) in sTAG, the wireless device may use an activated SCells as the reference cell for deriving the UE transmit timing for the cells in the sTAG. The wireless device may determine/select/use the reference cell within the TAG as one of the cell(s) in the TAG that is not in a cell DTX state and/or cell DRX state (e.g., for which a cell DTX pattern and/or cell DRX pattern is not activated) or as one of the cell(s) in the TAG that is not configured with a cell DTX pattern or a cell DTX pattern.

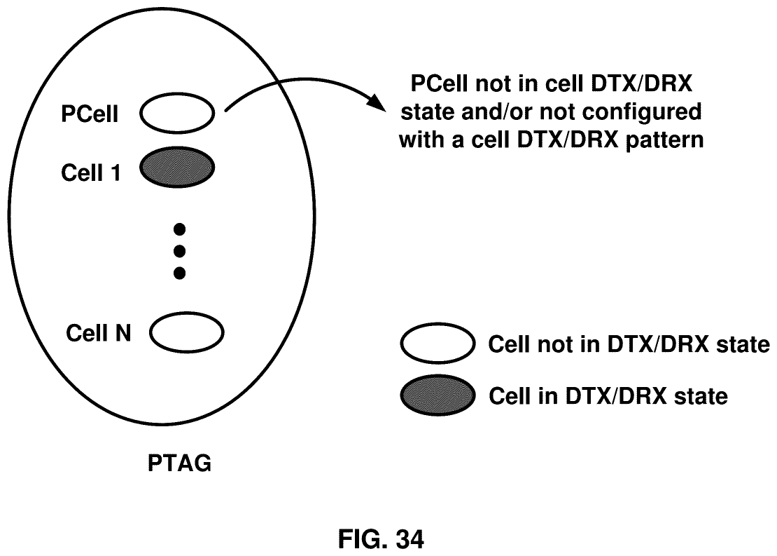

In an example as shown in FIG. 34, for serving cell(s) in pTAG, the wireless device may determine/select/use the SpCell (e.g., primary cell (PCell) or primary secondary cell (PSCell)) as the reference cell for deriving the UE transmit timing for cells in the pTAG. The SpCell may not be configured and/or activated with a cell DTX pattern and/or cell DRX pattern.

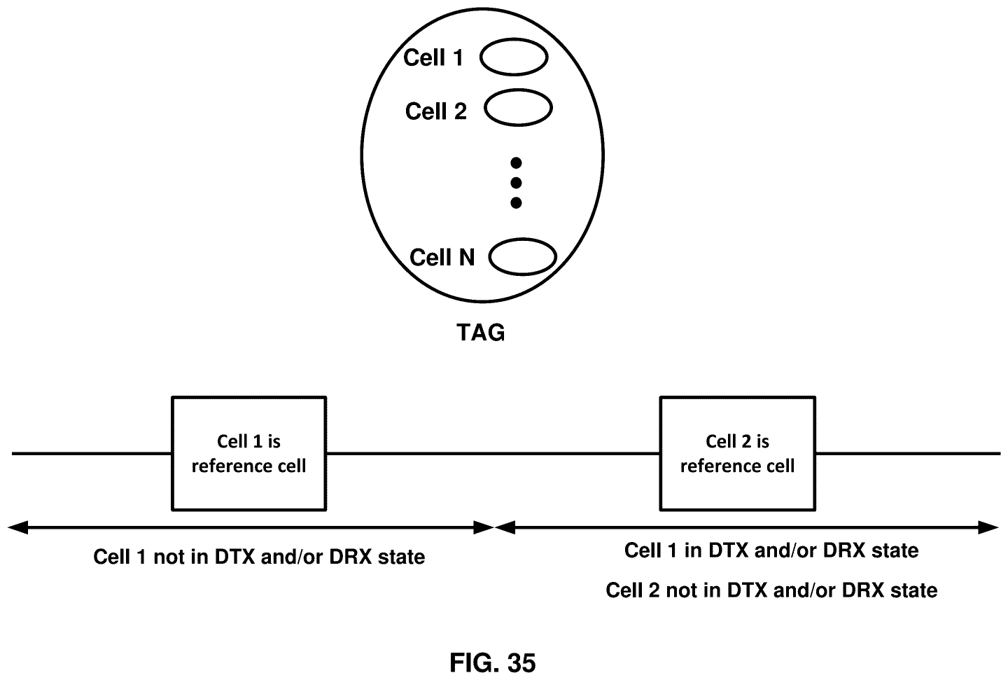

In an example as shown in FIG. 35, a reference cell within the TAG (e.g., the sTAG) may be determined/selected based on the cell DTX and/or cell DRX state status of the cells within the TAG. For example, the TAG may include a plurality of cells comprising a first cell (e.g., Cell 1) and a second cell (e.g., Cell 2). During a first time duration/window, the first cell may not be in a cell DTX state and/or cell DRX state (e.g., may be in a non-cell DTX state and/or non-cell DRX state); and the first cell may be the reference cell (e.g., the wireless device may determine the first cell as the reference cell) in the TAG during the first time duration/window. During a second time duration/window, the first cell may be in a cell DTX state and/or cell DRX state and the second cell may not be in the cell DTX state and/or cell DRX state (e.g., may be in a non-cell DTX state and/or non-cell DRX state); and the second cell may be the reference cell (e.g., the wireless device may determine the second cell as the reference cell) in the TAG during the second time duration/window.

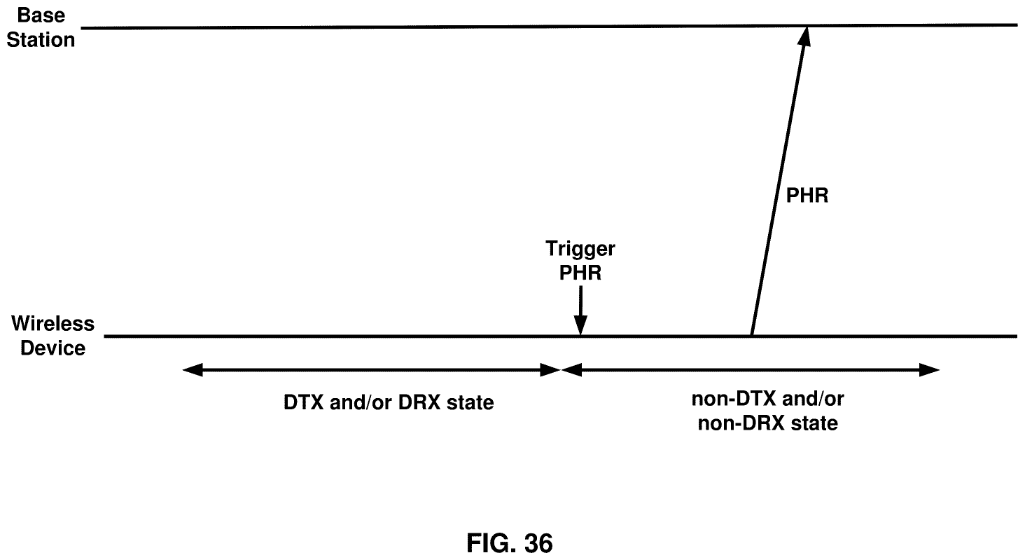

In an example as shown in FIG. 36, the wireless device may transition from a cell DTX state to a non-cell DTX state and/or may transition from a cell DRX state to a non-cell DRX state. The wireless device may transition from the cell DTX state to the non-cell DTX state and/or may transition from the cell DRX state to the non-cell DRX state in response to deactivation of the first cell DTX pattern and/or the first cell DRX pattern (e.g., based on releasing the configuration parameters of the cell DTX pattern and/or the cell DRX pattern or based on receiving a L1 command (e.g., DCI)/L2 command (e.g., MAC CE) indicating deactivation of the first cell DTX pattern and/or first cell DRX pattern). In response to the transitioning to the non-cell DTX state and/or transitioning to the non-cell DRX state, the wireless device may trigger a power headroom (PHR). The wireless device may transmit a PHR MAC CE in response to the transitioning.

In an example, the wireless device may receive configuration parameters for one or more reference signals (RSs) for determining/estimating pathloss. The configuration parameters may comprise first configuration parameters, for one or more first RSs of a first cell for determining/estimating first pathloss estimates associated with a first cell, and second configuration parameters for one or more second RSs of a second cell for determining/estimating second pathloss estimates associated with a second cell.

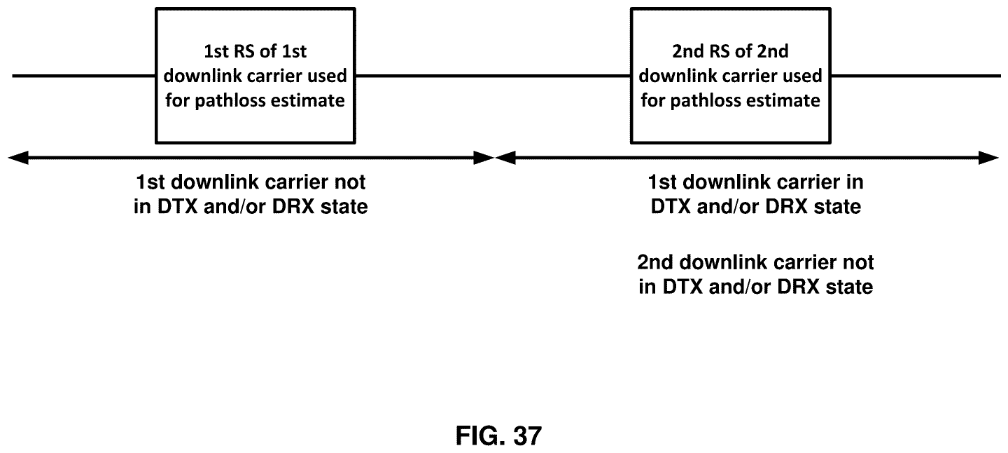

In an example as shown in FIG. 37, the wireless device may receive configuration parameters of a plurality of cells comprising a first cell and a second cell. The configuration parameters may comprise first configuration parameters, for one or more first RSs of a first cell for determining/estimating first pathloss estimates associated with a first cell, and second configuration parameters for one or more second RSs of a second cell for determining/estimating second pathloss estimates associated with a second cell. The configuration parameters may comprise cell DTX and/or cell DRX parameters of one or more cell DTX patterns and/or cell DRX patterns of one or more cells of the plurality of cells. The one or more cell DTX patterns and/or cell DRX patterns may be activated/applied in response to receiving the configuration parameters of one or more cell DTX patterns and/or cell DRX patterns (e.g., in response to receiving one or more messages (e.g., one or more RRC messages) comprising the configuration parameters of one or more cell DTX patterns and/or cell DRX patterns) or may be activated/applied in response to receiving the configuration parameters of one or more cell DTX patterns and/or cell DRX patterns (e.g., the one or more messages) and further receiving a L1/L2 command indicating activation of the one or more cell DTX patterns and/or cell DRX patterns. During a first time duration/window, the first cell may not be in a cell DTX state and/or cell DRX state (e.g., may be in a non-cell DTX state and/or non-cell DRX state). During a second time duration/window, the first cell may be in a cell DTX state and/or cell DRX state and the second cell may not be in the cell DTX state and/or cell DRX state (e.g., may be in a non-cell DTX state and/or non-cell DRX state). During the first time duration/window, the wireless device may determine/estimate pathloss estimates (e.g., pathloss estimates associated with the first cell) based on the one or more first RSs transmitted via the first cell. During the second time duration/window, the wireless device may determine/estimate pathloss estimates (e.g., pathloss estimates associated with the first cell) based on the one or more second RSs transmitted via the second cell. The wireless device may use a pathloss estimate in one or more processes such as a random access process or a PHR triggering and/or reporting process. For example, the wireless device may trigger a PHR when a phr-ProhibitTimer expires or has expired and the path loss has changed more than phr-Tx-PowerFactorChange dB for at least one RS used as pathloss reference for one activated Serving Cell of any MAC entity of which the active DL BWP is not dormant BWP since the last transmission of a PHR in this MAC entity when the MAC entity has UL resources for new transmission. For example, the wireless device may determine an uplink carrier (e.g., a normal uplink carrier or a supplementary uplink carrier) based on comparing the pathloss estimate with a threshold (e.g., separate thresholds for normal uplink carrier and supplementary uplink carrier).

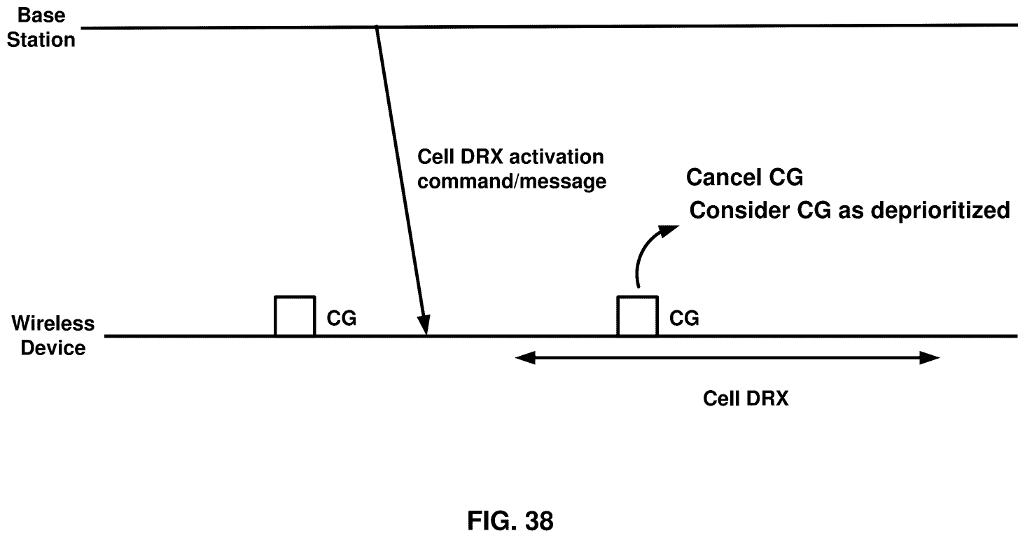

In an example as shown in FIG. 38, a wireless device may receive configuration parameters of one or more cells comprising a first cell. The configuration parameters may comprise configured grant configuration parameters of one or more configured grants for the first cell. The wireless device may activate a plurality of configured grants for the first cell (e.g., in response to receiving the configured grant configuration parameters or in response to receiving the configured grant configuration parameters and further a DCI indicating activation of a configured grant configuration). The wireless device may further receive configuration parameters of a cell DRX pattern and/or cell DTX pattern. The wireless device may determine that the cell DRX pattern is activated (e.g., in response to receiving configuration parameters of the cell DRX pattern and/or in response to receiving an L1 (e.g., DCI)/L2 (e.g., MAC CE) command indicating activation of a cell DRX pattern for the first cell) for the first cell and may further determine, based on the cell DRX pattern, that the first cell is in a cell DRX state during a first time duration/window. The plurality of configured grants activated for the first cell may comprise a first configured grant configured during the first time duration/window. The wireless device may cancel/ignore the first configured grant. The wireless device may cancel/ignore the first configured grant based on the first configured grant being configured during the first time window/duration. The wireless device may consider the first configured grant as deprioritized. If this deprioritized uplink grant is configured with autonomousTx, the configuredGrantTimer for the corresponding HARQ process of this deprioritized uplink grant may be stopped if it is running. If this deprioritized uplink grant is configured with autonomousTx, the cg-RetransmissionTimer for the corresponding HARQ process of this deprioritized uplink grant may be stopped if it is running. In an example, based on the first configured grant being considered as deprioritized based on being configured during the first time window/duration, the first configured (e.g., the data/TB generated for the first configured grant) may be prioritized for transmission via a subsequent configured grant.

In an example, a wireless device may receive configuration parameters of one or more cells comprising a first cell. The first cell may be a PUCCH cell and may be configured with PUCCH/SR resources (e.g., for SR transmission). For example, the PUCCH cell may be a primary cell (PCell) or a PUCCH secondary cell (PUCCH SCell). The wireless device may determine a triggering condition for buffer status report (BSR) reporting. The wireless device may determine that uplink resources are not available for transmission of the BSR MAC CE. The wireless device may trigger a scheduling request (SR) or may trigger a random access process depending on whether the first cell (e.g., the PUCCH cell configured with PUCCH/SR resources (e.g., the PCell and/or the PUCCH SCell)) is in a cell DRX state or in a non-cell DRX state (e.g., is not in the cell DRX state). In response to the PUCCH cell (e.g., the PCell and/or the PUCCH SCell) being in a cell DRX state, the wireless device may trigger/initiate a random access process (e.g., without triggering/transmitting a SR). In response to the PUCCH cell being in a non-cell DRX state (e.g., not being in a cell DRX state), the wireless device may trigger/transmit a SR.

In an example, a wireless device may receive configuration parameters of one or more cells comprising a first cell. The first cell may be a PUCCH cell and may be configured with PUCCH/SR resources for SR transmission. The wireless device may further receive cell DTX/DRX configuration parameters of one or more cell DTX and/or cell DRX patterns for the first cell. The first cell, configured for the wireless device, may transition from a non-cell DTX state to a cell DTX state and/or may transition from a non-cell DRX state to a cell DRX state. The first cell may transition from the non-cell DTX state to the cell DTX state and/or may transition from the non-cell DRX state to the cell DRX state in response to activation of the first cell DTX pattern and/or the first cell DRX pattern (e.g., based on/in response to receiving, by the wireless device, the configuration parameters of the cell DTX pattern and/or the cell DRX pattern and/or based on/in response to receiving, by the wireless device, a L1 command (e.g., DCI)/L2 command (e.g., MAC CE) indicating activation of the first cell DTX pattern and/or first cell DRX pattern). In an example, in response to the first cell transitioning to the cell DTX state and/or transitioning to the cell DRX state (e.g., in response to receiving, by the wireless device, the L1/L2 command and/or RRC message(s) comprising the DTX/DRX configuration parameters), the wireless device may cancel one or more pending SRs. In an example, in response to the first cell transitioning to the cell DTX state and/or transitioning to the cell DRX state (e.g., in response to receiving the L1/L2 command and/or RRC message(s) comprising the DTX/DRX configuration parameters), the wireless device may cancel one or more pending SRs and may stop one or more corresponding SR prohibit timers.

In an example, the wireless device may receive configuration parameters of a plurality of cells comprising a first cell. The first cell may be a secondary cell. The configuration parameters may comprise a timer parameter indicating a cell deactivation timer value for the first cell. The configuration parameters may comprise cell DTX/DRX parameters of one or more cell DTX and/or cell DRX patterns, comprising a first cell DTX pattern and/or a first cell DRX pattern, of one or more cells comprising the first cell. The first cell, configured for the wireless device, may transition from a non-cell DTX state to a cell DTX state and/or may transition from a non-cell DRX state to a cell DRX state. The first cell, configured for the wireless device, may transition from the non-cell DTX state to the cell DTX state and/or may transition from the non-cell DRX state to the cell DRX state in response to activation of the first cell DTX pattern and/or the first cell DRX pattern (e.g., based on/in response to receiving, by the wireless device, the configuration parameters (e.g., RRC message(s) comprising the configuration parameters) of the cell DTX pattern and/or the cell DRX pattern and/or based on/in response to receiving, by the wireless device, a L1 command (e.g., DCI)/L2 command (e.g., MAC CE) indicating activation of the first cell DTX pattern and/or the first cell DRX pattern). In an example, in response to the transitioning of the first cell to the cell DTX state and/or transitioning of the first cell to the cell DRX state (e.g., in response to receiving the L1 command (e.g., DCI)/L2 command (e.g., MAC CE) and/or RRC message(s) comprising the DTX/DRX configuration parameters), the wireless device may start a deactivation timer of/associated with the first cell. The wireless device may deactivate the first cell in response to expiry of the deactivation timer.

In an example, a wireless device may receive one or more messages (e.g., one or more RRC messages) comprising configuration parameters of a first cell. the first cell may be a secondary cell. The one or more messages/the configuration parameters may comprise cell DTX/DRX configuration parameters of one or more cell DTX/DRX patterns for the first cell. The wireless device may receive an SCell activation/deactivation MAC CE indicating activation of the first cell. The wireless device may determine to activate a cell DTX and/or cell DRX pattern for the first cell (e.g., in response to receiving the SCell activation command and the SCell activation command indicating activation of the first cell). The wireless device may determine, based on the cell DTX pattern and/or the cell DRX pattern, that a first timing of an action associated with activation of the first cell is while the first cell is in a cell DTX state and/or a cell DRX state, e.g., overlaps with a duration that the first cell is in the cell DTX state and/or the cell DRX state. The wireless device may delay the action and may perform the action after the first cell transitions from the cell DTX state and/or the cell DRX state to the non-cell DTX state and/or the non-cell DRX state. Example actions associated with activation of the first cell may comprise one or more of: SRS transmissions on the first cell, CSI reporting for the first cell, PDCCH monitoring on the first cell, PDCCH monitoring for the first cell, and PUCCH transmissions on the first cell, if configured.

In an example embodiment, a wireless device may receive configuration parameters of one or more cell discontinuous transmission (DTX) patterns and/or cell discontinuous reception (DRX) patterns associated with one or more cell. The wireless device may activate or deactivate a first cell DTX pattern, in the one or more cell DTX patterns, and/or a first cell DRX pattern in the one or more cell DRX patterns.

In an example, the first cell DTX pattern and/or the first cell DRX pattern may be activated in response to receiving the configuration parameters (e.g., in response to receiving one or more messages (e.g., RRC messages) comprising the configuration parameters). In an example, first configuration parameters of the first cell DTX pattern and/or the first cell DRX pattern may comprise at least one configuration parameter indicating that the first cell DTX pattern and/or the first cell DRX pattern is activated in response to receiving the first configuration parameters, e.g., in response to receiving one or more messages (e.g., RRC messages) comprising the first configuration parameters. The first configuration parameters of the first cell DTX pattern and/or the first cell DRX pattern may comprise at least one configuration parameter indicating that the first cell DTX pattern and/or the first cell DRX pattern may be activated without receiving a L1 command/L2 command for/associated with activation of the first cell DTX pattern and/or the first cell DRX pattern. In an example, a first value of a first configuration parameter of the first configuration parameters of the first DTX pattern and/or the first DRX pattern may indicate activation of the first DTX pattern and/or the first DRX pattern in response to receiving the first configuration parameters (e.g., in response to receiving one or more messages (e.g., RRC messages) comprising the first configuration parameters). A second value of the first configuration parameter may indicate that the first DTX pattern and/or the first DRX pattern is(are) activated in response to receiving a L1 command (e.g., DCI)/L2 command (e.g., MAC CE) indicating activation of the first DTX pattern and/or the first DRX pattern.

In an example, the wireless device may receive a L1 command (e.g., a DCI) and/or a L2 command (e.g., a MAC CE) indicating activation or deactivation of the first cell DTX pattern and/or the first cell DRX patten. In an example, the L1 command/L2 command may indicate activation of the first cell DTX pattern and/or the first cell DRX patten. The first cell DTX pattern and/or the first cell DRX pattern may be activated in response to receiving the configuration parameters (e.g., in response to receiving one or more messages (e.g., RRC messages) comprising the configuration parameters) and receiving the L1 command/L2 command. In an example, the L1 command/L2 command may indicate deactivation of the first cell DTX pattern and/or the first cell DRX patten. The first cell DTX pattern and/or the first cell DRX pattern may be deactivated in response to receiving the L1 command/L2 command.

In an example, the L1 command may be a DCI. In an example, a format associated with the DCI may indicate that the DCI is for/associated with/usable in activation/deactivation of a cell DTX pattern and/or a cell DRX pattern for a cell (e.g., for a BWP of a cell and/or for an uplink carrier of the cell). The wireless device may determine that the DCI is for/associated with/usable in activation/deactivation of a cell DTX pattern and/or a cell DRX pattern for a cell based on the format associated with the DCI. In an example, an RNTI associated with the DCI may indicate that the DCI is for/associated with/usable in activation/deactivation of a DTX pattern and/or a DRX pattern for a cell (e.g., for a BWP of a cell and/or for an uplink carrier of the cell). The wireless device may determine that the DCI is for/associated with/usable in activation/deactivation of a cell DTX pattern and/or a cell DRX pattern for a cell based on the RNTI associated with the DCI. In an example, a value of a field of the DCI may indicate that the DCI is for/associated with/usable in activation/deactivation of a DTX pattern and/or a DRX pattern for a cell (e.g., for a BWP of a cell and/or for an uplink carrier of the cell). The wireless device may determine that the DCI is for/associated with/usable in activation/deactivation of a DTX pattern and/or a DRX pattern for a cell based on the value of the field of the DCI. In an example, the value may be pre-determined/preconfigured. In an example, a first value of the field may indicate that the DCI is for/associated with/usable in activation of a DTX pattern and/or a DRX pattern and a second value of the field may indicate that the DCI is for/associated with/usable in deactivation of a DTX pattern and/or a DRX pattern.

In an example, the DCI (the DTX/DRX activation/deactivation DCI) may be a scheduling DCI (e.g., an uplink scheduling DCI for scheduling/allocation of resources for an uplink transmission or a downlink scheduling DCI for scheduling/allocation of resources for an uplink transmission).

In an example, the DCI (the DTX/DRX activation/deactivation DCI) may comprise a field with a value indicating the activation/deactivation of the first DTX pattern and/or the first DRX pattern. In an example, each of the one or more cell DTX patterns and/or cell DRX patterns may be associated with an identifier (for example each DTX pattern may be associated with an identifier and each DRX pattern may be associated with an identifier or each pair of DTX pattern and DRX pattern may be associated with an identifier). The value of the field may indicate a first identifier associated with the first cell DTX pattern and/or the first cell DRX pattern. The wireless device may determine the first cell DTX pattern and/or the first cell DRX pattern based on the value of the field indicating the first identifier.

In an example, a starting timing (e.g., a starting slot) of the first DTX pattern and/or the first DRX patten (e.g., a starting timing/slot that the first DTX pattern and/or the first DRX pattern is applicable) may be based on a reception timing (e.g., a slot in which the DCI (the DTX/DRX activation/deactivation DCI) is received) and an offset (e.g., an offset in a first number of slots). In an example, the wireless device may receive a configuration parameter indicating the offset (e.g., indicating the first number of slots of the offset). In an example, the DCI (e.g., a value of a field of the DCI) may indicate the offset. In an example, the DCI (e.g., a value of a field of the DCI) may indicate one of a plurality of configured offsets. The wireless device may receive configuration parameters indicating the plurality of configured offsets.

In an example, the DCI (the DTX/DRX activation/deactivation DCI) may comprise one or more fields with value(s) indicating an identifier of a cell and/or an identifier of a bandwidth part (BWP) of a cell and/or an identifier of an uplink carrier (e.g., a normal uplink carrier or a supplementary uplink carrier) of a cell for which the first DTX pattern and/or the first DRX pattern is applicable (e.g., is to be activated or deactivated).

In an example, the configuration parameters may indicate a cell DTX pattern/cell DRX pattern for a cell. The DCI (the DTX/DRX activation/deactivation DCI) may comprise a field comprising a bit. A first value (e.g., one) of the bit may indicate activation of the cell DTX pattern/cell DRX pattern and a second value (e.g., 0) of the bit may indicate deactivation of the cell DTX pattern/cell DRX pattern.

In an example, the DCI (the DTX/DRX activation/deactivation DCI) may be received via a first cell. The activation or deactivation of the first cell DTX pattern and/or the first cell DRX pattern, indicated by the DCI, may be applicable to the first cell (e.g., the cell via which the DCI is received).

In an example, the DCI (the DTX/DRX activation/deactivation DCI) may comprise a field comprising a plurality of bits. Each bit, in the plurality of bits, may be associated with a cell. A value of a bit, in the plurality of bits, may indicate whether a cell DTX pattern and/or a cell DRX pattern is activated or deactivated for the cell corresponding to the bit. A value of a bit, in the plurality of bits, may indicate whether a cell DTX pattern and/or a cell DRX pattern is to be in an activated or in a deactivated state for the cell corresponding to the bit. In an example, a value of one of the bit may indicate activation of the cell DTX pattern and/or the cell DRX pattern for the corresponding cell. The value of one of the bit may indicate that the cell DTX pattern and/or the cell DRX pattern for the corresponding cell is to be in activated state. A value of zero of the bit may indicate deactivation of the cell DTX pattern or the cell DRX pattern for the corresponding cell. A value of zero of the bit may indicate that the cell DTX pattern and/or the cell DRX pattern for the corresponding cell is to be in deactivated state. In an example, the cell corresponding to the bit may be configured with one cell DTX pattern and/or one cell DRX pattern. The value of the bit may indicate that the cell DTX pattern and/or the cell DRX pattern is to be in an activated state or in an deactivated state. In an example, a first bit(e.g., the rightmost bit in the plurality of bits) may correspond to a cell configured with a DTX pattern and/or a DRX pattern that has lowest cell index among cell index(es) of the cell(s) for which cell DTX and/or cell DRX (e.g., cell DTX pattern and/or a cell DRX pattern) are configured; a second bit, that is adjacent to the first bit (e.g., adjacent to the rightmost bit in the plurality of bits), may correspond to a cell configured with a DTX pattern and/or a DRX pattern that has second lowest cell index among cell indexes of the cells for which cell DTX and/or cell DRX (e.g., a cell DTX pattern and/or a cell DRX pattern) are configured; and so on.

In an example, the L2 command may be a MAC CE. In an example, a logical channel identifier (LCID) associated with the MAC CE may indicate that the MAC CE is for/associated with/usable in activation/deactivation of a cell DTX pattern and/or a cell DRX pattern for a cell (e.g., for a BWP of a cell and/or for an uplink carrier of the cell). The wireless device may determine that the MAC CE is for/associated with/usable in activation/deactivation of a cell DTX pattern and/or a cell DRX pattern for a cell based on the LCID associated with the MAC CE. In an example, a value of a field of the MAC CE may indicate that the MAC CE is for/associated with/usable in activation/deactivation of a cell DTX pattern and/or a cell DRX pattern for a cell (e.g., for a BWP of a cell and/or for an uplink carrier of the cell). The wireless device may determine that the MAC CE is for/associated with/usable in activation/deactivation of a cell DTX pattern and/or a cell DRX pattern for a cell based on the value of the field of the MAC CE. In an example, the value may be pre-determined/preconfigured. In an example, a first value of the field may indicate that the MAC CE is for/associated with/usable in activation of a DTX pattern and/or a DRX pattern and a second value of the field indicates that the MAC CE is for/associated with/usable in deactivation of a DTX pattern and/or a DRX pattern. In an example, a first value of the field may indicate that the MAC CE is for/associated with/usable in activation of a DTX pattern and/or a DRX pattern and a second value of the field may indicate that the MAC CE is for/associated with/usable in deactivation of a DTX pattern and/or a DRX pattern.

In an example, the MAC CE (the DTX/DRX activation/deactivation MAC CE) may comprise a field with a value indicating the activation/deactivation of the first DTX pattern and/or the first DRX pattern. In an example, each of the one or more cell DTX patterns and/or cell DRX patterns may be associated with an identifier (for example each DTX pattern may be associated with an identifier and each DRX pattern may be associated with an identifier or each pair of DTX pattern and DRX pattern may be associated with an identifier). The value of the field may indicate a first identifier associated with the first cell DTX pattern and/or the first cell DRX pattern. The wireless device may determine the first cell DTX pattern and/or the first cell DRX pattern based on the value of the field indicating the first identifier.

In an example, a starting timing (e.g., a starting slot) of the first DTX pattern and/or the first DRX patten (e.g., a starting timing/slot that the first DTX pattern and/or the first DRX pattern is applicable) may be based on a reception timing (e.g., a slot in which the MAC CE (the DTX/DRX activation/deactivation MAC CE) is received) and an offset (e.g., an offset in a first number of slots). In an example, the wireless device may receive a configuration parameter indicating the offset (e.g., indicating the first number of slots of the offset). In an example, the MAC CE (e.g., a value of a field of the MAC CE) may indicate the offset. In an example, the MAC CE (e.g., a value of a field of the MAC CE) may indicate one of a plurality of configured offsets. In an example, the wireless device may receive configuration parameters indicating the plurality of configured offsets.

In an example, the MAC CE (the DTX/DRX activation/deactivation MAC CE) may comprise one or more fields with value(s) indicating an identifier of a cell and/or an identifier of a bandwidth part (BWP) of a cell and/or an identifier of an uplink carrier (e.g., a normal uplink carrier or a supplementary uplink carrier) of a cell for which the first DTX pattern and/or the first DRX pattern is applicable (e.g., is to be activated or deactivated).

In an example, the configuration parameters may indicate a cell DTX pattern/cell DRX pattern for a cell. The MAC CE (the DTX/DRX activation/deactivation MAC CE) may comprise a field comprising a bit. A first value (e.g., one) of the bit may indicate activation of the cell DTX pattern/cell DRX pattern and a second value (e.g., 0) of the bit may indicate deactivation of the cell DTX pattern/cell DRX pattern.

In an example, the MAC CE (the DTX/DRX activation/deactivation MAC CE) may be received via a first cell. The first cell DTX pattern and/or the first cell DRX pattern may be applicable to the first cell (e.g., the cell via which the MAC CE is received).

In an example, the MAC CE (the DTX/DRX activation/deactivation MAC CE) may comprise a field comprising a plurality of bits. Each bit, in the plurality of bits, may be associated with a cell. A value of a bit, in the plurality of bits, may indicate whether a cell DTX pattern and/or a cell DRX pattern is activated or deactivated for the cell corresponding to the bit. A value of a bit, in the plurality of bits, may indicate whether a cell DTX pattern and/or a cell DRX pattern is to be in an activated state or deactivated state for the cell corresponding to the bit. In an example, a value of one of the bit may indicate activation of the cell DTX pattern and/or the cell DRX pattern for the corresponding cell. The value of one of the bit may indicate that the cell DTX pattern and/or the cell DRX pattern for the corresponding cell is to be in activated state. A value of zero of the bit may indicate deactivation of the cell DTX pattern or the cell DRX pattern for the corresponding cell. The value of zero of the bit may indicate that the cell DTX pattern and/or the cell DRX pattern for the corresponding cell is to be in deactivated state. In an example, the cell corresponding to the bit may be configured with one cell DTX pattern and/or one cell DRX pattern. The value of the bit may indicate that the cell DTX pattern and/or the cell DRX pattern is to be in an activated state or in a deactivated state. In an example, a first bit (e.g., the rightmost bit in the plurality of bits) may correspond to a cell configured with a DTX pattern and/or a DRX pattern that has lowest cell index among cell indexes of the cells for which cell DTX and/or cell DRX (e.g., cell DTX pattern and/or cell DRX pattern) are configured; a second bit, that is adjacent to the first bit (e.g., adjacent to the rightmost bit in the plurality of bits), may correspond to a cell configured with a DTX pattern and/or a DRX pattern that has second lowest cell index among the cells for which cell DTX and/or cell DRX (e.g., cell DTX pattern and cell DRX pattern) are configured; and so on.

In an example, the activating the first cell DTX pattern may be for a first cell in the one or more cells. The wireless device may flush one or more hybrid automatic repeat request (HARQ) buffers associated with one or more downlink HARQ processes of the first cell. In an example, the flushing the one or more HARQ buffers may be in response to transitioning to a cell DTX state (e.g., from a non-cell DTX/a normal state) based on the first cell DTX pattern and/or in response to activation of the first cell DTX pattern. In an example, the flushing the one or more HARQ buffers may be in response to receiving the configuration parameters of the one or more cell DTX patterns, e.g., in response to receiving one or more messages (e.g., RRC messages) comprising the configuration parameters of the one or more cell DTX patterns. In an example, the flushing the one or more HARQ buffers may be in response to receiving a L1 command (e.g., DCI)/L2 command (e.g., MAC CE) indicating the transitioning to the cell DTX state based on the first cell DTX pattern and/or activation of the first cell DTX pattern. In an example, the flushing the one or more HARQ buffers may be based on the first DTX pattern (e.g., based on one or more parameters associated with the first DTX pattern, e.g., a cell DTX periodicity or a cell DTX duration associated with the first cell DTX pattern). In an example, the flushing the one or more HARQ buffers may be based on the cell DTX duration being larger than a threshold (e.g., a preconfigured/predetermined threshold or a configurable threshold, e.g., RRC configurable threshold) and/or based on the cell DTX periodicity being larger than a threshold (e.g., a preconfigured threshold or a configurable threshold, e.g., RRC configurable threshold). In an example, the one or more downlink HARQ processes may be the downlink HARQ processes configured for the first cell. In an example, the one or more downlink HARQ processes may be a subset of the downlink HARQ processes configured for the first cell. In an example, the subset may exclude one or more HARQ processes associated with one or more semi-persistent scheduling (SPS) grants/SPS configurations. In an example, the flushing may be based on a first parameter having a first value and/or indicating the flushing. In an example, the one or more configuration parameters of the one or more cell DTX patterns and/or cell DRX patterns may comprise the first parameter. In an example, the activating the first cell DTX pattern may be in response to receiving a L1 command/L2 command (e.g., a DCI or a MAC CE). The flushing may be based on a field of the L1 command/L2 command having a first value.

In an example, the activating the first DRX pattern may be for a first cell in the one or more cells. The wireless device may flush one or more hybrid automatic repeat request (HARQ) buffers associated with one or more uplink HARQ processes of the first cell. In an example, the flushing the one or more HARQ buffers may be in response to transitioning to a cell DRX state (e.g., from a non-cell DRX/a normal state) based on the first cell DRX pattern and/or in response to activation of the first cell DRX pattern. In an example, the flushing the one or more HARQ buffers may be in response to receiving the configuration parameters of the one or more cell DRX patterns, e.g., in response to receiving one or more messages (e.g., RRC messages) comprising the configuration parameters of the one or more cell DRX patterns. In an example, flushing the one or more HARQ buffers may be in response to receiving a L1 command (e.g., DCI)/L2 command (e.g., MAC CE) indicating the transitioning to the cell DRX state based on the first cell DRX pattern and/or activation of the first cell DRX pattern. In an example, the flushing the one or more HARQ buffers may be based on the first cell DRX pattern (e.g., based on a cell DRX periodicity or a cell DRX duration associated with the first cell DRX pattern). In an example, the flushing the one or more HARQ buffers may be based on the cell DRX duration being larger than a threshold (e.g., a configurable threshold, e.g., RRC configurable threshold) and/or based on the cell DRX periodicity being larger than a threshold (e.g., a configurable threshold, e.g., RRC configurable threshold). In an example, the one or more uplink HARQ processes may be the uplink HARQ processes configured for the first cell. In an example, the one or more uplink HARQ processes may be a subset of the uplink HARQ processes configured for the first cell. In an example, the subset may exclude one or more HARQ processes associated with one or more configured grants/configured grant configurations. In an example, the flushing may be based on a first parameter having a first value and/or indicating the flushing. In an example, the one or more configuration parameters of the one or more cell DTX patterns and/or cell DRX patterns may comprise the first parameter. In an example, the activating the first cell DRX pattern may be in response to receiving a L1 command/L2 command (e.g., a DCI or a MAC CE). The flushing may be based on a field of the L1 command/L2 command having a first value.

In an example, a cell may be associated with a first number of downlink HARQ processes while the cell is in a cell DTX state and a second number of downlink HARQ processes while the cell is in a non-cell DTX/normal state. In an example, the first number may be smaller than the second number. In an example, the first number may be one. In an example, the HARQ process(es) in cell DTX state may be used for SPS transmissions.

In an example, a cell may be associated with a first number of uplink HARQ processes while the cell is in a cell DRX state and a second number of uplink HARQ processes while the cell is in a non-cell DRX/normal state. In an example, the first number may be smaller than the second number. In an example, the second number may be one. In an example, the HARQ process(es) in cell DRX state may be used for configured grant transmissions.

In an example, the wireless device may receive configured grant configuration parameters of a configured grant configuration, wherein at least one parameter of the configured grant configuration parameters may indicate whether configured grants associated with the configured grant configuration is allowed/used during the cell DRX state. In an example, a first value (e.g., ‘true’) of the at least one parameter indicates that configured grants associated with the configured grant configuration is allowed/used during the cell DRX state.

In an example, the wireless device may receive a configuration parameter indicating whether configured grants are allowed/used during the cell DRX state. In an example, a first value (e.g., ‘true’) of the configuration parameter may indicate that configured grants are allowed/used during the cell.

In an example, the wireless device may receive SPS configuration parameters of a SPS configuration, wherein at least one parameter of the SPS configuration parameters may indicate whether SPS grants associated with the SPS configuration is allowed/used during the cell DTX state. In an example, a first value (e.g., ‘true’) of the at least one parameter may indicate that SPS grants associated with the SPS configuration is allowed/used during the cell DTX state.

In an example, the wireless device may receive a configuration parameter indicating whether SPS grants are allowed/used during the cell DTX state. In an example, a first value (e.g., ‘true’) of the configuration parameter may indicate that SPS grants are allowed/used during the cell.

In an example, the wireless device may receive logical channel configuration parameters of a logical channel, wherein at least one parameter of the logical channel configuration parameters indicates whether data of the logical is allowed to be transmitted (e.g., allowed to be transmitted via/mapped to a configured grant) during the cell DRX state. In an example, a first value (e.g., ‘true’) of the at least one parameter may indicate that data of the logical channel is allowed to be transmitted (e.g., allowed to be transmitted via/mapped to a configured grant) during the cell DRX state.

In an example, the wireless device may transmit/report negative acknowledgements (NACKs) associated with one or more downlink transport blocks (TBs), wherein the one or more downlink TBs may be scheduled for reception on a cell while the cell is in a DRX state. In an example, the one or more downlink TBs may comprise SPS downlink TBs and/or dynamically scheduled downlink TBs. In an example, the reporting/transmitting NACKs associated with the one or more downlink TBS may be based on the one or more downlink TBs being scheduled for reception during the cell DRX state (e.g., while one or more cells on which the one or more downlink TBs are scheduled are in a cell DRX state during the scheduled timings of the one or more downlink TBs).

In an example, the wireless device may omit HARQ feedbacks associated with one or more downlink transport blocks (TBs) (e.g., one or more HARQ feedbacks in a HARQ feedback codebook), wherein the one or more downlink TBs may be scheduled for reception on a cell while the cell is in a cell DTX state. In an example, the one or more downlink TBs may comprise SPS downlink TBs and/or dynamically scheduled downlink TBs. In an example, the omitting the HARQ feedbacks associated with the one or more downlink TBS (e.g., omitting the HARQ feedbacks in the HARQ feedback codebook) may be based on the one or more downlink TBs being scheduled for reception during the cell DTX state (e.g., based on one or more cells on which the one or more downlink TBs are scheduled are in a cell DTX state during the scheduled timings of the one or more downlink TBs).

In an example, the wireless device may stop a timer (e.g., a timer associated with a first HARQ process of a first cell), wherein a configured grant (e.g., a configured grant associated with the first HARQ process) is configured on the first cell while the first cell is in a DRX state. In an example, the timer may be a configured grant timer. In an example, the timer may be a configured grant retransmission timer.

In an example, the wireless device may transition from a cell DTX and/or a cell DRX state to a non-cell DTX and/or non-cell DRX state (e.g., normal state). The wireless device may initiate a random access process in response to the transitioning. The wireless device may transmit a random access preamble in response to the transitioning. In an example, the transitioning may be in response to receiving a L1 command (e.g., DCI)/L2 command (e.g., MAC CE) indicating the transitioning. In an example, the L1 command/L2 command may indicate deactivation of the first cell DTX pattern and/or the first cell DRX pattern. In an example, the initiating the random access process may be for obtaining/determining a timing advance value, e.g., to be used for an uplink transmission in response to the transitioning from the cell DTX and/or the cell DRX state to the non-cell DTX and/or the non-cell DRX state (e.g., normal state). The transmitting the random access preamble may be for obtaining/determining a timing advance value, e.g., to be used for an uplink transmission in response to the transitioning from the cell DTX and/or the cell DRX state to the non-cell DTX and/or the non-cell DRX state (e.g., normal state). In an example, the wireless device may receive the timing advance value (e.g., a random access response message comprising the timing advance value) in response to the initiating the random access process. The wireless device may receive the timing advance value (e.g., a random access response message comprising the timing advance value) in response to the transmitting the random access preamble. The wireless device may perform/transmit an uplink transmission (e.g., PUSCH transmission of a TB) based on the timing advance value.

In an example, the wireless device may receive a L1 command (e.g., DCI)/L2 command (e.g., MAC CE) indicating deactivation of the first DRX patten and/or transitioning from a cell DTX state/cell DRX state to a non-cell DTX state/non-cell DRX state (e.g., normal state). The wireless device may deactivate the first DTX pattern and/or the first DRX patten and/or may transition from a cell DTX state/cell DRX state to a non-cell DTX state/non-cell DRX/normal state based on/in response to receiving the L1 command/L2 command. In an example, the L1 command (e.g., the DCI) or the L2 command (e.g., the MAC CE) may comprise a field with a value indicating a timing advance value. The wireless device may perform/transmit an uplink transmission (e.g., PUSCH transmission of a TB) based on the timing advance value.

In an example, the wireless device may transition from a cell DTX state and/or a cell DRX state to a non-cell DTX state and/or a non-cell DRX state (e.g., normal state). The wireless device may trigger a power headroom report (PHR) in response to the transitioning. The wireless device may transmit a PHR MAC CE in response to the transitioning.

In accordance with various exemplary embodiments in the present disclosure, a device (e.g., a wireless device, a base station and/or alike) may include one or more processors and may include memory that may store instructions. The instructions, when executed by the one or more processors, cause the device to perform actions as illustrated in the accompanying drawings and described in the specification. The order of events or actions, as shown in a flow chart of this disclosure, may occur and/or may be performed in any logically coherent order. In some examples, at least two of the events or actions shown may occur or may be performed at least in part simultaneously and/or in parallel. In some examples, one or more additional events or actions may occur or may be performed prior to, after, or in between the events or actions shown in the flow charts of the present disclosure.

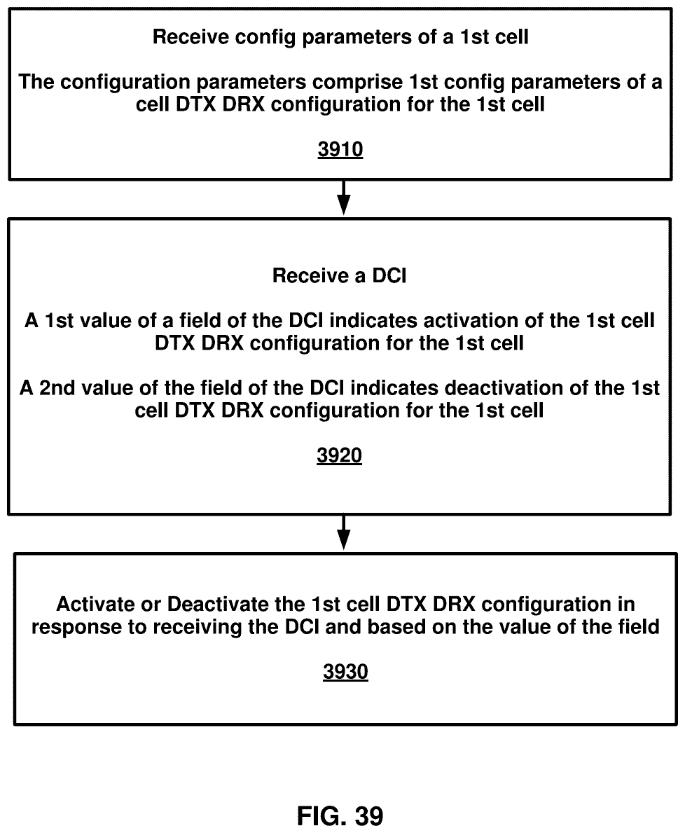

FIG. 39 shows an example flow diagram in accordance with several of various embodiments of the present disclosure. At 3910, a wireless device may receive configuration parameters of a first cell, wherein the configuration parameters comprise first configuration parameters of a cell discontinuous transmission (DTX) discontinuous reception (DRX) configuration for the first cell. At 3920, the wireless device may receive a downlink control information. A first value of a field of the downlink control information indicates activation of the first cell DTX DRX configuration for the first cell. A second value of the field of the downlink control information indicates deactivation of the first cell DTX DRX configuration for the first cell. At 3930, the wireless device may activate or deactivate the first cell DTX DRX configuration in response to receiving the downlink control information and based on the value of the field.

In an example embodiment, the cell DTX DRX configuration, for which the first configuration parameters are received at 3910, may indicate at least one of a cell DTX pattern and a cell DRX pattern.

In an example embodiment, the cell DTX DRX configuration, for which the first configuration parameters are received at 3910, may control at least one of uplink transmission activity and downlink transmission activity of the first cell.

In an example embodiment, the first configuration parameters, received at 3910, may be for one of: cell DTX only; cell DRX only; and joint cell DTX/DRX.

In an example embodiment, a format associated with the downlink control information, received at 3920, may indicate that the downlink control information is for activation or deactivation of a cell DTX DRX configuration.

In an example embodiment, the downlink control information, received at 3920, may be associated with a radio network temporary identifier. The radio network temporary identifier may indicate that the downlink control information is for activation or deactivation of a cell DTX DRX configuration.

In an example embodiment, the downlink control information, received at 3920, may be a common downlink control information (e.g., received via a common search space).

In an example embodiment, the first configuration parameters, received at 3910, may comprise a first parameter indicating whether the cell DTX DRX configuration is activated in response to receiving the first configuration parameters. In an example embodiment, the first parameter may indicate that the cell DTX DRX configuration is deactivated in response to receiving the first configuration parameters and that activation of the cell DTX DRX configuration is further in response to receiving a downlink control information.

In an example embodiment, a plurality of cell DTX DRX configurations, comprising the first cell DTX DRX configuration, may be configured for a medium access control (MAC) entity of the wireless device.

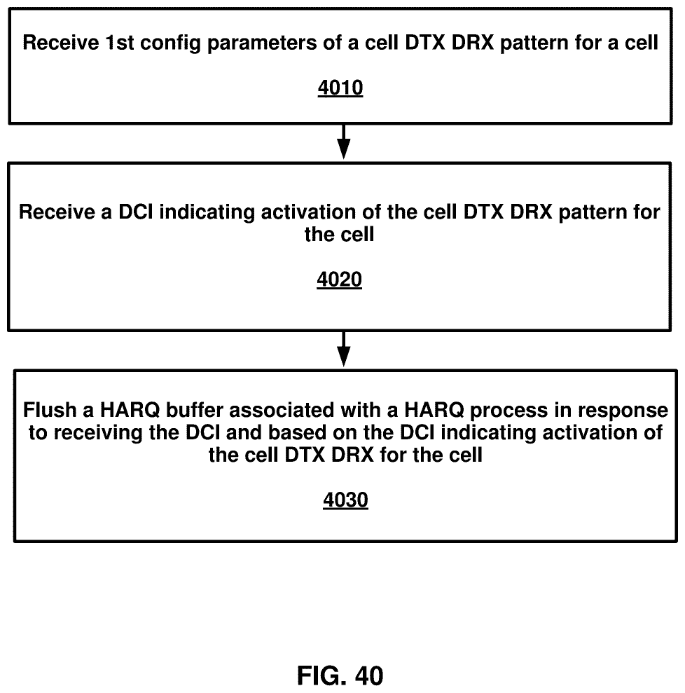

FIG. 40 shows an example flow diagram in accordance with several of various embodiments of the present disclosure. At 4010, a wireless device may receive first configuration parameters of a cell discontinuous transmission (DTX) discontinuous reception (DRX) pattern for a cell. At 4020, the wireless device may receive a downlink control information indicating activation of the cell DTX DRX pattern for the cell. At 4030, the wireless device may flush a hybrid automatic repeat request (HARQ) buffer associated with a HARQ process in response to receiving the downlink control information and based on the downlink control information indicating activation of the cell DTX DRX for the cell.

In an example embodiment, the cell DTX DRX pattern, whose first configuration parameters are received 4010, may be for cell DTX. In an example embodiment, the HARQ process may be a downlink HARQ process.

In an example embodiment, the cell DTX DRX pattern, whose first configuration parameters are received 4010, may be for cell DRX. In an example embodiment, the HARQ process may be an uplink HARQ process.

Various exemplary embodiments of the disclosed technology are presented as example implementations and/or practices of the disclosed technology. The exemplary embodiments disclosed herein are not intended to limit the scope. Persons of ordinary skill in the art will appreciate that various changes can be made to the disclosed embodiments without departure from the scope. After studying the exemplary embodiments of the disclosed technology, alternative aspects, features and/or embodiments will become apparent to one of ordinary skill in the art. Without departing from the scope, various elements or features from the exemplary embodiments may be combined to create additional embodiments. The exemplary embodiments are described with reference to the drawings. The figures and the flowcharts that demonstrate the benefits and/or functions of various aspects of the disclosed technology are presented for illustration purposes only. The disclosed technology can be flexibly configured and/or reconfigured such that one or more elements of the disclosed embodiments may be employed in alternative ways. For example, an element may be optionally used in some embodiments or the order of actions listed in a flowchart may be changed without departure from the scope.

An example embodiment of the disclosed technology may be configured to be performed when deemed necessary, for example, based on one or more conditions in a wireless device, a base station, a network controlled repeater, a radio and/or core network configuration, a combination thereof and/or alike. For example, an example embodiment may be performed when the one or more conditions are met. Example one or more conditions may be one or more configurations of the wireless device and/or network controlled repeater and/or base station, traffic load and/or type, service type, battery power, a combination of thereof and/or alike. In some scenarios and based on the one or more conditions, one or more features of an example embodiment may be implemented selectively.

In this disclosure, the articles “a” and “an” used before a group of one or more words are to be understood as “at least one” or “one or more” of what the group of the one or more words indicate. The use of the term “may” before a phrase is to be understood as indicating that the phrase is an example of one of a plurality of useful alternatives that may be employed in an embodiment in this disclosure.

In this disclosure, an element may be described using the terms “comprises”, “includes” or “consists of” in combination with a list of one or more components. Using the terms “comprises” or “includes” indicates that the one or more components are not an exhaustive list for the description of the element and do not exclude components other than the one or more components. Using the term “consists of” indicates that the one or more components is a complete list for description of the element. In this disclosure, the term “based on” is intended to mean “based at least in part on”. The term “based on” is not intended to mean “based only on”. In this disclosure, the term “and/or” used in a list of elements indicates any possible combination of the listed elements. For example, “X, Y, and/or Z” indicates X; Y; Z; X and Y; X and Z; Y and Z; or X, Y, and Z.

Some elements in this disclosure may be described by using the term “may” in combination with a plurality of features. For brevity and ease of description, this disclosure may not include all possible permutations of the plurality of features. By using the term “may” in combination with the plurality of features, it is to be understood that all permutations of the plurality of features are being disclosed. For example, by using the term “may” for description of an element with four possible features, the element is being described for all fifteen permutations of the four possible features. The fifteen permutations include one permutation with all four possible features, four permutations with any three features of the four possible features, six permutations with any two features of the four possible features and four permutations with any one feature of the four possible features.

Although mathematically a set may be an empty set, the term set used in this disclosure is a nonempty set. Set B is a subset of set A if every element of set B is in set A. Although mathematically a set has an empty subset, a subset of a set is to be interpreted as a non-empty subset in this disclosure. For example, for set A={subcarrier1, subcarrier2}, the subsets are {subcarrier1}, {subcarrier2} and {subcarrier1, subcarrier2}.

In this disclosure, the phrase “based on” may be used equally with “based at least on” and what follows “based on” or “based at least on” indicates an example of one of plurality of useful alternatives that may be used in an embodiment in this disclosure. The phrase “in response to” may be used equally with “in response at least to” and what follows “in response to” or “in response at least to” indicates an example of one of plurality of useful alternatives that may be used in an embodiment in this disclosure. The phrase “depending on” may be used equally with “depending at least on” and what follows “depending on” or “depending at least on” indicates an example of one of plurality of useful alternatives that may be used in an embodiment in this disclosure. The phrases “employing” and “using” and “employing at least” and “using at least” may be used equally in this in this disclosure and what follows “employing” or “using” or “employing at least” or “using at least” indicates an example of one of plurality of useful alternatives that may be used in an embodiment in this disclosure.

The example embodiments disclosed in this disclosure may be implemented using a modular architecture comprising a plurality of modules. A module may be defined in terms of one or more functions and may be connected to one or more other elements and/or modules. A module may be implemented in hardware, software, firmware, one or more biological elements (e.g., an organic computing device and/or a neurocomputer) and/or a combination thereof and/or alike. Example implementations of a module may be as software code configured to be executed by hardware and/or a modeling and simulation program that may be coupled with hardware. In an example, a module may be implemented using general-purpose or special-purpose processors, digital signal processors (DSPs), microprocessors, microcontrollers, application-specific integrated circuits (ASICs), programmable logic devices (PLDs) and/or alike. The hardware may be programmed using machine language, assembly language, high-level language (e.g., Python, FORTRAN, C, C++ or the like) and/or alike. In an example, the function of a module may be achieved by using a combination of the mentioned implementation methods.

What is claimed is:

1. A method comprising:
receiving, by a wireless device, configuration parameters of a first cell, wherein the configuration parameters comprise first configuration parameters of a cell discontinuous transmission (DTX) discontinuous reception (DRX) configuration for the first cell;
receiving a downlink control information, wherein:
a first value of a field of the downlink control information indicates activation of the first cell DTX DRX configuration for the first cell; and
a second value of the field of the downlink control information indicates deactivation of the first cell DTX DRX configuration for the first cell; and
activating or deactivating the first cell DTX DRX configuration in response to receiving the downlink control information and based on the value of the field.

2. The method of claim 1, wherein the cell DTX DRX configuration indicates at least one of a cell DTX pattern and a cell DRX pattern.

3. The method of claim 1, wherein the cell DTX DRX configuration controls at least one of uplink transmission activity and downlink transmission activity of the first cell.

4. The method of claim 1, wherein the first configuration parameters are for one of:
cell DTX only;
cell DRX only; and
joint cell DTX/DRX.

5. The method of claim 1, wherein a format associated with the downlink control information indicates that the downlink control information is for activation or deactivation of a cell DTX DRX configuration.

6. The method of claim 1, wherein:
the downlink control information is associated with a radio network temporary identifier; and
the radio network temporary identifier indicates that the downlink control information is for activation or deactivation of a cell DTX DRX configuration.

7. The method of claim 1, wherein the downlink control information is a common downlink control information.

8. The method of claim 1, wherein the first configuration parameters comprise a first parameter indicating whether the cell DTX DRX configuration is activated in response to receiving the first configuration parameters.

9. The method of claim 8, wherein the first parameter indicates that the cell DTX DRX configuration is deactivated in response to receiving the first configuration parameters and that activation of the cell DTX DRX configuration is further in response to receiving a downlink control information.

10. The method of claim 1, wherein a plurality of cell DTX DRX configuration, comprising the first cell DTX DRX configuration, are configured for a medium access control (MAC) entity of the wireless device.

11. A wireless device comprising:
one or more processors; and
memory storing instructions that, when executed by the one or more processors, cause the wireless device to:
receive configuration parameters of a first cell, wherein the configuration parameters comprise first configuration parameters of a cell discontinuous transmission (DTX) discontinuous reception (DRX) configuration for the first cell;
receive a downlink control information, wherein:
a first value of a field of the downlink control information indicates activation of the first cell DTX DRX configuration for the first cell; and
a second value of the field of the downlink control information indicates deactivation of the first cell DTX DRX configuration for the first cell; and
activate or deactivate the first cell DTX DRX configuration in response to receiving the downlink control information and based on the value of the field.

12. The wireless device of claim 11, wherein the cell DTX DRX configuration controls at least one of uplink transmission activity and downlink transmission activity of the first cell.

13. The wireless device of claim 11, wherein the first configuration parameters are for one of:
cell DTX only;
cell DRX only; and
joint cell DTX/DRX.

14. The wireless device of claim 11, wherein a format associated with the downlink control information indicates that the downlink control information is for activation or deactivation of a cell DTX DRX configuration.

15. The wireless device of claim 11, wherein:
the downlink control information is associated with a radio network temporary identifier; and
the radio network temporary identifier indicates that the downlink control information is for activation or deactivation of a cell DTX DRX configuration.

16. The wireless device of claim 11, wherein the downlink control information is a common downlink control information.

17. The wireless device of claim 11, wherein the first configuration parameters comprise a first parameter indicating whether the cell DTX DRX configuration is activated in response to receiving the first configuration parameters.

18. The wireless device of claim 17, wherein the first parameter indicates that the cell DTX DRX configuration is deactivated in response to receiving the first configuration parameters and that activation of the cell DTX DRX configuration is further in response to receiving a downlink control information.

19. The wireless device of claim 11, wherein a plurality of cell DTX DRX configurations, comprising the first cell DTX DRX configuration, are configured for a medium access control (MAC) entity of the wireless device.

20. A system comprising:
a base station; and
a wireless device comprising: one or more processors; and memory storing instructions that, when executed by the one or more processors, cause the wireless device to: receive, from the base station, configuration parameters of a first cell, wherein the configuration parameters comprise first configuration parameters of a cell discontinuous transmission (DTX) discontinuous reception (DRX) configuration for the first cell; receive a downlink control information, wherein: a first value of a field of the downlink control information indicates activation of the first cell DTX DRX configuration for the first cell; and a second value of the field of the downlink control information indicates deactivation of the first cell DTX DRX configuration for the first cell; and activate or deactivate the first cell DTX DRX configuration in response to receiving the downlink control information and based on the value of the field.
